(19) United States
(12) Patent Application Publication
(10) Pub. No.: US 2007/0289953 A1
(43) Pub. Date: Dec. 20, 2007

(54) OPTICAL ELEMENT PRODUCING METHOD, BASE MATERIAL DRAWING METHOD AND BASE MATERIAL DRAWING APPARATUS

(75) Inventors: KAZUMI FURUTA, Tokyo (JP); Yuichi Akanabe, Tokyo (JP); Masahiro Morikawa, Tokyo (JP); Osamu Masuda, Tokyo (JP); Koji Horii, Tokyo (JP); Tomohide Mizukoshi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA CORPORATION, Tokyo (JP)

(21) Appl. No.: 11/609,270

(22) Filed: Dec. 11, 2006

Related U.S. Application Data
(62) Division of application No. 10/080,638, filed on Feb. 21, 2002, now abandoned.

(30) Foreign Application Priority Data
Mar. 1, 2001 (JP) 057105/2001
Aug. 31, 2001 (JP) 263313/2001
Sep. 25, 2001 (JP) 292053/2001

(51) Int. Cl. B23K 15/08

(52) U.S. Cl. 219/121.2

(57) ABSTRACT

A method of working an optical element for producing an optical element having a microscopic pattern, comprising a pattern drawing step for forming a specified pattern corresponding to said optical element on a base material including a layer of pattern drawing object, wherein said layer of pattern drawing object has a curved surface, and said specified pattern is drawn by the application of an electron beam to said layer of pattern drawing object.

### CROSS-REFERENCE TO RELATED APPLICATIONS

The present application is a Divisional Application of U.S. application Ser. No. 10/080,638, filed Feb. 21, 2002.

### BACKGROUND OF THE INVENTION

This invention relates to a method of producing an optical element, method of drawing a pattern on a base material, and a pattern drawing apparatus using an electron beam, and in particular, to a method of drawing a microscopic structure such as a diffractive structure on an optical-function surface of a high-precision optical element having a microscopic shape.

In recent years, for an information recording medium, for example, a CD, a DVD, etc. are broadly used, and in a high-precision apparatus such as a reading apparatus for reading these recording media, a number of optical elements are utilized. As regards an optical element for use in these apparatus, for example an optical lens or the like, an optical lens made of resin rather than an optical lens made of glass is often used, from the view point of cost saving and making the size smaller.

Such an optical lens made of resin is manufactured by a general injection molding method, and a molding die for an injection molding is also formed by a general cutting process.

Incidentally, lately, the specification and the performance itself required of an optical element has been improved; for example, in manufacturing an optical element having a diffractive structure on its optical-function surface, for the purpose of the injection molding of said optical element, it is necessary to form a surface for giving such a diffractive structure on the molding die beforehand.

However, if it is intended to form a microscopic structure such as a diffractive structure as mentioned in the above on a molding die with a cutting tool (cutting bite) in a forming technology and working technology of present use, the precision of working is poor and there is a limit in the strength and life of the cutting tool, which makes it impossible to carry out a high-precision working in an order of sub-micron or under.

Especially, as compared to a pickup lens for a CD-ROM, for a pickup lens to be used in a medium such as a DVD, a diffractive structure with a higher precision is required in accordance with the increase of recording density, a working precision of a level smaller than a wavelength of light, for example, of nm level is required. However, as described in the above, it has been impossible to obtain such a working precision by a conventional cutting process.

On the other hand, as regards a method of drawing and working a desired shape on the surface of a base material including an optical element or the like, a method such as an optical exposure method for example, in which working is done by means of an exposure apparatus employing a mask exposure, has been put into practice.

For example, it can be considered to use an exposure apparatus for drawing and working a desired shape on the surface of a base material such as a semiconductor wafer substrate (photo-mask), in the working on the surface of the above-mentioned optical element or the working of the molding die. However, in the apparatus for a wafer substrate, the depth of working of the base material is controlled by the amount of exposure energy of irradiation light, and in the case of a high-precision working of a diffractive grating for an optical element or the like, or in the case of producing a photonic crystal, it is necessary to form a structure shorter than a wavelength of light precisely on a non-planer surface such as a lens. For that reason, an exposure apparatus employing the above-mentioned control method is not suitable for a microscopic working of a required level.

Further, working (or processing) by means of a laser beam can be also considered; although a laser beam is sometimes used in working of a micron level, the beam diameter is optically controlled, and there is a limit in the convergence of the beam. Hence, it is difficult to perform working of a sub-micron level, in particular, a level near a wavelength of light by a laser beam. Moreover, as regards the depth of focus, a deep one cannot be obtained, and it is necessary to use always a mechanical means such as auto-focusing; also this has been a factor to obstruct a high-precision working. Especially, when a high precision is required in drawing on an optical element having a shape of a curved surface (in this case, a three-dimensional shape having a macroscopically varying surface is included), this problem becomes remarkable.

Hence, there has been a problem that a laser beam is not suitable for the case where a microscopic shape is drawn on a base material having a dynamic three-dimensional shape such as a curved surface as in the case of a molding die for an optical lens.

This invention has been made in view of the above-mentioned things, and it is its object to apply drawing and working of a microscopic structure such as a diffractive grating on a base material such as an optical lens having a non-planer shape or the like.

Further, if the curvature of the above-mentioned optical lens becomes larger with the diffractive grating density being made higher, surface reflection increases in the area near the circumference of said optical lens. Therefore, in order to reduce such surface reflection, usually surface reflection reduction for an optical lens is put into practice through forming a single or multiple layers of dielectric materials by evaporation coating on the surface of the optical lens.

However, in the method of forming dielectric films by evaporation coating, it is necessary to practice an evaporation coating process for each optical lens; thus, there has been a situation that the productivity of lenses was reduced.

For an example of an optical pickup device such as a reading device utilizing an optical lens as described in the above, a device as shown in FIG. 30 can be cited for example.

In the optical pickup device 400 shown in the above-mentioned drawing, a laser beam from a semiconductor laser 401 is made a parallel beam by a collimator lens 402, is reflected towards an objective lens 404 by a splitting prism 403, is converged by the objective lens 504 to the diffraction limit, and irradiates the magneto-optical disk 405 (magneto-optical recording medium).

The reflected laser beam from the magneto-optical disk 405 enters the objective lens 404, becomes a parallel beam again, is transmitted through the splitting prism 403, and is further transmitted through a half-wave plate 506 to change its polarization orientation; after that, it enters a polarized light splitting element 407, by which it is split into two bundles of rays composed of P polarized light and S polarized light respectively with their optical paths positioned close to each other. The above-mentioned bundles of rays of both P polarized light and S polarized light are both converged by a convergent lens 408 and a cylindrical lens 409, to form their spots on the split light receiving areas (light receiving elements) of a split light detector 410 respectively.

In such an optical pickup device, the transmittance varies to a large extent due to not only the increase of surface reflection of the above-mentioned optical lens, but also the orientation of the incident polarized light; therefore, the lowering of pickup function in the reading processing of a detection signal has been brought about.

Further, in an optical lens having a diffractive grating formed on the surface for the correction of aberration owing to interchanging between a DVD and a CD for example, the degree of increase of the angle of incidence of an incident light becomes larger depending on the density of the grating, which makes larger the influence on the lowering of pickup function.

It is another object of this invention to make it possible to reduce surface reflection to prevent the lowering of pickup function without forming a dielectric film.

Incidentally, in a conventional optical pickup device, there has been a problem that the number of component members to be mounted such as the optical elements used was large, which raised the cost. On top of it, it is necessary that a process for obtaining a specified shape is applied to the surface of a base material in order to manufacture a polarized light splitting element and a wave plate; further, it is necessary to apply the above-mentioned process to each polarized light splitting element and each wave plate, which is not desirable from the view point of mass production, and brings about the lowering of the productivity.

Further, there has been a problem that the space occupied by the various kinds of optical members arranged there including the above-mentioned polarized light splitting element and a wave plate became large, and it could not contribute to making the size of the above-mentioned optical pickup device etc. smaller.

It is another object of this invention, in order to make it possible to contribute to making the size of the apparatus smaller while preventing the lowering of the productivity of an optical pickup apparatus, an optical element, etc., for a base material of the optical element to be used in those apparatus, to enable the working of the base material having a shape varying three-dimensionally in a sub-micron order.

### SUMMARY OF THE INVENTION

For the purpose of solving the above-mentioned problems, this invention has any one of the following structures.

(1) An optical element working method of producing an optical element having a microscopic pattern, comprises:

a pattern drawing step for forming, corresponding to the optical element, a specified pattern on a base material including a layer on which a pattern is to be drawn, wherein

said layer on which a pattern is to be drawn has a curved surface, and

said specified pattern is drawn by irradiating (or applying) an electron beam to said layer on which a pattern is to be drawn.

(2) A pattern drawing apparatus for forming a specified pattern on a base material including a layer on which a pattern is to be drawn, comprises:

a moving means for moving the focus position of an electron beam relatively with respect to said base material, in correspondence to said layer having a curved surface on which a pattern is to be drawn, and

an electron beam irradiating (or applying) means for carrying out the drawing of said specified pattern through the application of an electron beam to said layer on which a pattern is to be drawn.

(3) An optical element produced by the above-mentioned (1) or (2).

### BRIEF DESCRIPTION OF THE DRAWINGS

FIG. 1 is an explanatory drawing showing the outline structure of the whole of a pattern drawing apparatus using an electron beam of this invention;

FIG. 2(A) and FIG. 2(B) are explanatory drawings showing a base material on which a pattern is to be drawn by the pattern drawing apparatus using an electron beam shown in FIG. 1, and FIG. 2(C) is an explanatory drawing for explaining the principle of pattern drawing;

FIG. 3 is an explanatory drawing for explaining the principle of a measurement apparatus;

FIG. 4 is an explanatory drawing for explaining the principle of a measurement apparatus;

FIG. 5(A) to FIG. 5(C) are drawings for explaining the method of measuring the height of the surface of a base material;

FIG. 6 is an explanatory drawing showing the relation between the light application and light reception in a measurement apparatus;

FIG. 7 is a characteristic graph showing the relation between the signal output and the height of a base material;

FIG. 8 is a flow chart showing the steps of processing procedure in the case where a pattern is drawn on a base material by means of a pattern drawing apparatus using an electron beam of this invention;

FIG. 9 is a flow chart showing the steps of procedure for controlling a stage carrying a base material in the Z direction;

FIG. 10 is a flow chart showing the steps of processing procedure for controlling the electric current for energizing the electron lens in a pattern drawing apparatus using an electron beam of this invention;

FIG. 11 is a flow chart showing the steps of processing procedure for making a correction during pattern drawing;

FIG. 12 is an explanatory drawing showing the steps of processing procedure in the case where the position of drawing on an base material is converted;

FIG. 13(A) to FIG. 13(F) are explanatory drawings for explaining the steps of overall processing procedure in the case where a metal molding die is formed by using a base material;

FIG. 14 is an explanatory drawing for explaining the beam waist in a pattern drawing apparatus using an electron beam;

FIG. 15 is an explanatory drawing showing an example of the outline structure of a base material of this invention;

FIG. 16 is an explanatory drawing showing the essential part of the base material shown in FIG. 15 in detail;

FIG. 17 is a functional block diagram showing the detail of a control system for practicing pattern drawing with a specified dose distribution in a pattern drawing apparatus using an electron beam;

FIG. 18 is a functional block diagram showing in more detail the structure of a control system of a pattern drawing apparatus using an electron beam;

FIG. 19 is a characteristic graph showing the relation between the radial position on a base material and the surface reflectance;

FIG. 20 is a characteristic graph showing the relation between the radial position on a base material and the surface reflectance;

FIG. 21 is a characteristic graph showing the relation between the radial position on a base material and the surface reflectance;

FIG. 22 is a characteristic graph showing the relation between the radial position on a base material and the surface reflectance;

FIG. 23 is an explanatory drawing for explaining the condition for calculating a characteristic graph;

FIG. 24 is a flow chart showing the steps of processing procedure in the case where a pattern is drawn on a base material by means of a pattern drawing apparatus using an electron beam of this invention;

FIG. 25 is a flow chart showing the steps of processing procedure in the case where a pattern is drawn on a base material by means of a pattern drawing apparatus using an electron beam of this invention;

FIG. 26 is a flow chart showing the steps of processing procedure in the case where a pattern is drawn on a base material by means of a pattern drawing apparatus using an electron beam of this invention;

FIG. 27(A) is an explanatory drawing showing a pattern to be drawn, and FIG. 27(B) is a explanatory drawing showing a dose distribution;

FIG. 28(A) to FIG. 28(D) are explanatory drawings for explaining the overall steps of processing procedure in the case where a molding die is formed by using a base material;

FIG. 29(A) to FIG. 29(C) are explanatory drawings for explaining the overall steps of processing procedure in the case where a molding die is formed by using a base material;

FIG. 30 is an explanatory drawing showing the outline of an optical pickup device utilizing a base material of this invention;

FIG. 31 is an explanatory drawing showing an example of the outline structure of a base material of an example of the embodiment of this invention;

FIG. 32 is an explanatory drawing showing an example of the outline structure of a base material of an example of the embodiment of this invention;

FIG. 33 is an explanatory drawing for explaining the principle of an optical system using a polarized light splitting element and a wave plate;

FIG. 34(A) and FIG. 34(B) are explanatory drawings showing the characteristics of a TM wave and a TE wave generated by a wave plate;

FIG. 35(A) and FIG. 35(B) are explanatory drawings showing the characteristics of a TM wave and a TE wave generated by a polarized light splitting element;

FIG. 36 is a flow chart showing the steps of processing procedure in the case where a pattern is drawn on a base material by means of a pattern drawing apparatus using an electron beam of this invention;

FIG. 37(A) to FIG. 37(D) are explanatory drawings for explaining the overall steps of processing procedure in the case where a metal die is formed by using a base material and a base material is manufactured;

FIG. 38(A) to FIG. 38(C) are explanatory drawings for explaining the overall steps of processing procedure in the case where a metal die is formed by using a base material and a base material is manufactured;

FIG. 39(A) to FIG. 39(D) are explanatory drawings for explaining the overall steps of processing procedure in the case where a metal die is formed by using a base material and a base material is manufactured;

FIG. 40(A) to FIG. 40(C) are explanatory drawings for explaining the overall steps of processing procedure in the case where a metal die is formed by using a base material and a base material is manufactured;

FIG. 41 is an explanatory drawing showing the outline of an optical pickup device utilizing a base material of this invention;

FIG. 42 is an explanatory drawing showing an example of the outline structure of a base material of an example of the embodiment of this invention;

FIG. 43 is an explanatory drawing for explaining the principle of a polarized light splitting layer to be formed on the base material shown in FIG. 42;

FIG. 44 is an explanatory drawing showing an example of the outline structure of a base material of an example of the embodiment of this invention;

FIG. 45(A) to FIG. 45(D) are explanatory drawings for explaining the overall steps of processing procedure in the case where a metal die is formed by using a base material and a base material is manufactured;

FIG. 46(A) to FIG. 46(C) are explanatory drawings for explaining the overall steps of processing procedure in the case where a metal die is formed by using a base material and a base material is manufactured;

FIG. 47 is an explanatory drawing for explaining an example of a base material manufactured by a metal die for molding; and

FIG. 48 is an explanatory drawing showing the outline of an optical pickup device utilizing a base material of this invention.

### DETAILED DESCRIPTION OF THE PREFERRED EMBODIMENT

In the following, some suitable examples of the embodiment of this invention will be concretely explained with reference to the drawings.

### The First Example of the Embodiment

### The Overall Structure of a Pattern Drawing Apparatus Using an Electron Beam

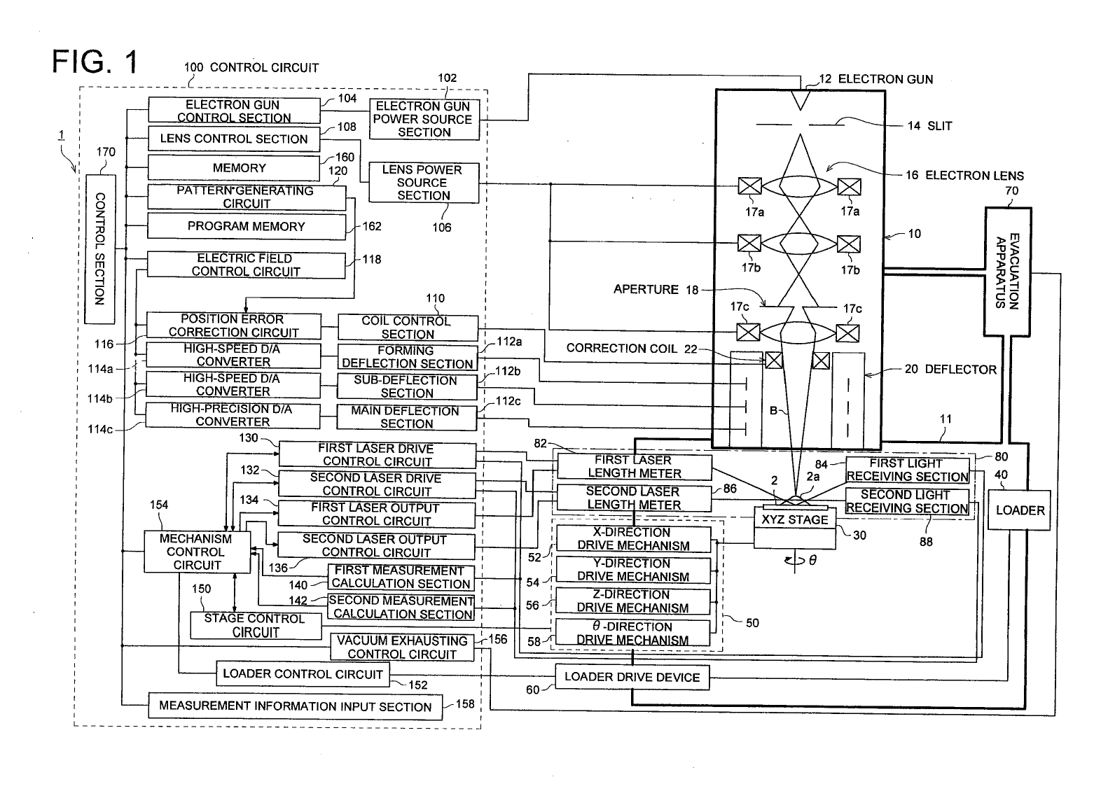

First, prior to the explanation of a method of drawing a pattern on a base material having a curved surface, which is characteristic of this invention, the outline structure of the whole of a pattern drawing apparatus using an electron beam will be explained with reference to FIG. 1. FIG. 1 is an explanatory drawing showing the overall structure of a pattern drawing apparatus using an electron beam of this example.

The pattern drawing apparatus using an electron beam 1, as shown in FIG. 1, scans a base material 2 as the object of pattern drawing at a high speed with a high-current electron beam probe having a high resolving power formed, and has a structure comprising an electron gun 12 as an electron beam generating means, which forms an electron beam probe having a high resolving power and generates an electron beam to practice a beam irradiation on a target, a slit 14 for letting an electron beam from the electron gun 12 pass, an electron lens 16 for controlling the focus position of the electron beam passing through the slit 14 with respect to said base material 2, an aperture 18 disposed at a position on the path through which an electron beam is emitted, a deflector 20 for controlling the scanning position on the base material 2 as the target, etc. by deflecting an electron beam, and a correction coil for correcting deflection. Besides, these parts is arranged inside a lens-barrel 10 and is maintained in a vacuum state while an electron beam is emitted.

Moreover, the pattern drawing apparatus using an electron beam 1 has a structure further comprising an XYZ stage 30 as a carrying table for placing a base material 2 as an object of pattern drawing on it, a loader 40 as a conveyance means for conveying a base material 2 to the setting position on the XYZ stage 30, a measurement apparatus 80 as a measuring means for measuring the reference points on the surface of a base material 2 on the XYZ stage 30, a stage driving means 50 as a drive means for driving the XYZ stage 30, a loader driving means 60 for driving the loader, an evacuation apparatus 70 for carrying out exhaustion to make vacuum the inside of the lens-barrel 10 and the inside of a case 11 including the XYZ stage, and a control circuit 100 as a control means for conducting the control of these.

Further, as regards the electron lens 16, a plurality of electronic lenses are generated by the electric currents energizing the respective coils 17a, 17b, and 17c placed separately at plural positions along the height direction, and they are controlled by the electric currents respectively, to control the focus position of an electron beam.

The measuring apparatus 80 has a structure comprising a first laser length meter (length measuring device) 82 for measuring a base material 2 by the application (irradiation) of a laser beam to the base material 2, a first light receiving unit 84 for receiving a laser beam which is emitted by the first laser length meter 82 (a first irradiation light) and is reflected by the base material 2, a second laser length meter 86 for carrying out irradiation at an angle of incidence different from that of the first laser length meter 82, and a second light receiving section 86 for receiving a laser beam which is emitted by the second laser length meter 86 (a second irradiation light) and is reflected by the base material 2. In addition, the first laser length meter and the first light receiving section in this example compose “the first optical system” of this invention, and the second laser length meter and the second light receiving section compose “the second optical system” of this invention.

The stage driving means 50 has a structure comprising an X-driving mechanism 52 for driving the XYZ stage in the X direction, a Y-driving mechanism 54 for driving the XYZ stage in the Y direction, a Z-driving mechanism 56 for driving the XYZ stage in the Z direction, and a θ-driving mechanism SB for driving the XYZ stage in the θ direction. By means of these, it is possible to move the XYZ stage three-dimensionally, or to make an alignment.

The control circuit 100 has a structure comprising an electron gun power source section 102, an electron gun controlling section 104 for adjusting and controlling the electric current and voltage in the electron gun power source section 102, a lens power source section 106 for energizing the electron lens 16 (each of the plural electronic lenses), and a lens control section 108 for adjusting and controlling the electric currents corresponding to the respective electronic lenses in this lens power source section 106.

Further, the control circuit 100 has a structure further comprising a coil controlling section 110 for controlling the correction coil 22, a forming deflection section 112a for carrying out the deflection in the forming direction, sub-deflection section 112b for carrying out the deflection in the sub-scanning direction by the deflector 20, a main deflection section 112c for carrying out the deflection in the main scanning direction by the deflector 20, a high-speed D/A converter 114a for converting a digital signal into an analogue signal in order to control the forming deflection section 112a, a high-speed D/A converter 114b for converting a digital signal into an analogue signal in order to control the sub-deflection section 112b, and a high-precision D/A converter 114c for converting a digital signal into an analogue signal in order to control the main deflection section 112c.

Further, the control circuit 100 has a structure further comprising a positional error correcting circuit 116 for correcting a positional error in the deflector 20, in other words, for urging the correction of a positional error by supplying a positional error correction signal etc. to each of the high-speed D/A converters 114a and 114b, and the high-precision D/A converter 114c, or carrying out the correction of a positional error by the correction coil 22 through supplying the above-mentioned signals to the coil controlling section 110, an electric field controlling circuit 118 as an electric field controlling means for controlling the electric field of an electron beam through controlling this positional error correcting circuit 116, the high-speed D/A converter 114a and 114b, and the high-precision D/A converter 114c, and a pattern generating circuit 120 for generating a pattern to be drawn etc. for the above-mentioned base material.

Furthermore, the control circuit 100 has a structure further comprising a first laser drive controlling circuit 130 for carrying out the drive control of the movement of the laser irradiation position, the incident angle of the irradiation laser, etc. through moving the first laser length meter 82, a second laser drive controlling circuit 132 for carrying out the drive control of the movement of the laser irradiation position, the incident angle of the irradiation laser, etc. through moving the second laser length meter 86, a first laser output controlling circuit 134 for adjusting and controlling the output (the light intensity of a laser beam) of the irradiation laser beam at the first laser length meter 82, a second laser output controlling circuit 136 for adjusting and controlling the output of the irradiation laser beam at the second laser length meter 86, and a first measurement calculation section 140 for calculating the result of the measurement on the basis of the result of light receiving at the first light receiving unit 84, and a second measurement calculation unit 142 for calculating the result of the measurement on the basis of the result of light receiving at the second light receiving section 88.

Furthermore, the control circuit 100 has a structure further comprising a stage control circuit 150 for controlling the stage driving means 50, a loader control circuit 152 for control the loader driving apparatus 60, a mechanism control circuit 154 for controlling the above-mentioned first and second laser driving circuits 130 and 132, first and second laser output control circuits 134 and 136, first and second measurement calculation sections 140 and 142, stage control circuit 150, and loader control circuit 152, an evacuation control circuit 156 for controlling the evacuation of the evacuation apparatus 70, measurement information inputting section 158 for inputting measurement information, a memory 160 as a memory means for memorizing inputted information and other plural kinds of information, a program memory 162 memorizing a control program for practicing various kinds of controls, and a control section 170 conducting the control of the above-mentioned various parts formed of, for example, a CPU or the like.

In addition, the first measurement calculation unit and the second measurement calculation unit can compose “the measurement calculation means” of this invention.

In the pattern drawing apparatus using an electron beam 1 having a structure as described in the above, when a base material 2, having conveyed by the loader 40, is placed on the XYZ stage 30, the air and dusts etc. in the lens-barrel 10 and the case 11 are exhausted by the evacuation apparatus 70, and then, an electron beam is emitted from the electron gun 12.

The electron beam, having been emitted from the electron gun 12, is deflected by the deflector 20 through the electron lens 16; the deflected electron beam B (hereinafter, only the electron beam that has been controlled to be deflected after it passed the electron lens 16 is sometimes referred to as “the electron beam B” with a sign B attached) is applied to the surface of a base material 2 on the XYZ stage 30, for example, to the pattern drawing position on the curved surface area (curved surface) 2a, to practice pattern drawing.

At this time, the parameters of the pattern drawing position on the base material 2 (at least a heightwise position or a position data with regard to height among the drawing position parameters) or the positions of the reference points to be described later are measured; the control circuit 100 adjusts and controls the value of the electric currents flowing in the coils 17a, 17b, and 17c of the electron lens 16 etc., to control the position within the depth of the focus, that is, the focus position, which is controlled to come to the above-mentioned pattern drawing position.

In another way, on the basis of the result of measurement, the control circuit 100 moves the XYZ stage 30 to make the focus position of the above-mentioned electron beam B agree with the above-mentioned pattern drawing position by controlling the stage driving means 50.

Further, in this example, the adjustment of the focus position may be done by any one of the control of an electron beam and the control of the XYZ stage 30, or by utilizing the both of them (in addition, the detail of moving and controlling the focus position is to be described later).

(Measurement Apparatus)

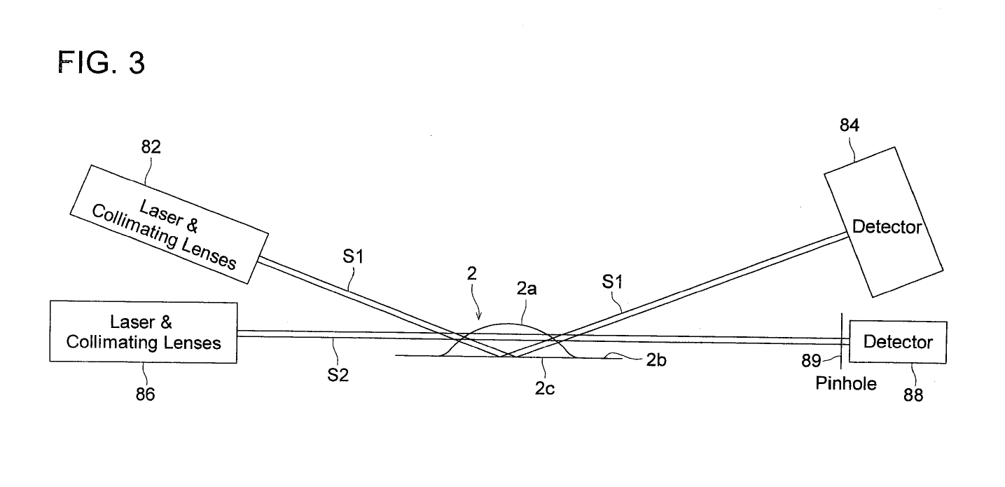

Next, the measurement apparatus 80 will be explained with reference to FIG. 3. To state it in more detail, as shown in FIG. 3, the measurement apparatus 80 comprises the first laser length meter 82, the first light receiving section 84, the second laser length meter 86, the second light receiving section 88, etc.

By means of the first laser length meter 82, the first light beam S1 is applied to the base material 2 from the direction crossing the electron beam, and the first light intensity distribution is detected by receiving the first light beam S1 transmitting the base material 2.

At this time, as shown in FIG. 3, it is understood that, because the first light beam S1 is reflected by the bottom portion 2c of the base material 2, the position (height) of the flat portion 2b of the base material 2 is measured and calculated on the basis of the first light intensity distribution. However, in this case, the position (height) of any point on the curved surface portion 2a of the base material cannot be measured.

Therefore, in this example, the second laser length meter 86 is further provided. That is, by means of the second laser length meter 86, the second light beam S2 is applied to the base material 2 from the direction approximately perpendicular to the electron beam, which is different from the first light beam S1, and the second light intensity distribution is detected by receiving the second light beam transmitted by the base material 2 through a pinhole 84 provided in the second light receiving section 88.

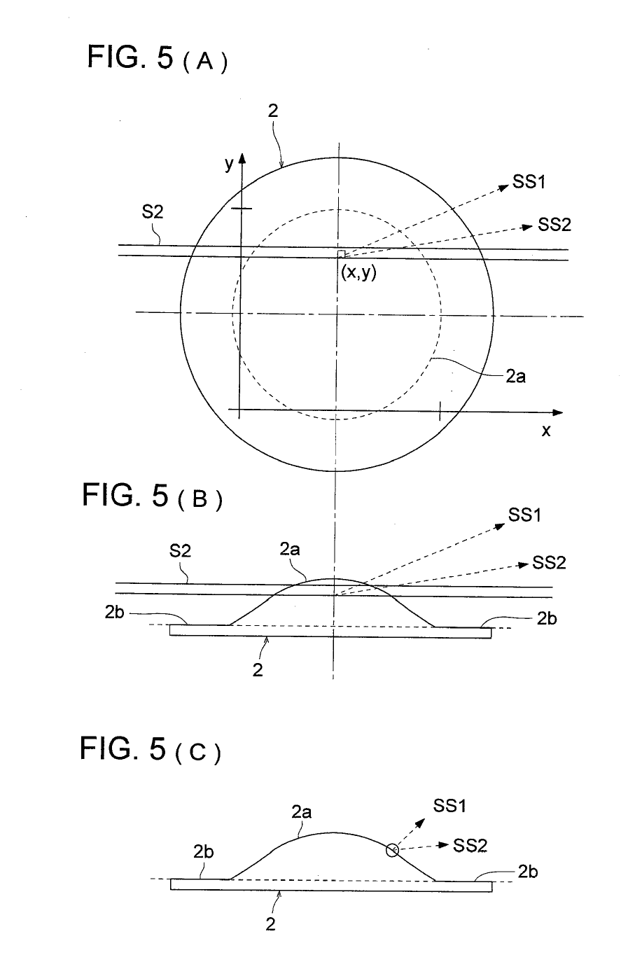

In this case, as shown in FIG. 5(A) to FIG. 5(C), because the second light beam S2 is transmitted through a point on the curved surface portion 2a, the position (height) of the point on the curved surface portion 2a projecting from the flat portion 2b of the base material 2 can be measured and calculated on the basis of the above-mentioned second light intensity distribution.

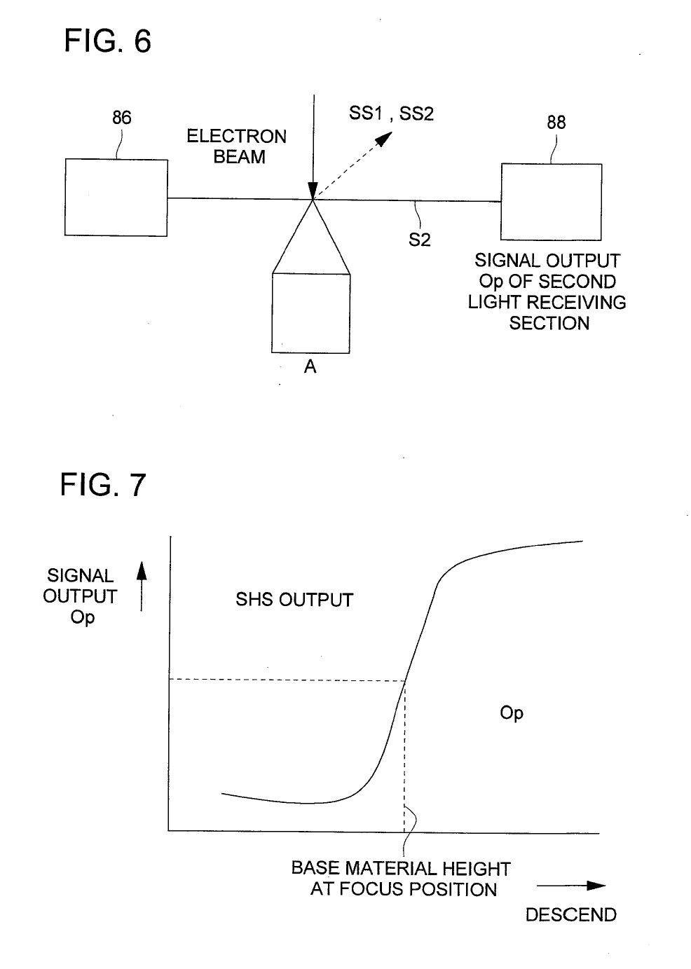

To state it concretely, if the second light beam S2 is transmitted through a point (x, y) on the curved surface portion 2a in an XY standard coordinate system with a certain height, as shown in FIG. 5(A) to FIG. 5(C), at this point (x, y), owing to the second light beam colliding with the curved surface of the curved surface portion 2a, the scattered light components SS1 and SS2 are generated, and the light intensity is reduced by these scattered light components. In this way, as shown in FIG. 6, the position (height) is measured and calculated on the basis of the second light intensity distribution detected by the second light receiving section 88.

At the time of this calculation, as shown in FIG. 6, because the signal output Op from the second light receiving section 88 has a correlation with the height of the base material as shown in the characteristic graph of FIG. 7, by storing a correlation relation table representing this characteristic, namely the correlation relation, in the memory 160 of the control circuit 100 or the like, the height position can be calculated on the basis of the signal output Op from the second light receiving section 88.

Further, with this height position of the base material taken as a pattern drawing position for example, the above-mentioned adjustment of the focus position of an electron beam is carried out, and pattern drawing is practiced.

(Summary of the Principle of Calculation of a Pattern Drawing Position)

Next, summary of the principle in pattern drawing in the pattern drawing apparatus using an electron beam 1, which is characteristic of this example, will be explained.

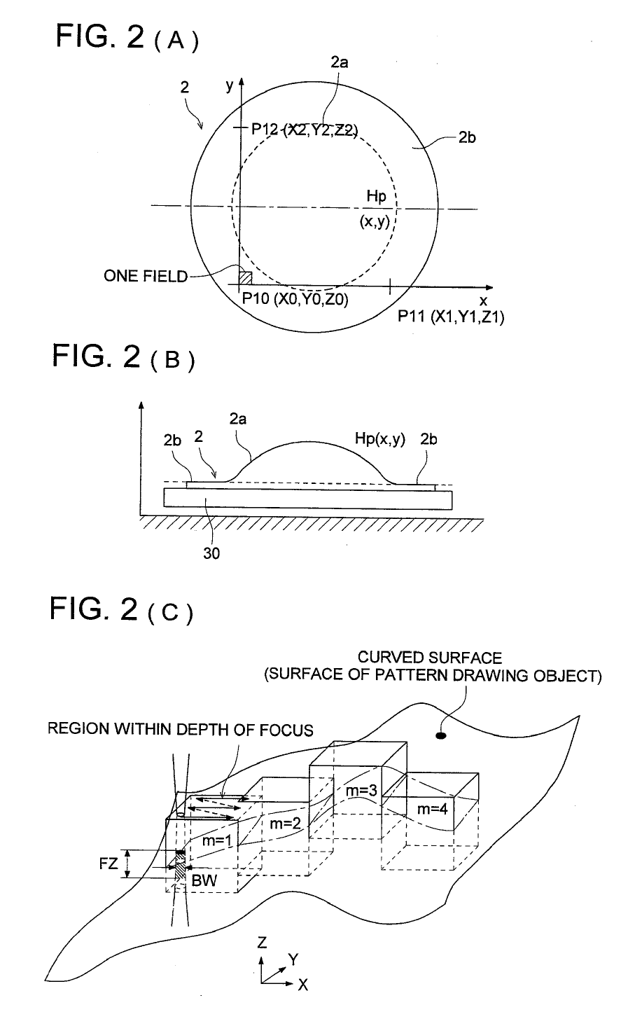

First, as shown in FIG. 2(A) and FIG. 2(B), it is desirable that the base material 2 is formed of an optical element made of resin, for example, an optical lens or the like, and it has a structure comprising the flat portion 2b having approximately a shape of a flat plate in a cross-section and the curved surface portion 2a forming a curved surface projecting from this flat portion 2b. This curved surface of the curved surface portion 2a is not limited to a spherical surface, but any other free curved surface having variations in the height direction such as an aspherical surface may be appropriate.

As regards such a base material 2, before the base material 2 is previously placed on the XYZ stage 30, a plurality (for example three) of reference points P00, P01, and P02 on the base material 2 are determined and their positions are measured beforehand (the first measurement). By doing this, for example, X-axis is defined by the reference points P00 and P01, and Y-axis is defined by the reference points P00 and P02; the first standard coordinate system in a three-dimensional coordinate system can be calculated. Now, let Ho(x, y) be a height position in the first coordinate system (the first height position). By doing this, the calculation of the thickness distribution of the base material 2 can be carried out.

On the other hand, also after the base material 2 is placed on the XYZ stage 30, the same process is practiced. That is, as shown in FIG. 2(A), a plurality (for example three) of reference points on the base material 2 are determined and their positions are measured (the second measurement). By doing this, for example, X-axis is defined by the reference points P10 and P11, and Y-axis is defined by the reference points P10 and P12; the second standard coordinate in a three-dimensional coordinate system can be calculated.

Further, a coordinate transformation matrix etc. for transforming the first standard coordinate system into the second standard coordinate system are calculated by using these reference points P00, P01, P02, P10, P11, and P12, and by utilizing this transformation matrix, the height position Hp(x, y) in the second standard coordinate system (second height position) corresponding to the above-mentioned Ho(x, y) is calculated; this position is defined as an optimum focus position, that is, a position with which the focus position of the electron beam is to agree. By doing this, the correction of the above-mentioned thickness distribution of the base material 2 can be performed.

Further, the above-mentioned second measurement can be performed by using the measurement apparatus 80 as the first measuring means of the pattern drawing apparatus using an electron beam 1.

In addition, it is necessary that the first measurement is practiced at another place beforehand by means of another measurement apparatus. For such a measurement apparatus for measuring the reference points previously before the base material 2 is placed on the XYZ stage 30, a measurement apparatus 200 having the completely same structure as the above-mentioned measurement apparatus 80 (the second measuring means) can be employed.

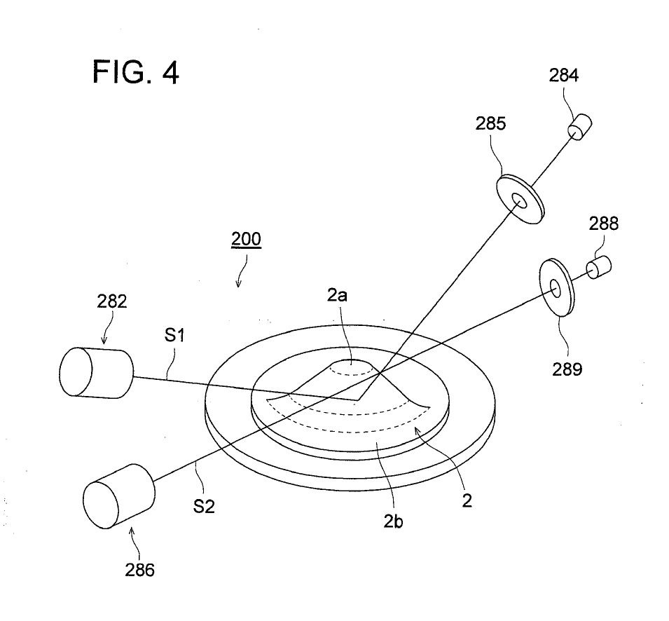

As shown in FIG. 4, this measurement apparatus 200 has a structure comprising, in the same way as the above-mentioned measurement apparatus 80, a first laser length meter 282, a second laser length meter 286, a first light receiving unit 284 provided with a pinhole 285, a second laser length meter 288 provided with a pinhole 289, a measurement calculation unit for calculating the result of these measurements (not shown in the drawing), a control means provided with various kinds of control systems (not shown in the drawing), etc.

In this case, the result of measurement by the measurement apparatus 200 is inputted, for example, in the measurement information inputting unit 158 shown in FIG. 1, or the data are transmitted through a network (not shown in the drawing) connected to the control circuit 100, and stored in the memory 160 or the like.

Of course, in such a case as a modified example to be described later, it can be considered a case where this measurement apparatus 200 becomes unnecessary (the detail is to be described later).

As described in the above, a pattern drawing position is calculated, the focus position of an electron beam is controlled, and pattern drawing is carried out.

To state it concretely, as shown in FIG. 2(C), the drawing position of an electron beam on the base material is adjusted and controlled to a pattern drawing position (pattern-drawing position) in one field (m=1) of a unit space in the three-dimensional standard coordinate system. (This control is carried out, as described in the foregoing, by at least one of the adjustment of the electric current value in the electron lens 16 to adjust the depth of focus FZ of the electron beam and adjustment the drive control of the XYZ stage 30

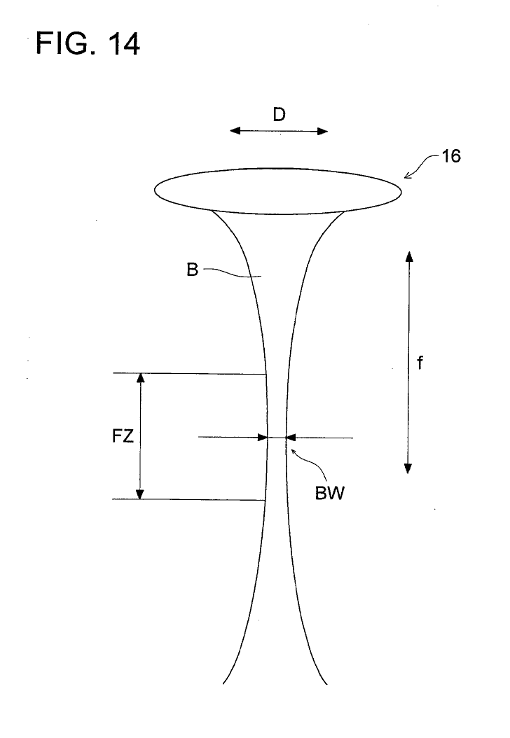

In addition, in this example, a field is set in such a way that the amount of height variation throughout one field is longer than the depth of focus FZ, but this invention is not limited to this. In this case, the depth of focus FZ represents, as shown in FIG. 14, the length of the range where the beam waist BW is effective in the electron beam B applied through the electron lens 16. Besides, in the case of the electron beam B, as shown in FIG. 14, with D put as the width of the electron lens 16 and f put as the depth up to the beam waist BW (a position where the beam waist is thinnest), D/f is about 0.01; further for example, the resolving power is of the order 50 nm, and the depth of focus is of the order several tens μm.

Further, as shown in FIG. 2(C), for example, by scanning in the X direction sequentially while being shifted in the Y direction within one field, pattern drawing within one field is to be performed. Further, inside one field, if there is an area where pattern drawing is not done, for said area too, the focus position is moved in the Z direction while it is being controlled in the above-mentioned way, and a pattern drawing process based on the same scanning is carried out.

Next, after pattern drawing within one field is done, also in other fields, for example, in a field of m=2, or in a field of m=3, in the same way as the above, pattern drawing is carried out in real time while the measurement and calculation of the pattern drawing position are being done. In this way, when the whole pattern drawing is finished for the pattern drawing area on which the pattern is to be drawn, it can be said that the pattern drawing on the surface of the base material 2 has been finished.

In addition, in this example, this pattern drawing area is taken for a layer on which a pattern is to be drawn, and the portion corresponding to the curved surface on the surface of the curved surface portion 2a is taken for a surface on which a pattern is to be drawn.

Further, the processing program for practicing the above-mentioned various kinds of operation processing, measurement processing, and control processing is stored beforehand in the program memory 162 as a control program.

(Processing Procedure)

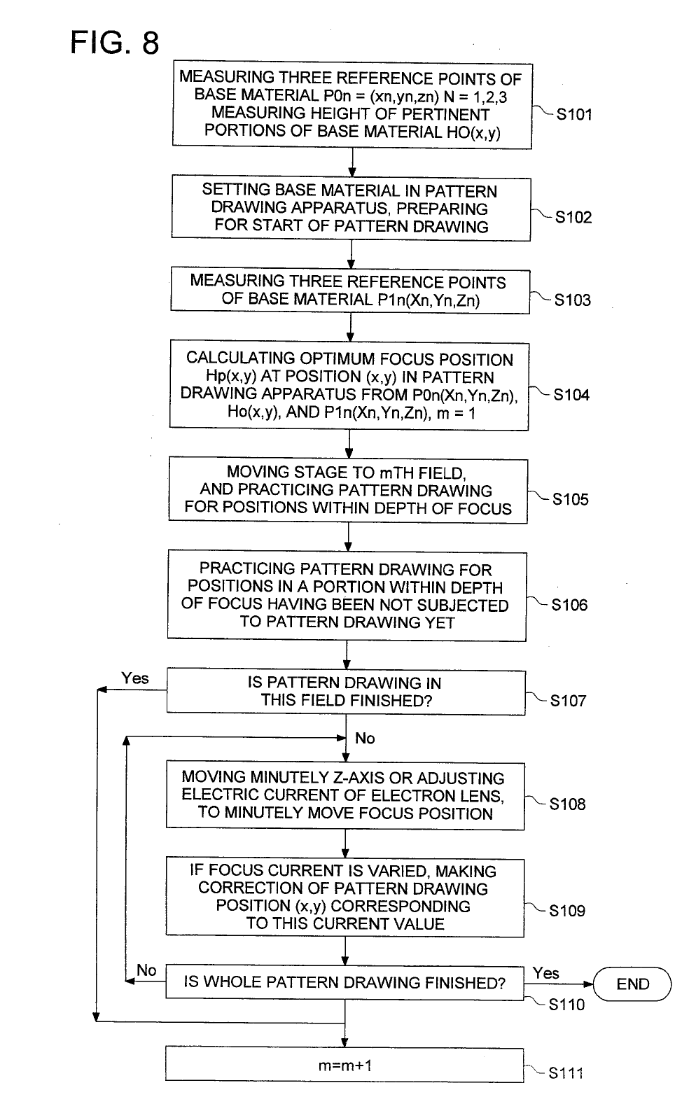

Next, the detail of the processing procedure in the case where pattern drawing is carried out on a base material by means of a pattern drawing apparatus using an electron beam having a structure as described in the above will be explained with reference to FIG. 8 to FIG. 12.

(Whole Pattern Drawing Process)

First, a general flow of the whole of a pattern drawing process will be explained with reference to FIG. 8.

The measurement of the three reference points P0n=(xn, yn, zn), n=1-3, of a base material and the height Ho(x, y) of various points of the base material is practiced beforehand by means of the measurement apparatus 200 (S101).

Next, setting of the measured base material to the pattern drawing apparatus using an electron beam 1 is carried out, and preparation for the start of pattern drawing is carried out (S102). In addition, in this step, the result of the measurement made by the above-mentioned measurement apparatus 200 is inputted by means of the measurement information inputting unit 158 of the pattern drawing apparatus using an electron beam 1. The result of the measurement inputted is stored in the memory 160 or the like.

Further, in the case where it is made up “a system” in which the pattern drawing apparatus using an electron beam 1 and the measurement apparatus 200 are connected through a network in a clean room or a chamber, and the result of the measurement done by the measurement apparatus 200 is uniquely stored in the memory 160 of the pattern drawing apparatus using an electron beam 1, the above-mentioned input operation is unnecessary. This “system” may be defined as a pattern drawing apparatus using an electron beam including the both of the two measurement apparatus, namely, the above-mentioned measurement apparatus for measuring a base material previously before setting (the second measurement apparatus) and the measurement apparatus for measuring a base material after setting (the first measurement apparatus).

Furthermore, also it is appropriate to make the system have a structure in which these two measurement apparatus are reduced to one that is capable of both measurement by itself (for example, a structure in which, in the conveyance path for conveying a base material from the position of gripping it with a chuck to on the stage, the measurement apparatus moves between the measurement position before setting (the first position) and the measurement position after setting (the second position), while a measurement stage for the measurement before setting is located at the above-mentioned first position, and the stage is located at the second position, or a structure in which a measurement stage and a stage are prepared beforehand, and any one of the stages is located at the measurement position of the pattern drawing position as occasion demands).

Next, the measurement of the three reference points P1n(Xn, Yn, Zn) is carried out by means of the measurement apparatus 80 provided in the pattern drawing area of the pattern drawing apparatus using an electron beam 1 (S103).

Then, on the basis of the information on the three reference points P0n(xn, yn, zn) measured in the above-mentioned step S101 beforehand and the information on the height Ho(x, y) of various points (the first coordinate system), and the information on the three reference points P1n(Xn, Yn, Zn) measured in the above-mentioned step S103 (the second coordinate system), it is carried out the calculation of the optimum focus position Hp(x, y) of the beam in the pattern drawing apparatus using an electron beam 1 (S104). In addition, a processing program in which the operation algorithm for practicing this calculation is embodied is stored in the program memory for example, and processed together with other processing programs by the control section as occasion demands. This processing program can compose an optimum focus position calculating means including, for example, the control unit 170 and the program memory 162. (Besides, the detail of the transformation processing of the coordinate system is to be described later.) Incidentally, this step S104 strictly concerns one field (for example, a unit space of 0.5×0.5×0.05 mm etc.) (m=1). In this connection, pattern drawing to be described later is performed by an electron beam scanning the area within this one field.

Next, the XYZ stage is moved to one specified field among the m divisional fields, and processing of practicing pattern drawing is carried out for a position located within the depth of focus f (S105).

Further, if there is a portion within the depth of focus on which a pattern has not been drawn yet, pattern drawing is to be done for said portion (S106).

Then, the judgement process whether or not pattern drawing for the one field concerned is finished is practiced (S107). If the result is that pattern drawing is finished for the field concerned in this judgement process, a process to substitute (m+1) for m is done (S111), and the same processing is to be carried out for the next one field (the second field).

On the other hand, if the result is that pattern drawing has not been finished yet for the first field concerned in the judgement process of S107, Z-axis is minutely moved by relatively moving one or both of the XYZ stage 30 and the lens-barrel 10, to move the focus position of the electron beam minutely (the first processing), the focus position of the beam is minutely moved by adjusting and controlling the electric current of the electron lens by the lens control unit (the second processing), or the focus position is adjusted and controlled by the both controls of the first processing and the second processing (S108).

Next, in the case where focus current is varied, correction processing for making the correction of the pattern drawing position (x, y) corresponding to this current value is practiced (S109).

Then, the judgement process whether or not whole pattern drawing has been finished is carried out (S110); if the result of the judgement is that the whole pattern drawing has not been finished, the procedure returns to the step S108, and if the result of the judgement is that the whole pattern drawing has been finished, the processing is completed.

(The Case where the XYZ Stage is Controlled)

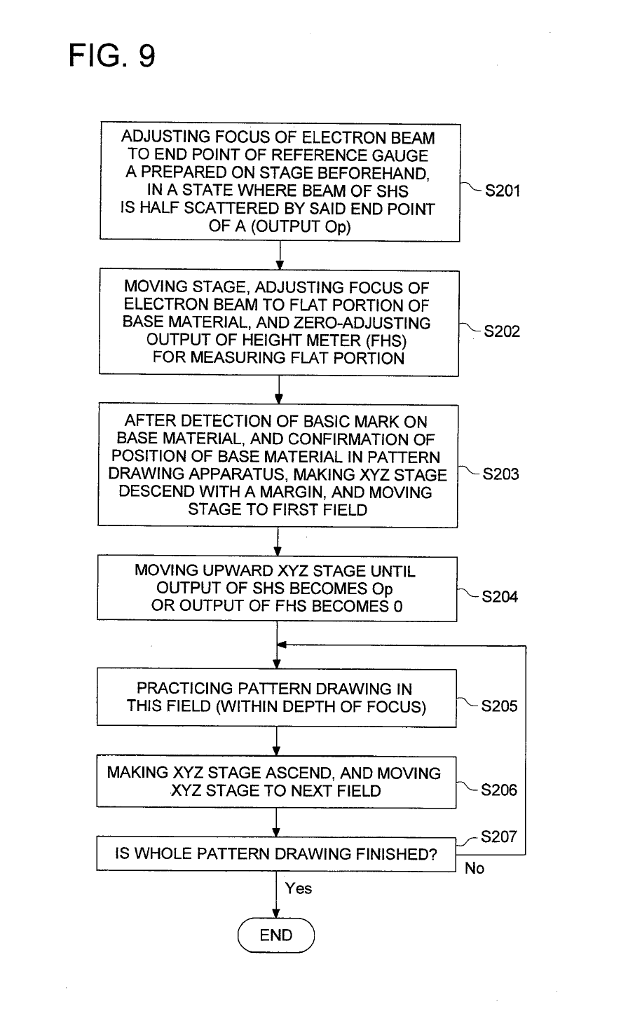

Next, it will be explained with reference to FIG. 9, the procedure of the processing in the case where the XYZ stage carrying a base material is controlled in the Z direction by means of the measurement apparatus 80.

In addition, the measurement apparatus 80 is sometimes called an SHS (a Slope Height Sensor) for its abbreviation.

Further, the dimensions of one field is the size specified by the pattern drawing range of x and y, and the depth of focus z; in this example, for instance, it is desirable to make it 0.5×0.5×0.05 mm.

First, in the state where the beam of the SHS is half scattered by the end point of the standard gauge A provided on the XYZ stage 30 beforehand (the output Op), the focal point of the electron beam is adjusted to the end point of the standard gauge A (refer to FIG. 6) (S201).

Next, by moving the XYZ stage 30, the focal point of the electron beam is adjusted to the flat portion of the base material, and the output of the height measuring device (Flat Height Sensor: FHS) is adjusted to zero (S202).

Then, after the reference mark on the base material 2 is detected, the position of the base material 2 in the pattern drawing apparatus using an electron beam 1 is recognized; after that, the XYZ stage 30 is made to descend with a margin, and it is moved to the first field (S203).

Subsequently, the XYZ stage 30 is moved upward until the output of the SHS becomes Op or the output of the FHS becomes zero (S204).

Further, pattern drawing in this field (within the depth of focus) is done (S205). Then, the XYZ stage is made to ascend again, to be moved to the next field (S206).

Next, the judgement process whether or not the whole pattern drawing has been finished is carried out (S207). In this judgement process, if the result of the judgement is that the whole pattern drawing has not been finished, the procedure returns to the step S205, and if the result of the judgement is that the whole pattern drawing has been finished, the processing is completed.

(The Case where the Electron Lens is Controlled)

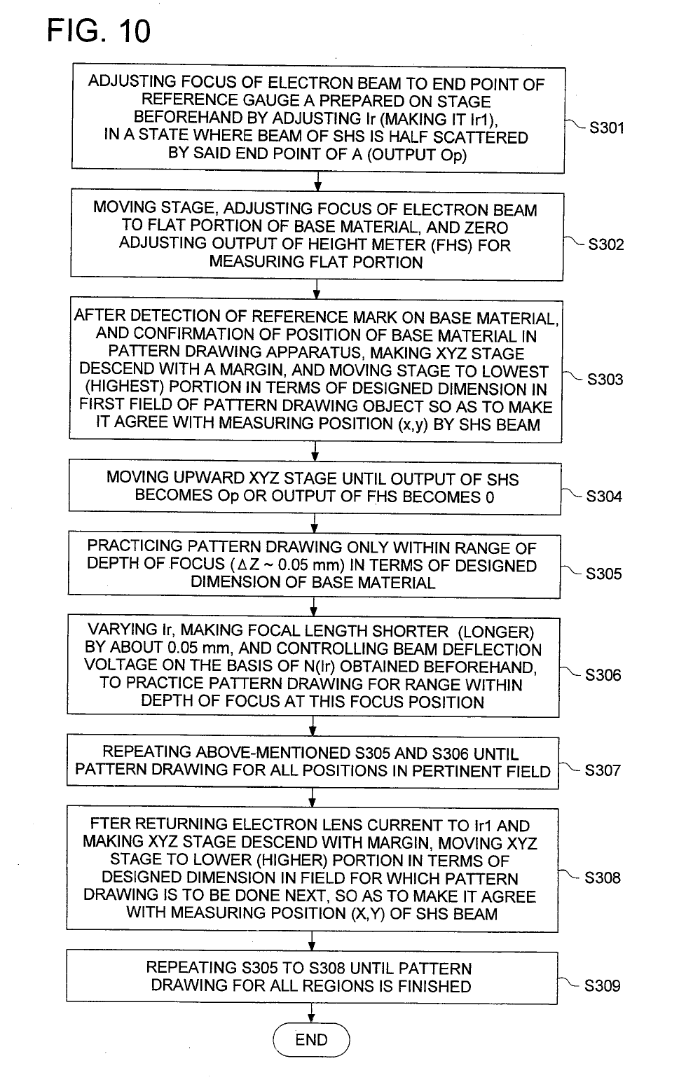

In the following, it will be explained with reference to FIG. 10, the procedure of the processing in the case where the electric current Ir energizing the electron lens is controlled by means of a measurement apparatus.

In addition, it is necessary that the control is carried out with it taken into consideration, that the relationship between the electric current Ir and the beam focus position is influenced by the beam current and the energy of the electron beam, and the relationship itself has a hysteresis. (In the following, it is assumed that the beam current and the energy of the electron beam are fixed, and the electric current Ir is set from one direction.) Further, in the processing of this case, it is desirable that the one field is set to be about 0.5×0.5 mm².

First, the electric current Ir is adjusted in the state where the beam of the SHS is half scattered by the end point of the standard gauge A provided on the XYZ stage 30 beforehand (the output Op), and the focal point of the electron beam is adjusted to the end point of the above-mentioned standard gauge A (S301). In addition, this adjusted electric current is denoted by Ir1. Further, as shown in FIG. 7, the position where the sensing output of the SHS becomes Op just corresponds to the focus position of the electron beam.

Next, by moving the XYZ stage 30, the focal point of the electron beam is adjusted to the flat portion 2b of the base material 2, and the output of the height measuring device (FHS) for measuring the flat portion 2b is adjusted to zero (S302).

Then, after the reference mark on the base material 2 is detected, the position of the base material 2 in the pattern drawing apparatus using an electron beam 1 is recognized; after that, the XYZ stage 30 is made to descend with a margin, and it is moved to the lowest (highest) portion in terms of the designed dimension in the first field where pattern drawing is to be done so as to agree with the measuring position (x, y) of the SHS beam (S303).

Subsequently, the XYZ stage 30 is moved upward until the output of the SHS becomes Op or the output of the FHS becomes zero (S304).

In this field, pattern drawing is carried out for the range where the designed dimension of the base material is within the depth of focus (ΔZ˜0.05 mm) (S305).

Next, the electric current Ir is varied, to make the focal length of the electron beam shorter (longer) by about 0.05 mm, and on the basis of N(Ir) which has been obtained beforehand, the beam deflection voltage is controlled; at this focus position, pattern drawing for the range within the depth of focus is carried out (S306).

Then, until the pattern drawing for all the positions within the field concerned is finished, the above-mentioned steps S305 and S306 are repeated (S307).

Further, the electric current for adjusting the electron lens 16 is made Ir1 again, and the XYZ stage 30 is made to descend with a margin; then, it is moved to the lowest (highest) portion in terms of the designed dimension in the field where pattern drawing is to be done next so as to agree with the measuring position (x, y) of the SHS beam (s308).

Then, until pattern drawing for all areas is finished, the steps S305 to S308 is to be practiced repeatedly.

In addition, in the case where the energy of the electron beam and the beam current are fixed, the deflection voltage of the beam (Vx, Vy) and the beam position at the focus portion are expressed by the following relation.
(x, y)=M(Ir)×(Vx, Vy),
(Vx, Vy)=N(Ir)×(x, y),
where N is the inverse matrix of the matrix M. Further, N(Ir) is to be obtained beforehand from a test pattern drawing for the values of energy and beam current to be used.

Moreover, it is desirable that the precision is made higher in the neighborhood of Ir1.

(Processing for Transforming the Position where Pattern Drawing is to be Done)

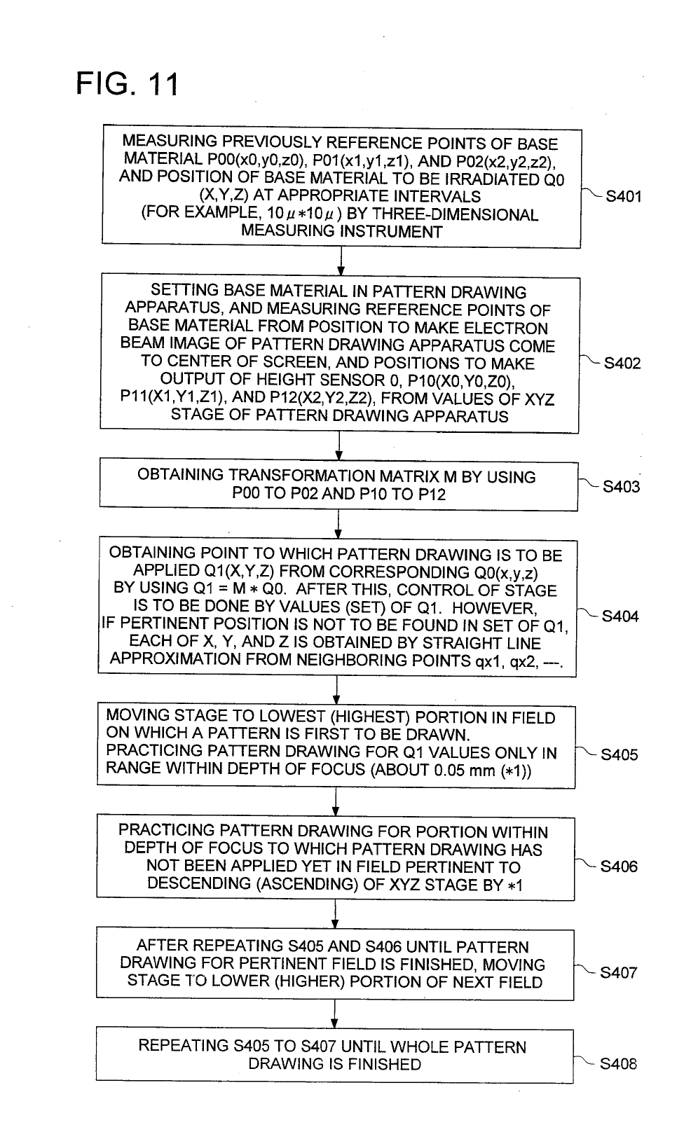

In the following, it will be explained with reference to FIG. 11, the procedure of the processing in the case where the pertinent portions of the base material are measured previously before it is set to the pattern drawing apparatus using an electron beam 1, the reference points are again measured in the pattern drawing apparatus using an electron beam 1, the position (x, y, z) where pattern drawing is to be done is transformed in said apparatus, and pattern drawing is practiced.

In FIG. 11, it is disclosed the procedure of the processing for transforming the position where pattern drawing is to be done on the base material 2. In addition, in this example, it is desirable that the dimension of the field is made the range specified by the pattern drawing range of x and y (for example, about 0.5×0.5 mm²).

First, before the base material 2 is set at a pattern drawing position, the reference points of the base material P00(x0, y0, z0), P01(x1, y1, z1), and P02(x2, y2, z2), and the irradiation positions of the base material Q0(x, y, z) at suitable intervals (for example, 10 μm×10 μm, etc.) are measured by means of a three-dimensional measuring device (S401).

Subsequently, the base material 2 is set in the pattern drawing apparatus using an electron beam 1; then, the reference points of the base material 2 are measured from the position such that the electron beam image at the pattern drawing position comes to the center of the screen, and the positions P10(X0, Y0, Z0), P11(X1, Y1, Z1), and P12(X2, Y2, Z2) to make the output of the height sensor zero are measured from the value of the XYZ stage 30 of the pattern drawing apparatus using an electron beam 1 (S402) Further, the transformation matrix M is obtained from P00 to P02 and P10 to P12 (S403).

The point Q1(X, Y, Z) where pattern drawing is to be done is calculated from the corresponding Q0(x, y, z) by Q1=M×Q0.

After that, the control of XYZ stage 30 is done by using the values (set of values) of Q1. However, if there is no pertinent position in the set of Q1, each of the values of X, Y, and Z is calculated from the neighboring points qx1, qx2, - - - by straight line approximation or the like (S404).

The XYZ stage 30 is moved to the lowest (highest) portion in the field where pattern drawing is to be done at first. Pattern drawing only for the positions whose values of Q1 are within the range of the depth of focus (for example, about 0.05 mm or so) in this field is carried out (S405).

In respect of the pertinent field, with the XYZ stage 30 made to descend (ascend), for example, by about 0.05 mm, pattern drawing for the portions within the depth of focus to which it has not been applied yet is carried out (S406).

Until pattern drawing in the pertinent field is finished, the steps S105 and S106 are repeated. Then, the stage is moved to the lowest (highest) portion of the next field (S407).

Until the whole pattern drawing is finished, the steps S405 to S407 are repeated (S408).

(Procedure of Calculation of the Matrix M)

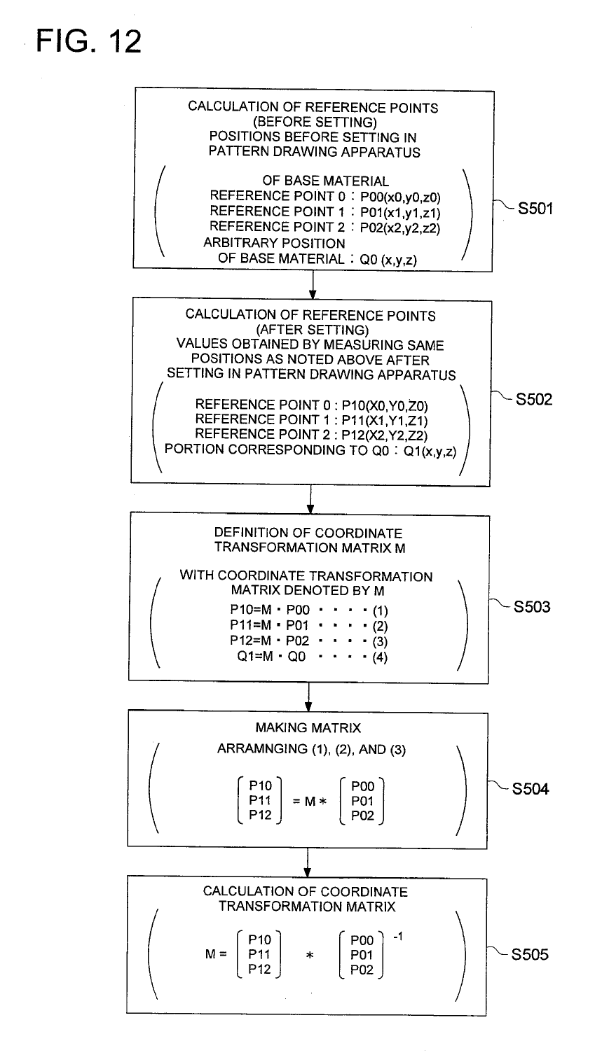

In the following, it will be explained with reference to FIG. 12, the procedure of calculation of the matrix M used in the operation in the above-mentioned step S403.

As shown in FIG. 12, before the base material 2 is set in the pattern drawing apparatus using an electron beam 1, the reference points are calculated as shown in the drawing on the basis of the result of the measurement, to determine the coordinate axes of the first coordinate system (S501).

Next, after the base material 2 is set in the pattern drawing apparatus using an electron beam 1, the reference points are calculated as shown in the drawing on the basis of the result of the measurement, to determine the coordinate axes of the second coordinate system (S502).

Now, the relationship between the reference points P00, P01, and P02 defined in the step S501 and the reference points P10, P11, and P12 defined in the step S502 is expressed by the equations (1) to (3), with the coordinate transformation matrix for transforming the first coordinate system into the second coordinate system denoted by M.

In the same way, an arbitrary position Q0 on the base material 2 in the step S501 and the position Q1 of the base material in the Step 502 corresponding to Q0 can be expressed by the equation (4).

In this way, the coordinate transformation matrix M is defined (S503). That is, to state this step in terms of processing of a level nearer to the hardware, the processing of reading out the equations of definition (1) to (4) for the coordinate transformation matrix M which has been defined beforehand from the specified area on the memory is practiced.

Next, as a previous stage for calculating the coordinate transformation matrix M, the above-mentioned equations of definition (1) to (3) are handled inclusively, to make a matrix representation as shown in the drawing (S504).

Then, an operating equation for calculating the coordinate transformation matrix M is derived (S505). In addition, in this example, for the purpose of making it easily understood, the procedure of calculating the operating equation for calculating the coordinate transformation matrix M has been explained in the order of the steps; however, also it is appropriate to make this procedure have a structure such that the steps S503 to S505 are reduced to one step, only the above-mentioned operating equation is memorized in the specified area of the memory beforehand, and operation is carried out on the basis of the result of measurements and calculations in the steps S501 and S502 as occasion demands. By doing this way, the coordinate transformation matrix M can be calculated.

In this way, when the coordinate transformation matrix M is calculated, the above-mentioned procedure steps from the step S404 on can be carried out. That is, on the basis of the coordinate transformation matrix M, by using the equation (4) in the step S503, an arbitrary position after the base material 2 is set in the pattern drawing apparatus 1 using an electron beam can be obtained.

In order to produce an optical element having a diffractive structure on the spherical or aspherical optical-function surface, or to produce a molding die for producing an optical element by injection molding, it is necessary to practice more three-dimensional working; as the result of investigations, the inventors of this application has found that utilization of a technology of direct pattern drawing and direct working using an energy beam, for example an electron beam, is suitable for very precise working because an electron beam has a shorter wavelength as compared to a laser beam for example.

On top of it, an electron beam is advantageous in the precision of working with respect to the direction of beam application (the direction of the thickness of an object of working), and even if the base material and the beam applying means (for example, a light source etc.) are relatively moved, a sufficient positional precision can be secured. For this reason, working of a solid object having a three-dimensional shape, in particular, a base material having a continuous curved surface can be easily performed.

Hence, it is possible to form an optical element having a diffractive structure on its spherical or aspherical optical-function surface, and more three-dimensional working can be easily actualized.

Further, in this case, because the focus position can be easily calculated by a control such as feed-back if the shape of the base material is grasped beforehand by means of a measurement apparatus, pattern drawing can be easily done with high precision even for a base material having a curved surface.

### The Second Example of the Embodiment

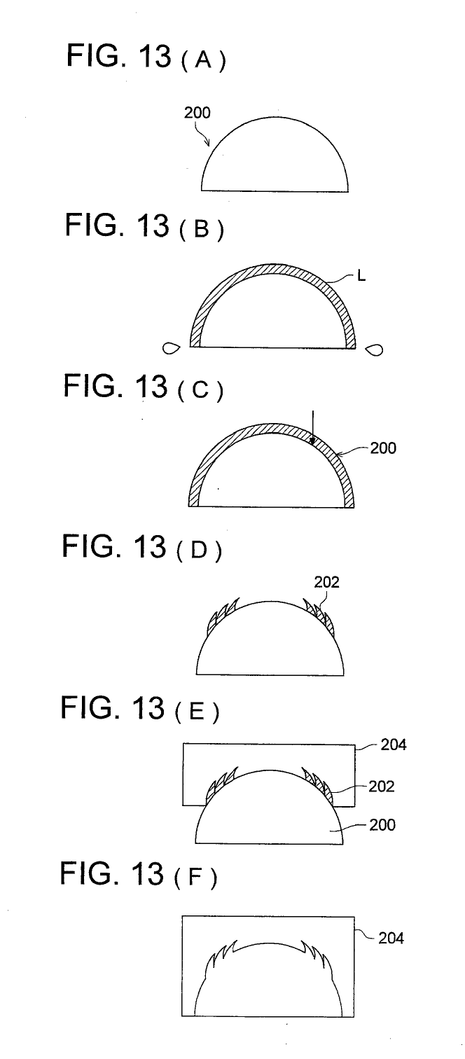

In the following, the second example of the embodiment of this invention will be explained with reference to FIG. 13. In addition, in the below description, explanation of a structure that is substantially the same as the above-mentioned first example of the embodiment will be omitted, and only the different parts will be described.

In the above-mentioned example of the embodiment, it has been disclosed the process in which high-precision working of a diffractive grating or the like is applied to a base material by means of an electron beam; however, in this example, the whole process including the above-mentioned process, in particular, a process of manufacturing a metal die for manufacturing an optical element such as an optical lens by molding will be explained.

First, aspherical working of a metal die (made of non-electrolytic nickel, etc.) is carried out by machining. Next, as shown in FIG. 13(A), resin molding of a base material 200 having the above-mentioned aspherical surface is carried out by means of the metal die (resin molding process). Further, the base material 200 is washed and dried.

Subsequently, a surface treatment of the resin base material is carried out (resin surface treatment process). In this process, for example, evaporation coating of gold (Au) or the like is done. To state it concretely, as shown in FIG. 13(B), the position adjustment of the base material is made, and a spinner is rotated while a resist material L is dropped down, to practice spin coating. Moreover, pre-baking or the like is carried out.

After spin coating, the thickness of said resist film is measured, and evaluation of the resist film is performed (resist film evaluation process) To state it concretely, as shown in FIG. 13(C), the position adjustment is made, and exposure is done while said base material is controlled with respect to each of the X, Y, and Z axes.

Next, surface smoothing treatment of the resist film of the base material 200 is carried out (surface smoothing process). Further, as shown in FIG. 13(D), while the position adjustment of the base material 200 is being made, development processing is carried out (development process). Moreover, surface hardening treatment is done.

Subsequently, by SEM observation and film thickness measurement, a process for evaluating the shape of the resist is performed (resist shape evaluation process).

Further, after that, an etching process is carried out in a dry etching method. Then, evaporation coating of a metal film 202 onto the resist surface of the base material 200 is carried out (metal evaporation coating process).

Next, in order to produce a metal die for the base material 200 to which the surface treatment has been applied, as shown in FIG. 13(E), after pre-treatment for electroforming the metal die is done, an electroforming process is carried out, and as shown in FIG. 13(F), a process of separating the metal die 204 from the base material 200 is carried out.

A surface treatment is applied to the metal die 204 which has been separated from the surface-treated base material (die surface treatment process). Then, the metal die is evaluated. After evaluation, mold products are produced by using said metal die. After that, said mold products are evaluated.

As described in the above, according to this example of the embodiment, also the above mentioned molding die for producing an optical element injection molding can be easily manufactured.

In addition, as regards an apparatus and a method of this invention, they have been explained on the basis of some specified examples of the embodiment; however, a person who is skilled in the art can make various modifications for the embodiment described in the specification of this invention without departing from the spirit and scope of this invention. For example, in the above-mentioned embodiment, the case where pattern drawing is applied directly onto the base material of an optical element such as an optical lens has been explained; however, in the case where a molding die (metal die) for molding an optical lens made of resin or the like by injection molding is worked, also it is appropriate to use the above-mentioned principle, procedure steps, and processing method.

Further, also it is appropriate to employ a structure in which the steps of measuring a plurality of reference points on the base material, calculating the standard coordinate system on the basis of the result of this measurement, and [measuring] calculating the thickness distribution of the base material on the basis of this coordinate system are practiced during application of an electron beam. Further, also it is appropriate to employ a structure in which the calculation step to calculate the optimum focus position on the basis of the thickness distribution, and the adjustment step to adjust said focus position to a pattern drawing position are practiced during application of an electron beam. In this case, it is desirable to employ a structure in which, during the application of an electron beam which is carrying out pattern drawing at one pattern drawing position, an operation process such as the above-mentioned calculation of focus position at another pattern drawing position is being practiced to be ready for the succeeding application of the electron beam. Besides, as regards something that can be calculated in a calculation step during application of an electron beam, on top of the above-mentioned optimum focus position and thickness distribution of the base material, a processing such as correction of the thickness distribution can be considered.

Further, it is a matter of course that this invention includes an example based on the combination of one and the other of the above-mentioned examples of the embodiment, and an example based on the combination of any one of them and some modified example.

As explained in the foregoing, according to this invention, an electron beam is advantageous in the precision of working with respect to the direction of application of the beam (the direction of the thickness of an object of working); therefore, even if a base material and a means for applying an electron beam are relatively moved, a high positional precision can be sufficiently secured. For this reason, a solid object having a three-dimensional shape, in particular, a base material having a continuous curved surface can be easily worked.

Hence, it is possible to produce an optical element having a diffractive structure on a spherical or aspherical optical-function surface, and a more three-dimensional working can be easily actualized.

In the following, a suitable example of the embodiment for making it possible to reduce surface reflection will be explained concretely with reference to the drawings.

### The Third Example of the Embodiment

### Base Material

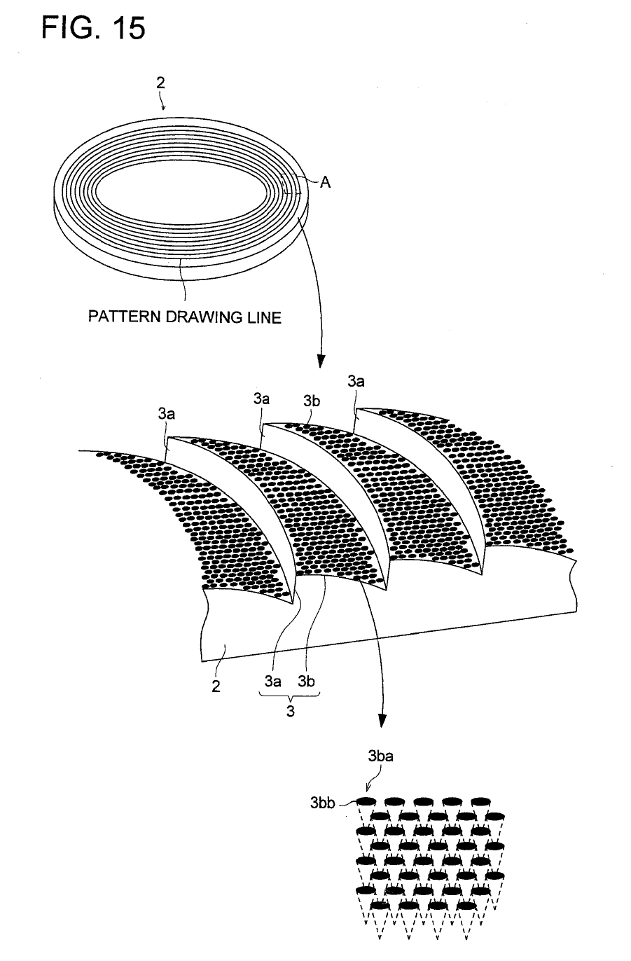

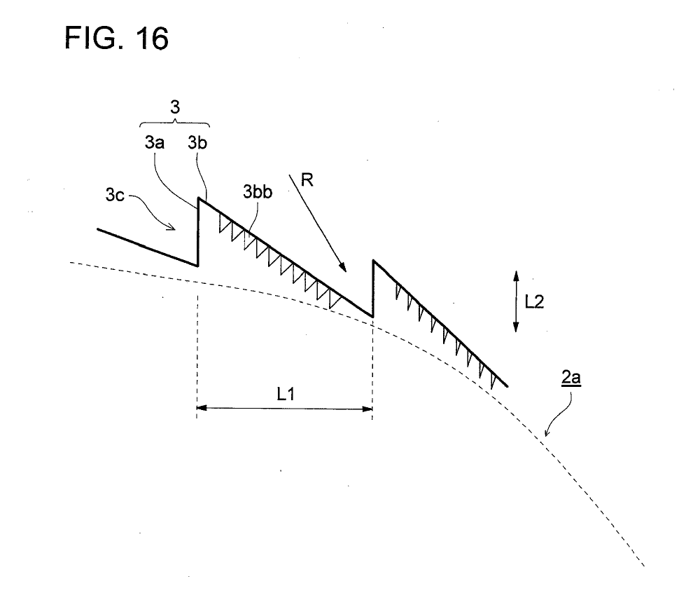

First, a base material as an object of pattern drawing to which pattern drawing is applied by an electron beam will be explained with reference to FIG. 15 and FIG. 16. In FIG. 15, a pattern to be drawn on a base material and the pattern shape of its detailed part are disclosed.

As shown in the drawing, a circular pattern is disclosed as an example of a pattern to be drawn on a base material as an object of pattern drawing 2 (hereinafter referred to simply as a base material) of this example of the embodiment, and as shown in an enlarged view of the part A, which is a part of pattern drawing portion of the base material 2, the base material 2 has a diffractive grating structure formed of a plurality of blazes 3.

The blaze 3 is formed of the slope portion 3b and the side wall portion 3a, and a plurality of said side wall portions 3a are formed cylindrically along the circumferential direction.

To state it in more detail, as shown in FIG. 16, the base material 2 has a curved surface portion 2a formed at least on one surface, has a diffractive grating having a pitch of L1 per each blaze unit formed with a tilt; at least in one blaze unit of this diffractive grating having a length L1, the side wall portion 3a rising upward from said curved surface portion 2a at one end position of said blaze unit, a slope portion 3b formed between neighboring side walls 3a and 3a of said blaze unit, and a groove portion 3c formed in the border space between the side wall portion 3a and the slope portion 3b are included. In addition, it is desirable that this diffraction pattern structure is formed by the pattern drawing applied to a coating layer (a resist) coated on the curved surface portion 2a.

To return the explanation to FIG. 15, in the slope portion 3b, a reflection reducing structure 3ba for reducing the reflection of light incident on said slope portion 3b is formed. It is desirable to make this reflection reducing structure 3ba have a shape consisting of a plurality of minute concave and convex portions causing structural birefringence, and in this example of the embodiment, for example, it is formed of a plurality of minute hole portions 3bb. Each of these minute hole portions 3bb has a shape being tapered towards the depth direction, the diameter of the opening of each of the minute hole portions 3bb is of an order of sub-micron, and the ratio of area of the minute hole portions 3bb to the area of the slope portion 3b is about 30% or so.

Besides, in this example of the embodiment, an example in which a plurality of minute hole portions are provided as a reflection reducing structure is explained, but this invention is not to be limited to this shape; also it is appropriate, for example, a case where a plurality of minute convex portions are formed, or a case where the above-mentioned minute hole portions and minute convex portions are combined together. Further, also it is appropriate a structure in which a circular pattern is drawn by an approximation using a plurality of straight lines.

Further, as regards the base material 2, it is desirable to make up it of an optical element, for example, a pickup lens or the like.

Incidentally, a periodic grating having a sub-wavelength structure influences strongly the transmitting and reflecting characteristics of a light wave, and a reflection reducing effect can be derived from minute concave and convex portions. That is, reflection of light is produced by a sudden variation of the refractive index, but in the reflection reducing structure, because the average refractive index varies gradually towards the depth direction of the base material 2, the refractive index varies continuously and it has a structure to reflect light scarcely.

For this reason, a high-density diffractive grating structure as it is has a large surface reflection; however, on the basis of the collective action of the bundles of rays having a size of a sub-wavelength order, by making the above-mentioned reflection reducing structure 3ba have a continuous refractive index distribution, reflection can be reduced.

In this way, by drawing a cluster structure of an order of sub-wavelength together with a diffractive grating pattern by a three-dimensional pattern drawing method, to form a structure reducing surface reflection on the above-mentioned base material 2, it becomes possible to reduce cost by a large margin in forming a reflection reducing structure as the shape of a metal die.

Further, even if the curvature of the curved surface portion 2a becomes larger with the diffractive grating density being made higher, surface reflection in the area near the periphery is reduced, and also the difference of transmittance depending on the orientation of polarization of light can be reduced. Hence, in the reading process of a detection signal, the lowering of pickup function is not produced.

Further, as regards an optical element having a diffractive grating formed for interchangeability between a DVD and a CD and the correction of the aberration, the lowering of pickup function caused by the increase of the angle of incidence due to the high grating density can be eliminated. The concrete structure of a pattern drawing apparatus using an electron beam and the control for pattern drawing, which are regarded as the basis of forming such a base material, are as described in the foregoing.

(Dose Distribution)

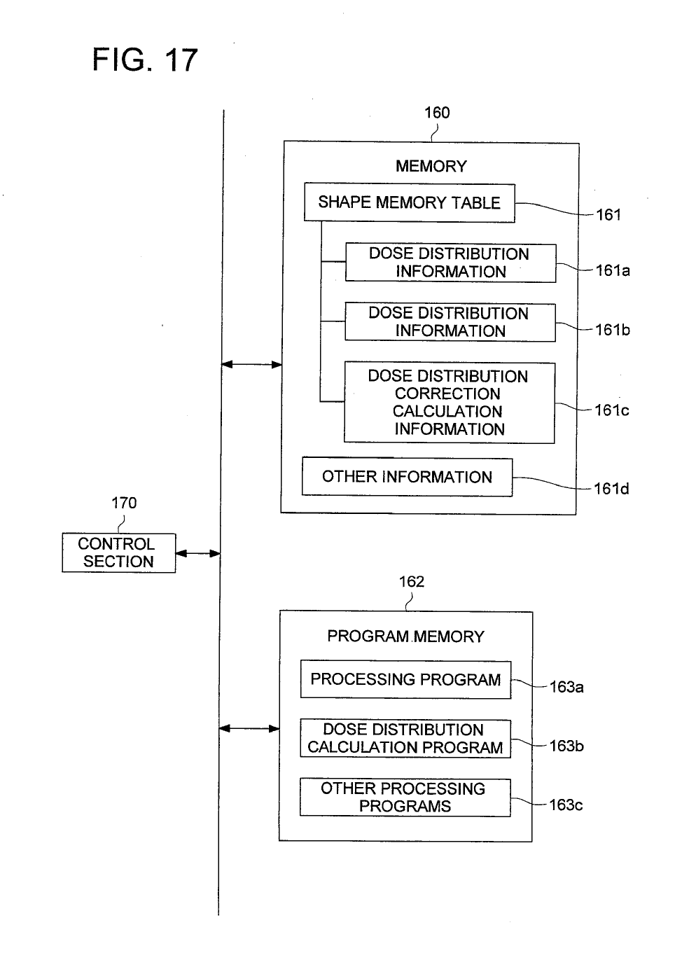

In FIG. 17, it is disclosed the functional block diagram of a pattern drawing apparatus using an electron beam having a structure characteristic of this example of the embodiment.

As shown in the drawing, the memory 160 of the pattern drawing apparatus using an electron beam 1 comprises a pattern memory table 161, and in this pattern memory table 161, dose distribution information 161a concerning the characteristic of the dose distribution etc. which defines beforehand the dose quantity distribution with respect to the scanning position in forming, for example, a diffractive grating one blaze unit after another in a tilted way on the curved surface portion 2a of the base material 2, dose distribution information 161b concerning the dose quantity at the pertinent concave or convex portion in forming concave and convex portions for reducing surface reflection for each of blaze units, dose distribution correcting operation information 161c concerning the correcting operation of a dose distribution, and other information 161d, etc. are memorized. In addition, the above-mentioned dose distribution correcting operation information 161c is a table or operation information to become the basis for calculating a dose distribution etc.

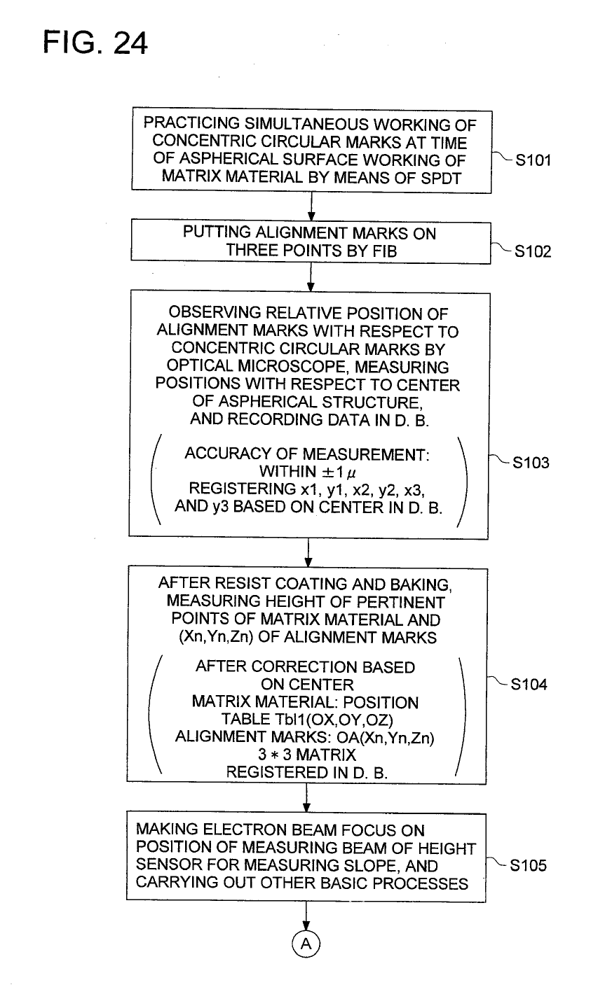

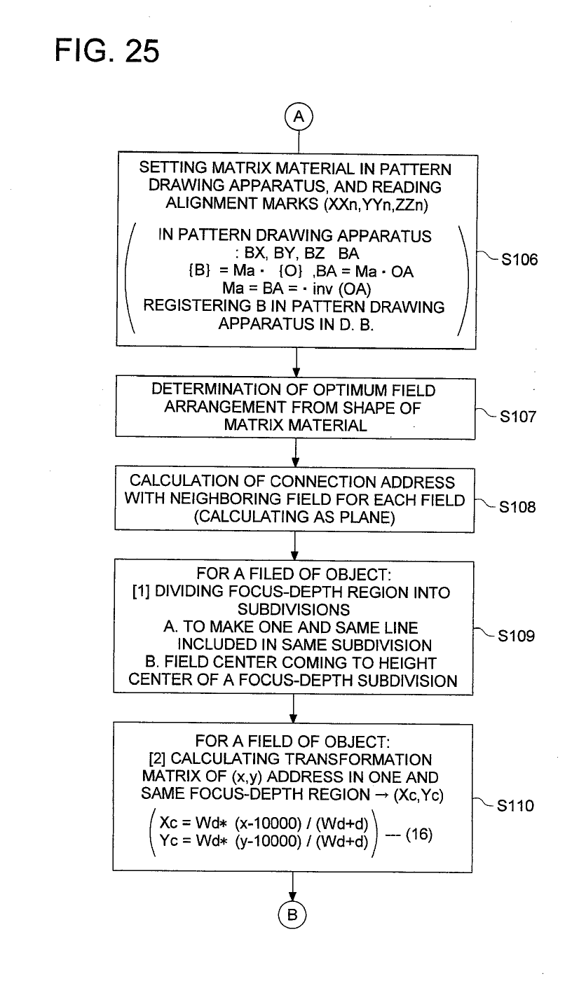

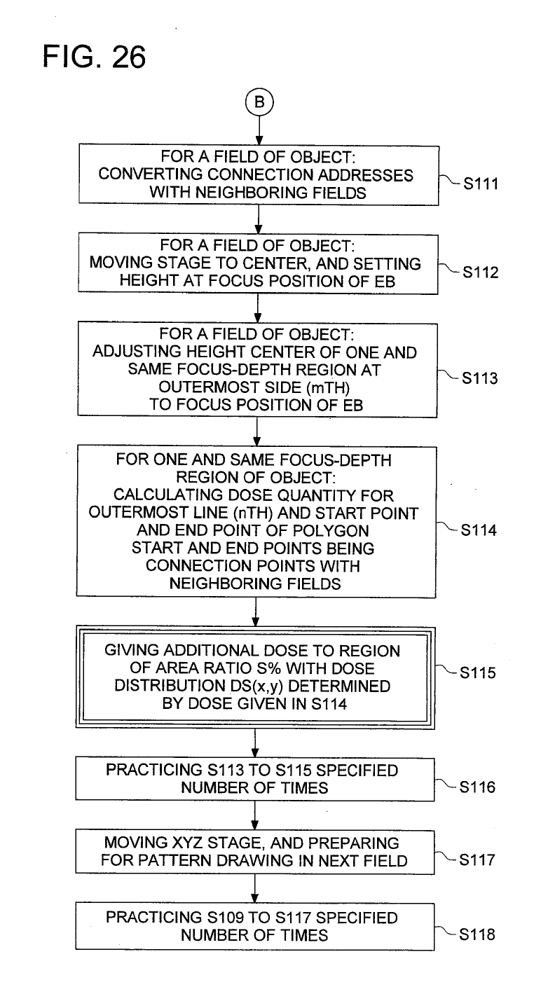

Further, in the program memory 162, a processing program 163a for practicing the processing of these (to state it more in detail, for example, a series of steps of procedure S101 to S118 in FIG. 24 to FIG. 26 to be described later, etc.), a dose distribution operation program 163b for calculating by operation the dose distribution characteristics etc. at a specified tilt angle on the curved surface portion 2a on the basis of the information such as the above-mentioned dose distribution information 161a, 161b, or the dose distribution correcting operation information 161c, another processing program 163c, etc. are memorized. Besides, the “storing means” of this invention can be made up of the memory 160 in this example of the embodiment, and the “control means” of this invention can be made up of the program memory 162 and the control section 170.

The above-mentioned control means carries out such a control as to practice the pattern drawing for the above-mentioned base material and the concave or convex portions as calculating the pertinent dose quantity. In another way, when at least one blaze unit portion of the diffractive grating is formed in a tilted way on the curved surface portion, and concave and/or convex portions for reducing surface reflection are formed for the pertinent one blaze unit portion, it carries out such a control as to practice the pattern drawing for the curved surface portion and the concave and/or convex portions of the above-mentioned base material as calculating the pertinent dose quantity, on the basis of the characteristic of the dose distribution which defines beforehand the dose quantity distribution with respect to the scanning position to which the dose quantity for the pertinent concave and/or convex portion is added.

Further, the control means carries out such a control as to practice the pattern drawing process for the above-mentioned diffractive grating and the pattern drawing process for the above-mentioned concave and/or convex portions approximately at the same time, and such a control as to practice the pattern drawing with the ratio of the area of the hole portions to the area of the slope portion kept at a specified value.

Furthermore, on the basis of the pattern drawing position measured by the measuring means, the control means carries out a control to vary the focus position in accordance with the above-mentioned pattern drawing position by adjusting the electric current value of the electron lens, while it carries out such a control as to practice the pattern drawing, within the depth of focus at the above-mentioned focus position, for the above-mentioned base material and the concave and/or convex portions, as calculating the pertinent dose quantity on the basis of the characteristic of the dose distribution.

Moreover, on the basis of the pattern drawing position measured by the measuring means, the control means carries out a control to vary the focus position of an electron beam applied by the electron beam applying means through moving up and down the carrying table by the drive means in accordance with the above-mentioned pattern drawing position, while it carries out such a control as to practice the pattern drawing, within the depth of focus at the above-mentioned focus position, for the above-mentioned base material and the concave and/or convex portions, as calculating the pertinent dose quantity on the basis of the characteristic of the above-mentioned dose distribution memorized in the above-mentioned storing means.

Furthermore, in this example of the embodiment, a structure in which a dose distribution is calculated for each of tilt angles on the curved surface portion 2a is employed, but also it is appropriate a structure in which a certain number of dose distributions are calculated beforehand to be made a table, and a pertinent dose quantity D is extracted by referring to said table.

In the control system having such a structure as described in the above, dose distribution information is stored beforehand in the pattern memory table 161 of the memory 160 for example, and on the basis of the processing program 163a, a pertinent portion of the dose distribution information is extracted, to practice various kinds of pattern drawing by using the dose distribution information.

In another way, the control unit 170 may practice a control using a method in which a specified pattern drawing algorithm is practiced by using the processing program 163a to come to the routine for calculating a dose quantity, then, the dose distribution operation program 163b is practiced, and after corresponding dose distribution characteristic information is calculated as referring to a table which stores basic information to some extent for calculating dose distributions in accordance with the tilt angle, namely, the two kinds of dose distribution information 161a and 161b, the dose distribution correcting operation information 161c, etc., this calculated dose distribution characteristic information is stored in a specified temporary memory area of the above-mentioned memory 160, and dose quantities are calculated by referring to the dose distribution characteristic information, to carry out the pattern drawing.

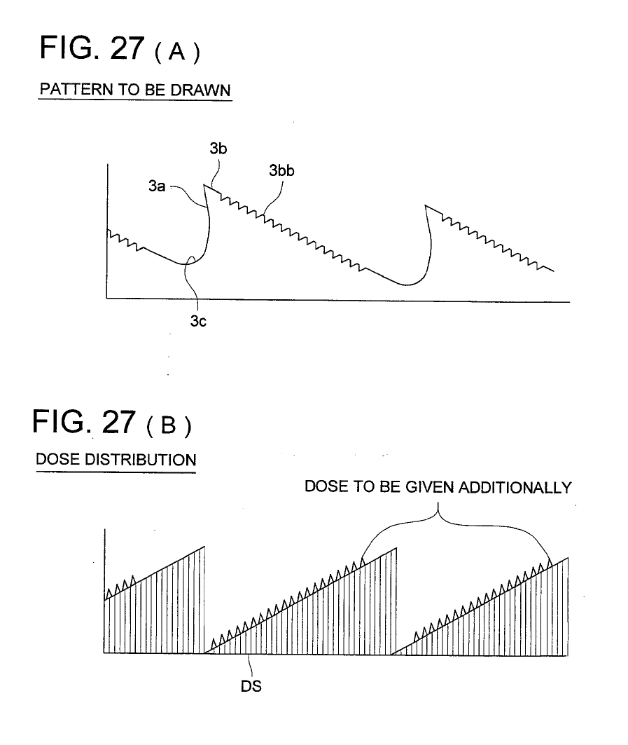

In the following, the concrete shape of a dose distribution characteristic will be explained with reference to FIG. 27. In FIG. 27(A) and in FIG. 27(B), the shape of a pattern to be drawn and the characteristic graph of the dose distribution corresponding to said pattern to be drawn are disclosed respectively. As shown in the drawings, the dose distribution DS in the characteristic graph of the dose distribution is composed of the dose distribution to be given to the slope portions and the side wall portions and the dose to be additionally given for forming the minute hole portions. By doing this way, it is possible to carry out approximately at the same time (through a single scanning) the pattern drawing for forming the slope portions and the side wall portions and the pattern drawing for forming the reflection reducing structure.

(The Concrete Structure of the Control System)

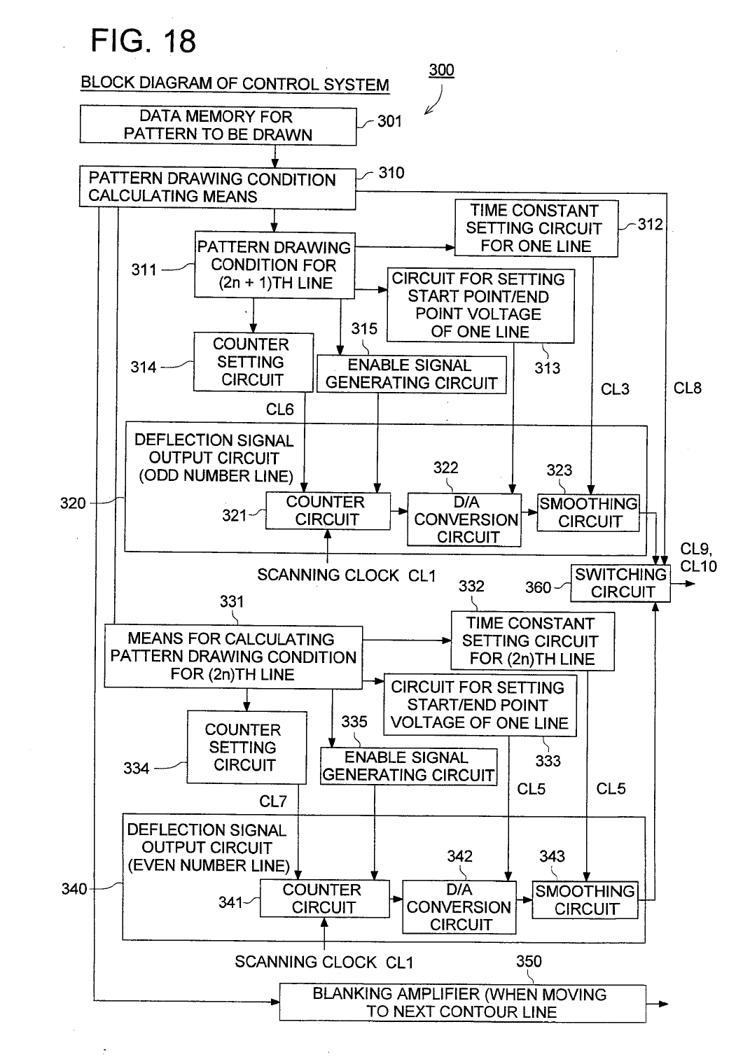

In the following, the concrete structure of the control system for practicing various kinds of processes in the case where the above-mentioned circular pattern is approximated by a regular polygon to be drawn by straight-line scans will be explained with reference to FIG. 18. In FIG. 18, the detailed structure of the control system of a pattern drawing apparatus using an electron beam of this example of the embodiment is disclosed.

As shown in FIG. 18, the control system 300 of the pattern drawing apparatus using an electron beam has a structure comprising a drawing pattern data memory 301 as a drawing pattern memorizing means for memorizing various kinds of data, for example, which are necessary, in drawing a circular pattern, for approximating it by a regular polygon (or an irregular polygon) (corresponding to the radius of circles) (for example, as regards a circle having a radius of k mm, the information corresponding to the circle such as the number of divisions n based on the polygon, the coordinate information of the positions of the sides and the positions of the vertices as well as the multiple value of the clock number, and further, the position in the Z direction), further, various kinds of data which are necessary, in drawing various kinds of curved lines, not to be limited to a circle, for approximating them by sets of straight lines, and the data concerning various kinds of patterns to be drawn (a rectangle, a triangle, a polygon, a vertical line, a horizontal line, an oblique line, a circular plate, a circumference, whole sides of a triangle, an arc, a sector, an ellipse, etc.).

Further, the control system 300 has a structure comprising a pattern drawing condition calculating means 310 for carrying out the calculation of the pattern drawing conditions on the basis of the drawing pattern data memorized in the above-mentioned drawing pattern data memory 301, a (2n+1)th line drawing condition calculating means 311 for carrying out the calculation of the pattern drawing conditions of the (2n+1)th line, the odd-number line, from the above-mentioned pattern drawing condition calculating means 310 (in the case where n=0, 1, 2, - - - , the number is (2n+1), but in the case where n=1, 2, 3, - - - , the number may be also (2n−1)), a time constant setting circuit 312 for setting the time constant of one line on the basis of the (2n+1)th line drawing condition calculating means 311, a start/end point voltage setting circuit 313 for setting the voltage at the start point and end point of one line on the basis of the (2n+1)th line drawing condition calculating means 311, a counter number setting circuit 314 for setting a counter number on the basis of the (2n+1)th line drawing condition calculating means 311, an enable signal generating circuit 315 for generating an enable signal on the basis of the (2n+1)th line drawing condition calculating means 311, and a deflection signal outputting circuit 320 for outputting a deflection signal of an odd-number line.

Further, the control system 300 has a structure comprising a (2n)th line drawing condition calculating means 331 for carrying out the calculation of the pattern drawing conditions of the (2n)th line, the even-number line, from the above-mentioned pattern drawing condition calculating means 310, a time constant setting circuit 332 for setting the time constant of one line on the basis of the (2n) line drawing condition calculating means 331, a start/end point voltage setting circuit 333 for setting the voltage at the start point and end point of one line on the basis of the (2n)th line drawing condition calculating means 331, a counter number setting circuit 334 for setting a counter number on the basis of the (2n)th line drawing condition calculating means 331, an enable signal generating circuit 335 for generating an enable signal on the basis of the (2n)th line drawing condition calculating means 331, a deflection signal outputting circuit 340 for outputting a deflection signal of the even-number line, a blanking amplifier 350 for carrying out blanking at a timing when pattern drawing moves to the next contour line on the basis of the (2n)th line drawing condition calculating means 331, and a switching circuit 360 for switching the processing steps between an odd-number line and an even-number line on the basis of the pattern drawing conditions in the pattern drawing condition calculating means 310 and the information from the deflection signal outputting circuit 320 of an odd-number line and from the deflection signal outputting circuit 340 of an even-number line.

The deflection signal outputting circuit 320 of an odd-number line has a structure comprising a counter circuit 321 as a number counting means for practicing count processing on the basis of a scanning clock CL1, an odd-number line count signal CL6 from the counter number setting circuit 314, and an enable signal from the enable signal generating circuit 315, a D/A conversion circuit 322 for carrying out D/A conversion on the basis of a count timing signal and an odd-number line drawing condition signal CL3 in the start/end point voltage setting circuit 313, and a smoothing circuit 323 for carrying out processing to smooth an analogue signal converted in the D/A conversion circuit 322 (processing such as eliminating higher frequency components of a deflection signal).

The deflection signal outputting circuit 340 for an even-number line has a structure comprising a counter circuit 341 as a number counting means for practicing a counting process on the basis of a scanning clock CL1, an even-number line count signal CL7 from the counter number setting circuit 334, and an enable signal from the enable signal generating circuit 335, a D/A conversion circuit 342 for carrying out D/A conversion on the basis of a count timing signal and an even-number line drawing condition signal CL5 in the start/end point voltage setting circuit 333, and a smoothing circuit 343 for carrying out processing to smooth an analogue signal converted in the D/A conversion circuit 342.

Besides, it is employed such a structure that every part composing the control system 300 can be controlled by the control section 170 (control means) such as the CPU shown in FIG. 1. Further, also it is possible that this control system makes up each of the control system for X-deflection and the control system for Y-deflection.

Furthermore, “an operation means” can be made up of this control system 300 in this example of the embodiment comprising the drawing pattern data memory 301 and the pattern drawing condition calculating means 310. This “operation means” has a function to calculate the respective positions of at least two points equivalent to the distance corresponding to the time of an integral multiple of the minimum time of resolving power of the D/A converter on a scan line to be scanned. In this case, the “control means” in the control section 170 practice such a control as to make an approximately straight-line scanning by the above-mentioned electron beam between the two positions calculated by the above-mentioned operation means. Further, in the same way, “an operation means” in another example of the embodiment of this invention, has a function to calculate the vertex positions of a polygon with a side length of a distance corresponding to an integral multiple of the minimum time of the resolving power of the D/A converter on a scan line to be scanned approximately circularly. Moreover, in the same way, the control means carries out a control to make an approximately straight-line scanning by the above-mentioned electron beam between the positions calculated by the operation means.

The control system 300 having a structure as mentioned in the above functions generally in the following way. That is, when the pattern drawing condition calculating means 310 obtains the information which is necessary for a scanning (pattern drawing) approximated by a straight line from the drawing pattern data memory 301, it practices calculation processing of the specified pattern drawing conditions, for example, in the case where a circular pattern is approximated by the sides of a regular polygon, the information concerning the first side among the above-mentioned sides of a polygon, that is, the odd-number line, is transmitted to the (2n+1)th line drawing condition calculating means 311, and the information concerning the next side, that is, the even-number line, is transmitted to the (2n)th line drawing condition calculating means 331.

Through this, for example, the (2n+1)th line drawing condition calculating means 311 generates the pattern drawing conditions concerning odd-number lines, and on the basis of the scanning clock CL1 and a generated odd-number line drawing condition generation signal CL2, it outputs an odd-number line deflection signal CL9 from the deflection signal outputting circuit 320.

On the other hand, for example, the (2n)th line drawing condition calculating means 331 generates the pattern drawing conditions concerning even-number lines, and on the basis of the scanning clock CL1 and a generated even-number line drawing condition generation signal CL4, it outputs an even-number line deflection signal CL10 from the deflection signal outputting circuit 340.

As regards these odd-number line deflection signal CL9 and even-number line deflection signal CL10 their outputs are switched alternately by the switching circuit 360 under the pattern drawing condition calculating means 310. Hence, as regards a certain circle, when each of the sides of a polygon approximating the circle is calculated, the sides of the polygon are alternately drawn (scanned) as straight lines in such a way that when one of the sides, an odd-number side, is drawn, the next side, an even-number side, is drawn, and then, the next side, an odd-number side, is drawn.

Then, when the pattern drawing for a certain circle is finished, the pattern drawing condition calculating means 310 transmits a message to that effect to the blanking amplifier 350, and carries out processing to urge the pattern drawing of another circle. In this way, pattern drawing for every circle is carried out with its shape approximated by a polygon.

(The Characteristics of this Example of the Embodiment)

In the following, the ground of it that surface reflection can be reduced by making up the reflection reducing structure, that is, the relationship between each of the positions on the curved surface portion and the surface reflectance will be explained.

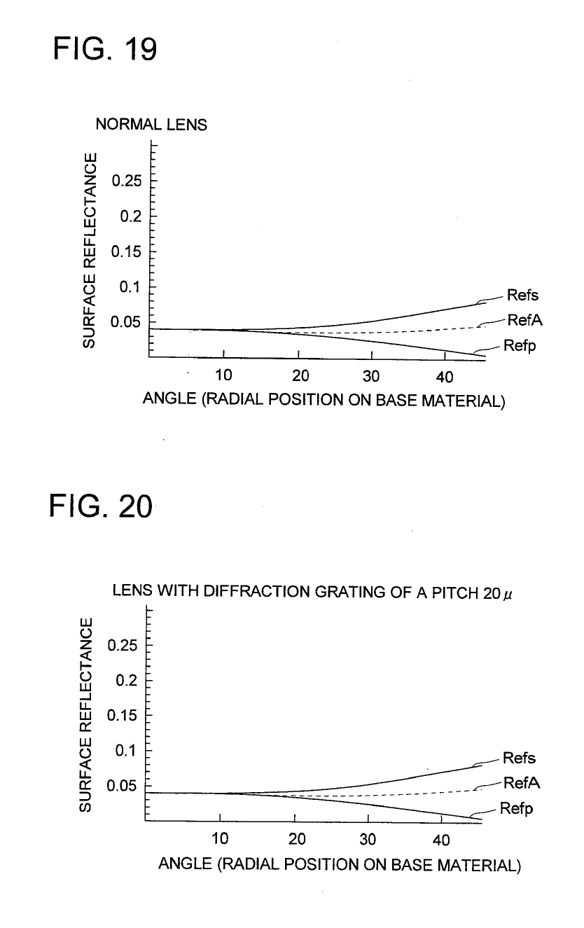

In FIG. 19 to FIG. 22, the ways surface reflectance varies with the position moving from the central position of the curved surface portion of a base material towards the circumference are disclosed respectively for each of the cases of a normal lens (FIG. 19), a lens with a diffractive grating (having a pitch of 20 μm) (FIG. 20), a lens with a diffractive grating (having a pitch of 3 μm) (FIG. 21), and a lens with a diffractive grating (having a pitch of 3 μm) provided with a reflection reducing structure (FIG. 22).

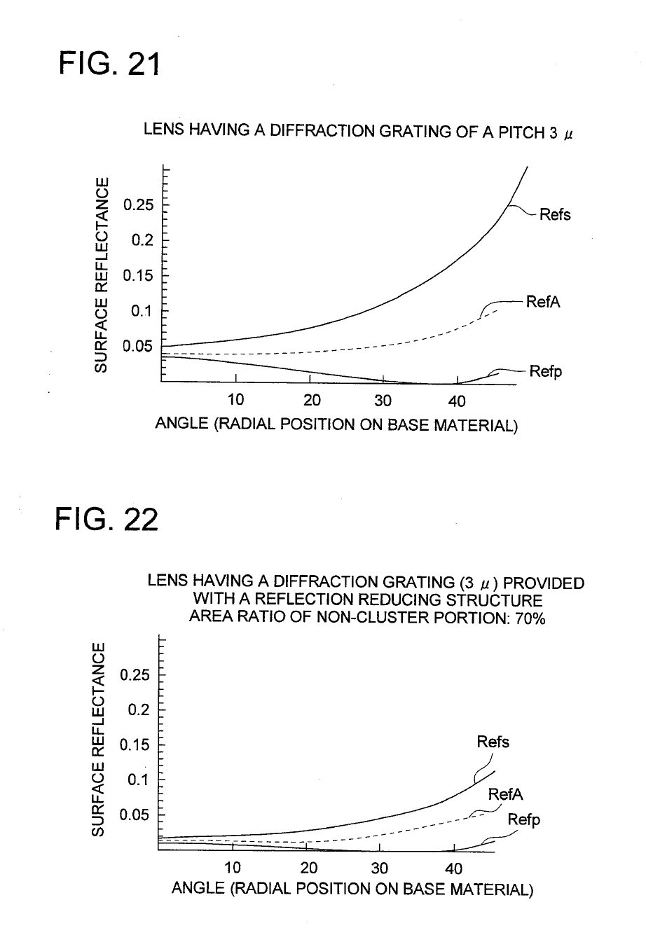

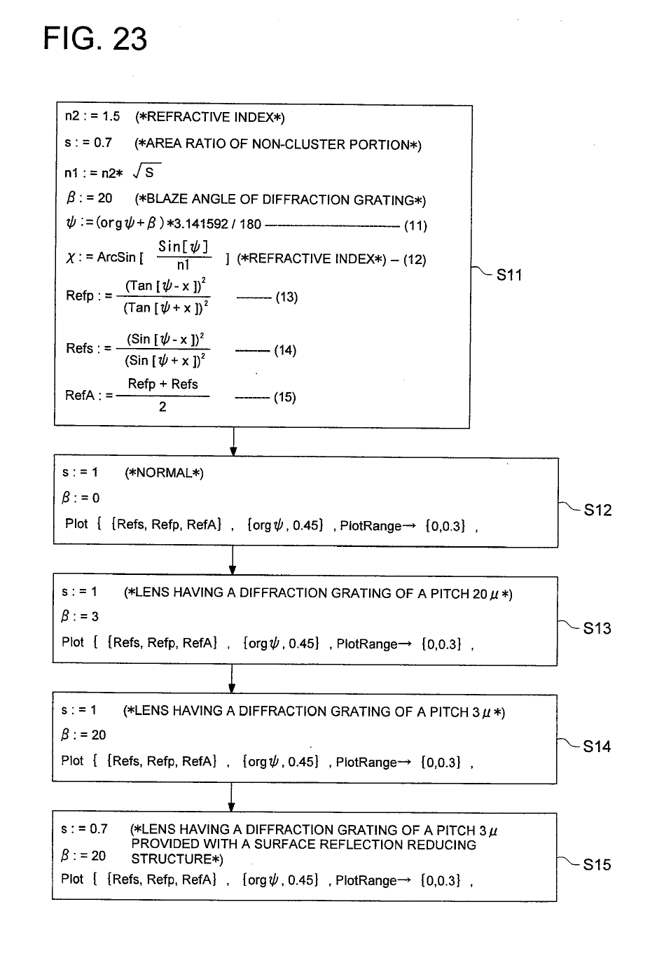

Besides, in calculating each of these characteristics, setting of the various kinds of conditions shown in FIG. 23 is carried out. That is, with the refractive index assumed as 1.5, the proportion of the area of the non-cluster portion (the ratio of the slope portion to the hole portion) denoted by S, the blaze angle of the diffractive grating denoted by β, and the angle of the position (the radial position on the curved surface of a base material) denoted by ψ, Refp, Refs, and RefA are calculated from the equations (13) to (15) shown in the drawing (step, hereinafter referred to as “S”, 11). In the above, the angles of refraction χ and ψ are calculated by the equations (12) and (11) respectively.

Next, on the above-mentioned premise, for a normal lens, in the case where S=1, β=0, and ψ is 0 to 45, Refp, Refs, and RefA are calculated (S12), and the result is shown in the graph of FIG. 19.

In the same way, for a lens with a diffractive grating (having a pitch of 20 μm), in the case where S=1, β=3, and ψ is 0 to 45, Refp, Refs, and RefA are calculated (S13), and the result is shown in the graph of FIG. 20.

Further, for a lens with a diffractive grating (having a pitch of 3 μm), in the case where S=1, β=20, and ψ is 0 to 45, Refp, Refs, and RefA are calculated (S14), and the result is shown in the graph of FIG. 21.

Further, for a lens with a diffractive grating (having a pitch of 3 μm) provided with a reflection reducing structure, in the case where S=0.7, β=20, and ψ is 0 to 45, Refp, Refs, and RefA are calculated (S15), and the result is shown in the graph of FIG. 22.

As shown in these graphs, in the case of a normal lens and in the case where the blaze surface is not so much tilted and the width of one blaze unit (equivalent to one pitch) is comparatively larger, the variation of the surface reflectance is minute; however, as shown in FIG. 153, in the case where the blaze surface is tilted (assuming the case of FIG. 16), and the width of one blaze unit is comparatively smaller, the surface reflectance rises sharply with the position coming nearer to the circumference. Further, the difference of transmittance depending on the orientation of polarization of light becomes remarkable.

On the other hand, in the case where a reflection reducing structure is provided as in this example of the embodiment, as shown in FIG. 22, even if the blaze surface is tilted and the width of one blaze unit is comparatively smaller, it never occurs that the surface reflectance rises sharply with the position coming nearer to the circumference. In addition, it is assumed that the area ratio of the hole portions is about 30%.

According to this, it can be understood that a high-density diffractive grating structure as it is exhibits a large surface reflection, but on the basis of the collective action of bundles of light rays each having a size of an order of sub-wavelength, by making the above-mentioned reflection reducing structure have a continuous refractive index distribution, surface reflection can be reduced even in the case of a diffractive grating structure.

For this reflection reducing structure, various kinds of structures can be considered; in particular, such one that has a plurality of minute holes being tapered towards the depth direction formed, and has the area ratio of the hole portions made to be about 30% of the slope portion exhibits a remarkable effect of reducing surface reflectance as shown in FIG. 22.

(The Steps of the Procedure of Processing)

In the following, the steps of the procedure of processing of producing a base material having a structure as described in the above by means of a pattern drawing apparatus using an electron beam capable of drawing a pattern three-dimensionally will be explained with reference to FIG. 24 to FIG. 26.

First, in carrying out working of an aspherical surface of a matrix material (base material) by using SPDT (Single Point Diamond Turning: diamond cutting by a super high-precision machine tool), simultaneous working of a concentric circular marks is practiced (S101). At this time, it is desirable that a pattern having a precision, for example, within ±1 μm to be detected by an optical microscope is formed.

Next, by means of an FIB, alignment marks are put, for example, on three points (S102). In addition, it is desirable that the cross-shaped alignment mark has a detection precision within ±20 nm in the pattern drawing apparatus using an electron beam.

Further, the relative positions of the above-mentioned alignment marks to the concentric marks is observed by an optical microscope, and the positions with respect to the center of the aspherical structure are measured and recorded in a data base (DB) (or a memory (the same way hereinafter)). Besides, it is desirable that the precision of this measurement is within ±1 μm, and the positions of the three alignment marks based on the center taken for the reference (x1, y1), (x2, y2), and (x3, y3) are registered in the data base (DB).

Further, the height of the pertinent points and the positions of the alignment marks of the basic configuration (base material) after resist coating/baking are measured (S104). Then, the basic configuration (base material) corrected for the center reference: the position table Tb11 (OX, OY, OZ), and the alignment marks: OA(Xn, Yn, Zn) (both are 3×3 matrices) are registered in the data base (DE).

Next, various kinds of preparation processes such as focusing of the electron beam on the position of the measuring beam of the measurement apparatus for measuring a slope (a height detector) are carried out (S105).

At this time, the measuring beam for height detection is projected on a needle-shaped calibrator for the focusing of the electron beam (EB) attached on the stage, while it is observed by the pattern drawing apparatus using an electron beam in the SEM mode; thus the focus is adjusted.

Subsequently, the basic configuration (base material) is set inside the pattern drawing apparatus using an electron beam, and the alignment marks are read (XXn, YYn, ZZn) (S106). At this time, in the pattern drawing apparatus using an electron beam, the values shown in the step S106 are registered in the data base (DE).

Further, the optimum field position is determined from the shape of the matrix material (base material) (S107). In the above step, as regards the fields formed by dividing the concentric circles into sectors, neighboring fields are made to overlap each other a little, and the first circular zone located at the center is not divided into fields.

Then, for each of the fields, the calculation of the connection address with the adjacent field is carried out (S108). This calculation is practiced for the surface regarded as a plane. Incidentally, one side of a polygon is to be included in one and the same field. In the above, “a polygon”, as explained in the item of the above-mentioned control system, means at least one line to be drawn in the case where a circular pattern is approximated by a specified n-polygon.

Next, in a field taken as the object, as regards the subdivision of a focus-depth region, one and the same line is made to be included in the same subdivision. Further, the center of a field becomes the height center of a focus-depth subdivision (S109). In addition, a position within a height range of 50 μm is made to fall in the same focus-depth range.

Subsequently, for the field taken as the object, a conversion matrix (Xc, Yc) of an (x, y) address in the same focus-depth region is calculated (S110). These Xc and Yc are as expressed by the equation (16) shown in the drawing.

Further, for the field taken as the object, the connection address with the adjacent field is converted (S111). In this case, the connection position coordinates calculated in the step S108 are converted by using the equation (16).

Then, with respect to the field taken as the object, the XYZ stage is moved to the center, and the height is set at the focus position of the electron beam (EB) (S112). That is, the focus position is set at the center of the field by the XYZ stage. Moreover, while a signal from the measurement apparatus (height detector) is being detected, the XYZ stage is moved, to read the height position.

Further, in the field taken as the object, the height center of the outermost (mth) area of the same focus-depth zone is adjusted to the focus position of the electron beam (EB) (S113). To state it concretely, by referring to the table B, the XYZ stage is moved by an amount of the difference between the height position of the field center and the focus position.

Next, within the same focus-depth range taken as the object, the calculation of the dose quantity for the outermost (nth) line and the start point and end point of the polygon is carried out. In addition, the start point and the end point are made to be the connection points with the adjacent fields (S114). At this time, it is determined to make the number of pairs of the start points and end points an integer, and the dose quantity is expressed by the product of the maximum dose quantity determined by the radial position (angle of incidence) and a coefficient determined by the position of the grating and said maximum dose quantity.

Subsequently, according to the dose distribution DS (x, y) determined by the dose quantity given in the step S114, additional dose is given to the area having the area ratio S % (S115). At this time, the spreading of this additional dose including the adjacency effect is to be included in the tilted surface of the blaze (slope portion) (S115). Further, it is desirable to make the dose distribution broad for the shallow portion (apex portion) of the tilted surface (slope portion) and sharp for the deep portion (groove portion); that is, for example, a dose distribution as shown in FIG. 27(B) is desirable.

Thus, by giving the above-mentioned dose distribution, the pattern drawing for the diffractive grating structure and the pattern drawing for the reflection reducing structure can be carried out approximately at the same time (together by a single scanning). Then, the above-mentioned steps S113 to S115 are practiced a specified number of times (S116).

Next, the movement of the XYZ stage and the preparation for practicing the pattern drawing in the next field are carried out (S117). At this time, the field number, time, temperature, etc. are registered in the data base (DB).

In this way, by practicing the above-mentioned steps S116 and S117 a specified number of times (S118), it can be carried out the formation of a reflection reducing structure (a cluster) on a base material having a diffractive grating structure on its curved surface portion by an electron beam.

As described in the foregoing, according to this example of the embodiment, although a high-density diffractive structure as it is exhibits a large surface reflection, on the basis of the collective action of bundles of light rays each having a size of an order of sub-wavelength, by forming a hole portions having a continuous refractive index distribution as the above-mentioned reflection reducing structure on a base material having a diffractive grating structure on its curved surface portion, reflection can be reduced.

Further, even if the curvature of the curved surface portion becomes larger with the density of the diffractive grating being made higher, surface reflection in the area near the periphery is reduced and also the difference of transmittance depending on the orientation of polarization of light can be reduced. Hence, it never occurs the lowering of pickup function in the reading processing of a detection signal.

Further, as regards an optical element provided with a diffractive grating for the purpose of the interchangeability between a DVD and a CD, and the correction of aberration, the lowering of pickup function caused by the increase of angle of incidence owing to the grating density being made higher can be eliminated.

Besides, for the above-mentioned reflection reducing structure, various kinds of structures can be considered as mentioned in the above, and in particular, such one that has a plurality of minute holes being tapered towards the depth direction formed, and has the area ratio of the hole portions made to be about 30% of the slope portion exhibits a remarkable effect of reducing surface reflectance.

### The Fourth Example of the Embodiment

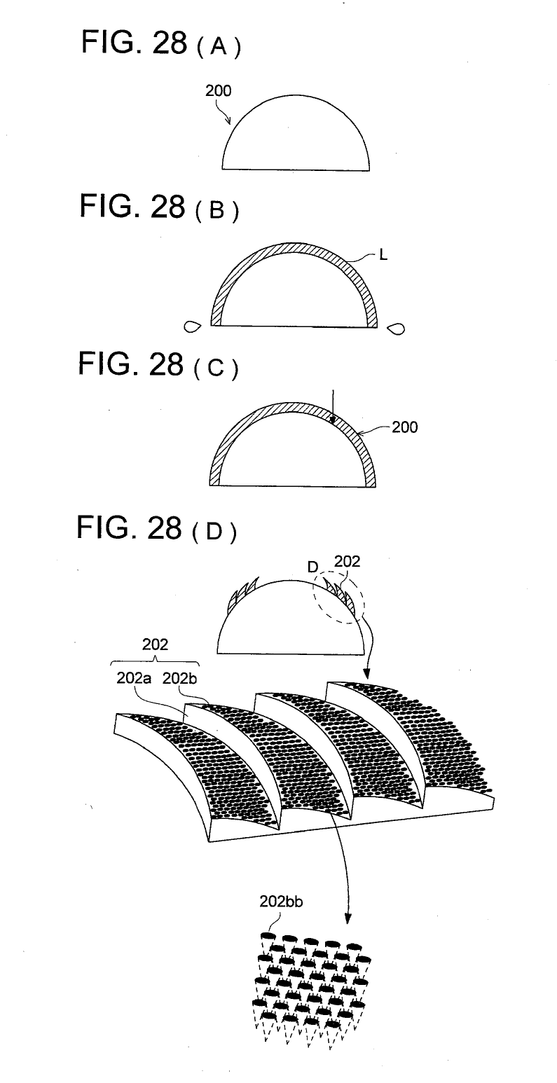

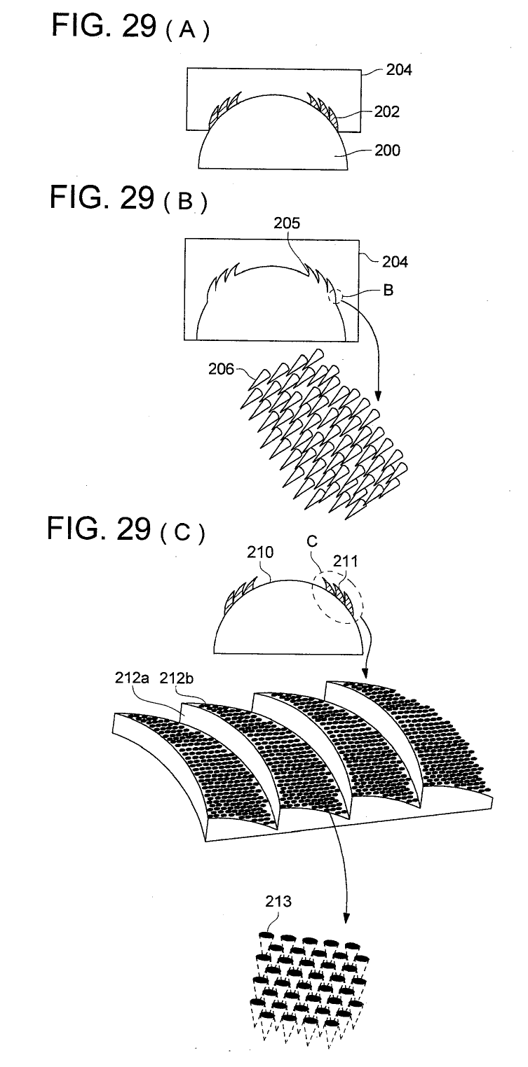

In the following, the fourth example of the embodiment of this invention will be explained with reference to FIG. 28 and FIG. 29. In addition, in the following, the explanation of a structure which is substantially the same as that in the above-mentioned third example of the embodiment will be omitted, and only the different part will be described.

In the above-mentioned third example of the embodiment, it is disclosed a process in which high-precision working of, for example, a diffractive grating including a reflection reducing structure is applied to a base material by means of an electron beam, but in this example of the embodiment, the steps of the procedure of the overall process including the above-mentioned process, in particular, of a process in which a metal die etc. for manufacturing an optical element such as an optical lens by injection molding is produced will be explained.

First, aspherical working of a metal die (made of non-electrolytic nickel, etc.) by machining is carried out (working process). Next, as shown in FIG. 28(A), resin molding of a base material 200 having the above-mentioned hemispherical surface is carried out by using the metal die (resin molding process). Further, the base material 200 is washed and dried.

Subsequently, a surface treatment of the base material 200 is carried out (resin surface treatment process). In this process, for example, a process such as evaporation coating of gold (Au) is to be done. To state it concretely, as shown in FIG. 28(B), the position adjustment of the base material 200 is made, and a spinner is rotated while resist L is being dropped, to carry out spin coating. Moreover, also pre-baking is carried out.

After spin coating, the thickness of said resist film is measured, and the evaluation of the resist film is made (resist film evaluation process). Then, as shown in FIG. 28(C), the position adjustment of the base material 200 is carried out, and as said base material 200 is being controlled with respect to the X-axis, Y-axis, and Z-axis, pattern drawing for the curved surface portion comprising a diffractive grating structure Including a reflection reducing structure 202bb is carried out by a three-dimensional electron beam (pattern drawing process).

Next, a surface smoothing treatment for the resist film L on the base material 200 is carried out (surface smoothing process). Further, as shown in FIG. 28(D), while the position adjustment of the base material 200 is being made, development processing is carried out (development process). Furthermore, a surface hardening treatment is carried out.

Subsequently, by SEM observation, film thickness measurement, etc., a process for evaluating the shape of the resist is carried out (resist shape evaluation process).

Further, after that, evaporation coating of a metal 202 on the resist surface of the base material 200 is carried out (metal evaporation coating process). Then, etching is carried out by a dry etching method or the like.

Now, as shown in an enlarged view of the part D of the metal 202 of the diffractive grating structure, a diffractive grating structure is formed of a plurality of blazes composed of slope portions 202b and side wall portions 202a respectively, and in each of the slope portions 202b, a reflection reducing structure composed of a plurality of hole portions 202bb being tapered towards the depth direction are formed. These plural hole portions 202bb occupies about 30% of the area of the slope portion 202b (or desirably, a proportion within the range of 20% to 40%). As regards this blaze, because the angle of the diffractive grating surface becomes steeper with its position coming closer to the periphery, it is desirable that also the angle of the taper of the hole portion is varied in accordance with the angle variation of the diffractive grating surface.

Next, in order to produce a metal die 204 for the base material 200 to which a surface treatment has been applied, as shown in FIG. 29(A), after a pre-treatment for electroforming processing of the metal die is carried out, an electroforming process etc. are practiced, and as shown in FIG. 29(B), a processing to separate the metal die 204 from the base material 200 is carried out.

To the metal die 204 which has been separated from the base material having been subjected to a surface treatment, a surface treatment is carried out (die surface treatment process). Then, the evaluation of the metal die 204 is performed.

Now, in the metal die 204, concave portions 205 are formed in such a way as to correspond to the blazes of the above-mentioned base material 200, and as shown in an enlarged view of the part B, in each of these concave portions 205, a plurality of minute convex portions 206 are formed in such a way as to correspond to the shape of the hole portions in the slope portion 202b of the above-mentioned base material 200.

In this way, after evaluation, by using the above-mentioned metal die 204, as shown in FIG. 29, mold products are produced by injection molding. After that, the evaluation of said mold products is performed.

Now, as shown in FIG. 29(C), in an injection molding product 210, a similar structure to the base material in the above-mentioned third example of the embodiment is completed, and a diffractive grating structure 211 composed of a plurality of blazes is formed on the curved surface portion. Further, as shown in an enlarged view of the part C, one unit having a width of the pitch of the diffractive grating makes up a blaze consisting of a side wall portion 212a and a slope portion 212b, and in this slope portion 212b, a reflection reducing structure composed of a plurality of minute hole portions 213 having a diameter of an order of sub-micron is formed.

In this way, according to this example of the embodiment, in the case where an optical element (for example, a lens) as a base material in the above-mentioned third example of the embodiment is produced, when the pattern of a diffractive grating is drawn by means of a three-dimensional pattern drawing apparatus, also the pattern of a cluster structure whose each component has a size of an order of sub-wavelength is drawn together, to form a reflection reducing structure as the shape of a metal die, and said optical element can be manufactured by an injection molding process using the metal die; therefore, it is possible to make the cost necessary for manufacturing reduced. Further, by adding a structure having a reflection reducing function to the metal die, the function can be added to lenses at the same time in injection molding, which makes it unnecessary to carry out an additional process. For this reason, although the manufacturing cost of the metal die itself is increased and the possible number of shots (about one million times) is decreased, it is possible to make the manufacturing cost and operation time reduced by a large margin as compared to the case where an evaporation coating process is applied to each of lenses.

Further, because a microscopic structure for reflection reducing can be built in a plastic lens simultaneously in the process of injection molding of it, evaporation coating process of a dielectric material becomes unnecessary, which causes the cost of optical parts to be reduced.

In particular, this method can be also applied to a lens having no diffractive grating structure produced by injection molding, and by eliminating a step such as evaporation coating, it is possible to achieve cost reduction by a large margin.

### The Fifth Example of the Embodiment

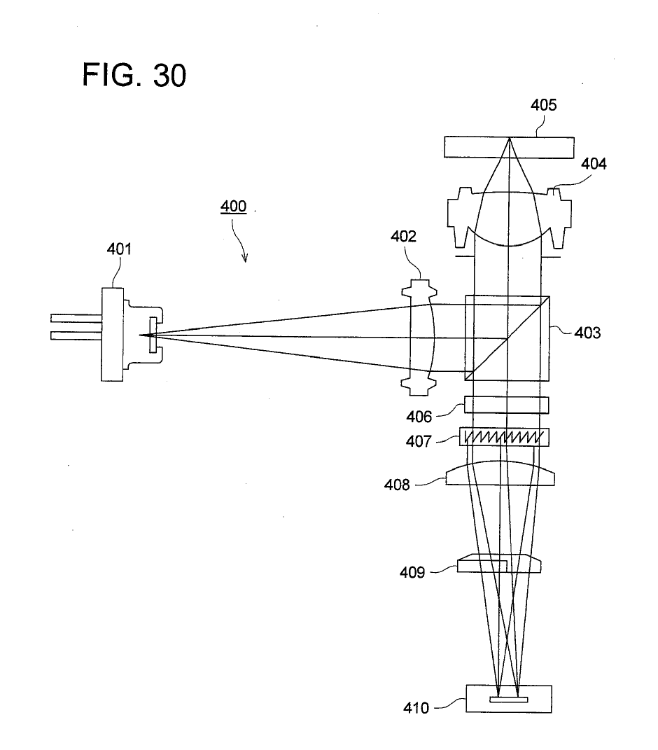

In the following, the fifth example of the embodiment of this invention will be explained with reference to FIG. 30. FIG. 30, is a functional block diagram showing the fifth example of the embodiment of this invention.

In this example of the embodiment, it is disclosed an example of an optical pickup device as an example of electronic equipment using a base material as the object of pattern drawing (a base material) on which a pattern has been drawn by means of the above-mentioned pattern drawing apparatus using an electron beam (or an optical element which is a product formed of resin by injection molding).

In FIG. 30, an optical pickup device 400 comprises a semiconductor laser 401, a collimator lens 402, a splitting prism 403, an objective lens 404, a magneto-optical disk 405 such as a DVD or a CD (an magneto-optical recording medium), a half-wave plate 406, a polarized light splitting element 407, a convergent lens 408, a cylindrical lens 409, and a split light detector 410.

In this example of the embodiment, it is desirable that as regards the above-mentioned optical parts, for example, any one or all of the collimator lens 402, the objective lens 404, the converging lens 408, the cylindrical lens 409 (irrespective of the presence or absence of a diffractive grating structure and the presence or absence of a curved surface portion) employ an optical element including a reflection reducing structure of any one of the above-mentioned examples of the embodiment.

In the optical pickup device 400 having a structure as described in the above, a laser beam from the semiconductor laser 401 is made a parallel beam by the collimator lens 402, is reflected by the splitting prism 403 towards the objective lens 404, is converged by the objective lens 404 to the diffraction limit, and is applied to the magneto-optical disk 405 (magneto-optical recording medium).

The reflected laser beam from the magneto-optical disk 405 enters the objective lens 404, is again made a parallel beam, is transmitted through the splitting prism 403, is further transmitted through the half-wave plate 406 to rotate its polarization orientation by 45 degrees, and then, enters the polarized light splitting element 407, by which it is split into two bundles of rays which are composed of P polarized light and S polarized light and have optical paths close to each other respectively. The above-mentioned two bundles of rays composed of P polarized light and S polarized light respectively are converged by the convergent lens 408 and the cylindrical lens 409, to form their respective spots in the split light receiving areas (light receiving elements) of the split light detector 410.

As described in the foregoing, in this example of the embodiment, in addition to the reduction of surface reflection near the periphery of a lens, the difference of transmittance depending on the orientation of polarization can be reduced, and it never happens that the pickup function is lowered in the reading process of a detection signal. Besides, it is considered that an optical element, which has been given a diffractive grating for the purpose of interchangeability between a DVD and a CD and correction of aberration, has a high grating density, the degree of increase of angle of incidence becomes higher, and its influence on lowering of the pickup function based on surface reflection becomes larger; however even in such a case, a situation such that the pickup function is lowered can be avoided.

In addition, the apparatus and the method of this invention has been explained on the basis of some particular examples of the embodiment, but a person skilled in the art can make various kinds of modifications for the embodiment described in the specification of this invention without departing from the spirit and scope of this invention.

Further, an example in which the area ratio of the plural hole portions formed on the slope portion is made about 30% has been shown, but this invention should not be limited to this, and also it is appropriate of course that the ratio is 20%, 40%, 50%, 60%, etc. Moreover, also it is appropriate to make the ratio vary in accordance with the slope portion of each of the blaze units.

Further, as regards the reflection reducing structure, a structure having hole portions each of which is tapered towards the depth direction has been shown, but this invention should not be limited to this; it is essential that concave or convex portions enabling birefringence are formed, and also it is appropriate, for example, to form convex portions, or to form a combination of hole portions and convex portions. Moreover, also it is appropriate to make the structure have hole portions in one blaze unit and convex portions in another blaze unit.

As a matter of course, it is necessary that also the shape of the metal die is changed in accordance with the shape of the above-mentioned base material or optical element in such a way as to correspond to it.

Further, in the above-mentioned examples of the embodiment, as regards the pattern drawing of the diffractive grating structure composed of the slope portion and the side wall portion and the pattern drawing of the reflection reducing structure, the steps of procedure in which both of them are carried out in a single scan have been explained; however, this invention should not be limited to this procedure, and in the case where a reflection reducing structure is composed of hole portions etc., also it is appropriate that the pattern drawing of the diffractive grating structure is carried out at first, and then, the pattern drawing of the reflection reducing structure is carried out.

Further, for a base material comprising at least a curved surface portion, in the case where at least a part having a width of the pitch is formed in a tilted manner (or in the case where groove portions are formed with a fine pitch), also a structure having at least a groove portion on the base material may be employed. Further, as regards the base material, also one having at least a tilted surface formed may be appropriate, even if it has no curved surface portion. Moreover, this invention may be applied to the case where the base material has a flat surface or a tilted surface and an electron beam is applied at a specified incident angle in a tilted state.

Further, as regards the reflection reducing structure, the case where a light beam is incident on the curved surface has been explained; however, the case where a light beam outgoes or the combination of them, that is, the case where a light beam is incident and another light beam outgoes at the same time may be also possible.

As explained up to now, according to the above-mentioned embodiment, by forming concave and/or convex portions for obtaining a continuous refractive index distribution as a reflection reducing structure on a base material having a diffractive grating structure on the curved surface portion, reflection can be reduced. Moreover, this can be applied also to a base material having no diffractive grating structure.

Further, even though the curvature of the curved surface portion becomes larger with the grating density being made higher, surface reflection at a portion near the periphery is reduced and the difference in transmittance depending on the orientation of polarization can be reduced. Hence, the lowering of the pickup function is not produced in the reading process of a detection signal. Moreover, as regards an optical element provided with a diffractive grating, the lowering of the pickup function caused by the increase of angle of incidence owing to the grating density being made higher can be eliminated.

In addition, as regards the above-mentioned reflection reducing structure, various kinds of structures can be considered; in particular, such one that has plural hole portions being tapered towards the depth direction formed has a remarkable effect for reducing surface reflection.

Further, because a base material can be manufactured by injection molding using a metal die, it is possible to achieve the reduction of the cost necessary for manufacturing. In injection molding of this base material, the addition of a reflection reducing function can be made simultaneously; therefore, an additional process is unnecessary. For this reason, the reduction of manufacturing cost by a large margin and the reduction of operation time can be achieved as compared to the case where an evaporation coating process is applied to each of lenses, which causes the cost of optical parts to be reduced.

Moreover, also the difference in transmittance depending on the orientation of polarization of light can be reduced, and the lowering of the pickup function is never produced in the reading process of a detection signal. In addition, it is considered that an optical element, which has been given a diffractive grating for the purpose of interchangeability between a DVD and a CD and correction of aberration, has a high grating density, the degree of increase of angle of incidence becomes higher, and its influence on lowering of the pickup function due to surface reflection becomes larger; however even in such a case, a situation such that the pickup function is lowered can be avoided.

In the following, another suitable example of the embodiment relating to a polarized light splitting element, a wave plate, etc. will be explained concretely with reference to the drawings.

### The Sixth Example of the Embodiment

### A Base Material

A base material on which a pattern is to be drawn of this invention is characterized by it that a polarized light splitting structure or a structure having a function of a wave plate (a birefringence phase structure) is formed on a surface of an optical lens.

### Polarized Light Splitting Structure

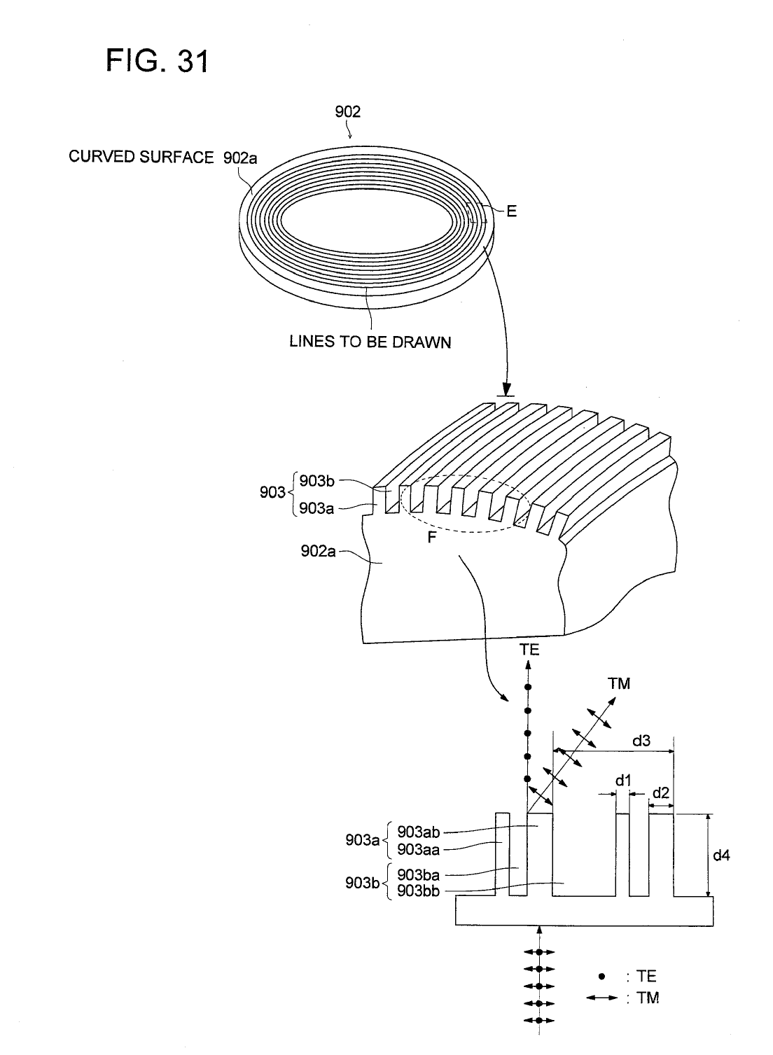

First, a base material as an object of pattern drawing having such a characteristic on which a pattern is to be drawn by an electron beam will be explained with reference to FIG. 31 to FIG. 35. In FIG. 31, a pattern to be drawn on a base material and the pattern shape of its detailed part are disclosed.

As shown in the drawing, as an example of a pattern to be drawn on a base material as an object of pattern drawing (hereinafter referred to as a base material simply) 902, a circular pattern is disclosed; as shown in an enlarged view of the part E which is a part of the pattern to be drawn on the base material 902 having a curved portion 902a as a surface on which a pattern is to be drawn, the base material 202 has a polarized light splitting structure 903 composed of a plurality of concave and convex portions formed on it. Besides, it is desirable that the base material 902 is made up of an optical element, for example, a pickup lens or the like.

The polarized light splitting structure 903 has a function to split a light beam entering or outgoing from said curved surface portion 902a into at least two polarized light components, namely, a TE wave and a TM wave, and has convex portions 903a and concave portions 903b.

To state it in more detail, as shown in an enlarged view of the part F shown in FIG. 31, each of the convex portions 903a of the polarized light splitting structure 903 comprises a first convex portion 903aa having a first width of d1 and a second convex portion 903ab having a second width of d2 which is different from said first width d1, and a plurality of the first and second convex portions are formed at intervals. Further, between the first convex portion 903aa and the second convex portion 903ab, a first concave portion 903ba having a narrower width and a second concave portion 903bb having a broader width are formed, and the concave portion 903b is composed of these first and second concave portions 903ba and 903bb. Besides, these first and second convex portions 903aa and 903ab are formed to have a height d4, and a plurality of periodic structure units, each of which has a length d3 and is composed of the first and second convex portions 903aa and 903ab and the first and second concave portions 903ba and 903bb, are formed. In addition, by making asymmetric the structure in one periodic structure unit, polarized light splitting can be performed even for a light beam entering perpendicularly.

In the base material 902 of this example of the embodiment, by making up such a periodic structure on the curved surface portion 902a, it is possible to split a light beam passing through said structure into a TE wave (a wave having no magnetic field component and only an electric field component in the plane perpendicular to the progressing direction) and a TM wave (a wave having no electric field component and only a magnetic field component in the plane perpendicular to the progressing direction).

Now, as the concrete numerical values of d1, d2, d3, and d4 in FIG. 31, it is desirable, for example, with the refractive index of the base material 902 denoted by n=1.92, and the wavelength denoted by λ, that d1=0.25λ, d2=0.39λ, d3=2λ, and d4=1.22λ.

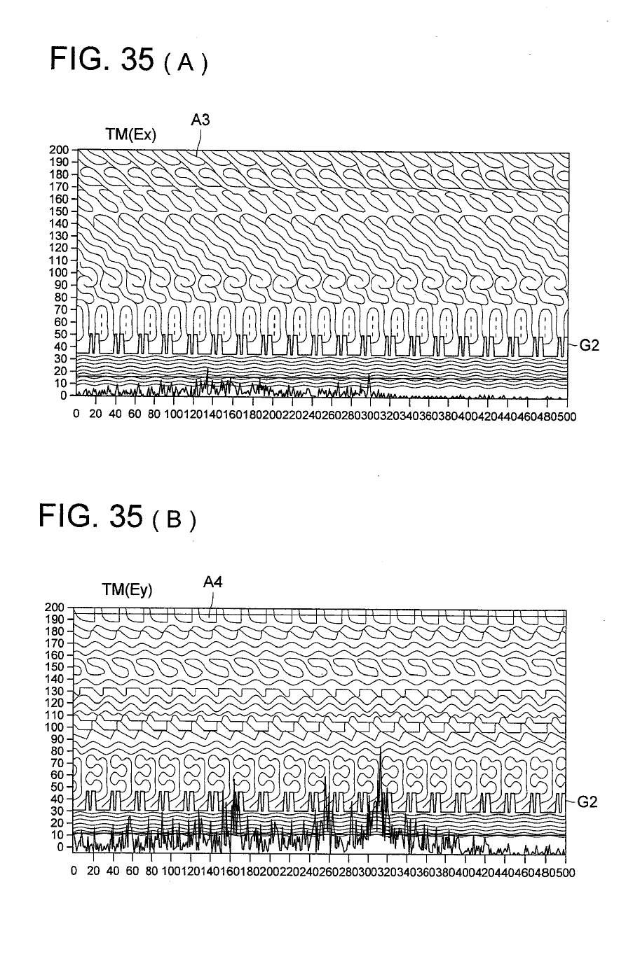

The result of analyzing how are the TM wave and the TE wave generated by the polarized light splitting structure 903 in the above-mentioned case, using the FDTD method for example, is shown in FIG. 35(A) and FIG. 35(B) respectively. In FIG. 35(A), it is disclosed how is the TM wave generated by the above-mentioned polarized light splitting structure 903, and in FIG. 35(B), it is disclosed how is the TE wave generated by said polarized light splitting structure 903.

However, in the both drawings, it is assumed that a light beam comes from the lower direction towards the upper direction in the drawing (supposing a base material, it is assumed that a light beam emerging out of the curved surface portion of the base material is split into a TE wave and a TM wave), and it is supposed a planar wave spreading to the infinity towards the upper side from the neighborhood of the position of the numerical value “10”, of the ordinate. Besides, the abscissa indicates the position along the lateral direction of the polarized light splitting structure G2 (unit: x 20 nm), and the ordinate indicates the position along the upper direction which is perpendicular to the polarized light splitting structure G2 (unit: nm). Further, in these drawings, the case where the wavelength λ is 250 nm is supposed.

As shown in these drawings, in the case where the polarized light splitting structure 903 having a shape as shown in FIG. 31 based on concave and convex portions (in FIG. 35(A) and FIG. 35(B), the polarized light splitting structure G2) is formed, as shown in FIG. 35(A) and FIG. 35(B), it is possible to generate both of the TM wave A3 and the TE wave A4 satisfactorily. Hence, it can be said that to set the above-mentioned d1 to d4 respectively at the numerical values shown in the above is desirable in generating a TE wave and a TM wave satisfactorily through splitting.

However, it is needless to say that, in short, so long as the function as a polarized light splitting structure of “splitting a progressing wave into a TE wave and a TM wave” can be achieved, the dimensions d1 to d4 in the birefringence structure, and the concave and convex structure are not to be limited to the example described in the above.

In this way, by making up the polarized light splitting structure 903 having such a shape as shown in FIG. 31 based on concave and convex portions on the curved surface portion 902a, it is possible to split a light wave into a polarized TE wave and TM wave. In addition, strictly speaking, as regards the distribution ratio of the transmittance for the TE wave and TM wave, for example, in the first order, it is 0.575 for the TE wave, and 0.036 for the TM wave; in the 0th order, it is 0.031 for the TE wave, and 0.574 for the TM wave; further, in the −1st order, it is 0.036 for the TE wave, and 0.016 for the TM wave, but the ratio in the −1st order is of no problem because it is negligibly small.

(Birefringence Phase Structure)

In the following, a base material on which a pattern is to be drawn provided with a birefringence phase structure will be explained with reference to FIG. 32. In FIG. 32, a pattern to be drawn on a base material and the pattern shape of its detailed portion are disclosed.

As shown in the drawing, as an example of a pattern to be drawn on a base material 4, a circular pattern is disclosed; as shown in an enlarged view of the part E which is a part of the pattern to be drawn on the base material 4 having a curved surface portion 4a as a surface on which a pattern is to be drawn, the base material 4 has a birefringence phase structure 5 composed of a plurality of concave and convex portions formed. In addition, it is desirable to make up the base material 4 of an optical element, for example, a pickup lens or the like.

The birefringence phase structure 5 has a function to generate a phase difference 0 at least between a TE wave and a TM wave, which are respectively one polarized light component and the other polarized light component of the two polarized light components TE wave and TM wave oscillating respectively in the directions perpendicular to each other in the plane crossing their progressing direction among light waves which are entering or emerging from said curved surface portion 4a, and has convex portions 5a and concave portions 5b.

To state it in more detail, as shown in an enlarged view of the part F shown in FIG. 32, the birefringence phase structure 5, which is different from the above-mentioned polarized light splitting structure 903, has a periodic structure formed of the convex portions 5a having a first width d5 and the concave portions 5b having a second width d6 which is shorter than said first width d5 being alternately positioned. In addition, the convex portions 5a is formed to have the height d7.

In the base material 4 of this example of the embodiment, by making up such a periodic structure on the curved surface portion 4a, it is possible to produce a phase difference φ between a TE wave and a TM wave among light waves transmitted through said structure.

Now, as regards the concrete numerical values of d5, d6, and d7 in FIG. 32, it is desirable that, for example, with the refractive index of the base material denoted by n=2.0 and the wavelength denoted by λ, d5:d6=7:3, and d7=1λ. Besides, in this case, a case where the structure has a function equivalent to, for example, a quarter-wave plate is supposed; however, this invention is not to be limited to this, and a structure having a function equivalent to a half-wave plate, one-wave plate, or the like is also of no problem.

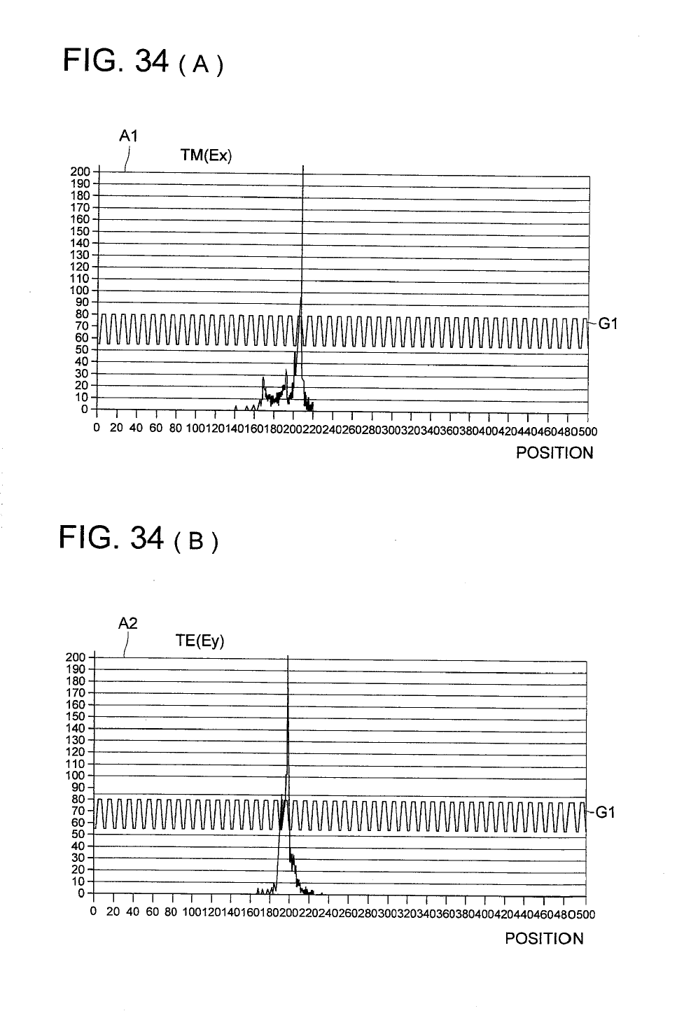

The results of analyzing how are the TM wave and the TE wave capable of producing a phase difference by the birefringence phase structure 5 in the above-mentioned case by the FDTD method etc. are shown respectively in FIG. 34(A) and FIG. 34(B). In FIG. 34(A), it is disclosed how is the TM wave generated by said birefringence structure 5, and in FIG. 34(B), it is disclosed how is the TE wave generated by said birefringence structure 5.

However, in the both drawings, it is assumed that a light wave comes from the lower direction towards the upper direction in the drawing (supposing a base material, it is assumed that a phase difference is produced between the TE wave and the TM wave of light waves emerging out of the curved surface portion of the base material), and it is supposed a planar wave spreading to the infinity towards the upper side from the neighborhood of the position of the numerical value “10” of the ordinate. Besides, the abscissa indicates the position along the lateral direction of the birefringence phase structure G1 (unit: x 20 nm), and the ordinate indicates the position along the upper direction which is perpendicular to the birefringence phase structure G1 (unit: nm). Further, in these drawings, the case where the wavelength λ is 500 nm is supposed.

As shown in these drawings, in the case where the birefringence phase structure 5 having a shape as shown in FIG. 32 based on concave and convex portions (in FIG. 34(A) and FIG. 34(B), the birefringence phase structure G1) is formed, as shown in FIG. 34(A) and FIG. 34(B), it is possible to generate satisfactorily both of the TM wave A1 and the TE wave A2 with a specified phase difference. Hence, it can be said that to set the above-mentioned d5 to d7 respectively at the numerical values shown in the above is desirable in generating a phase difference between a TE wave and a TM wave satisfactorily.

However, it is needless to say that, in short, so long as the function as a birefringence phase structure of “producing a phase difference between a TE wave and a TM wave” can be achieved, the setting of dimensions d5 to d7 in the birefringence structure, and the concave and convex structure are not to be limited to the example described in the above.

In this way, by making up the birefringence phase structure 5 having a shape as shown in FIG. 32 based on concave and convex portions on the curved surface portion 902a, it is possible to generate a phase difference between a TE wave and a TM wave.

In the following, it will be explained the principle of making a light wave polarized or the principle of making a phase difference produced by using a simple optical system composed of an element 902m having the above-mentioned polarized light splitting structure 903 and an element 904m having the birefringence phase structure 5.

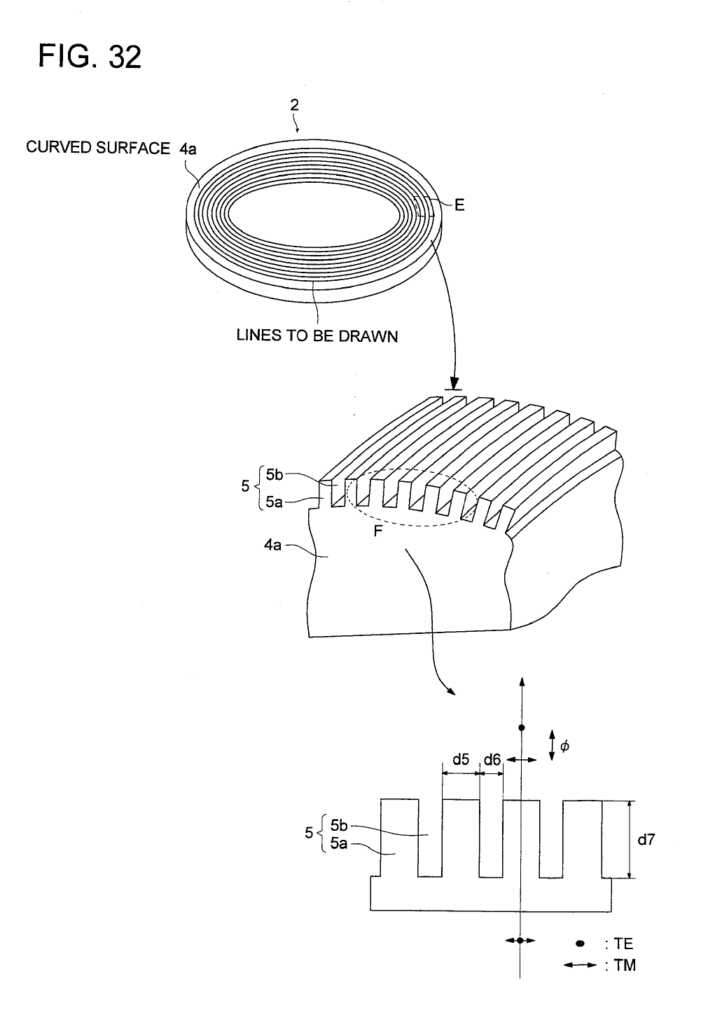

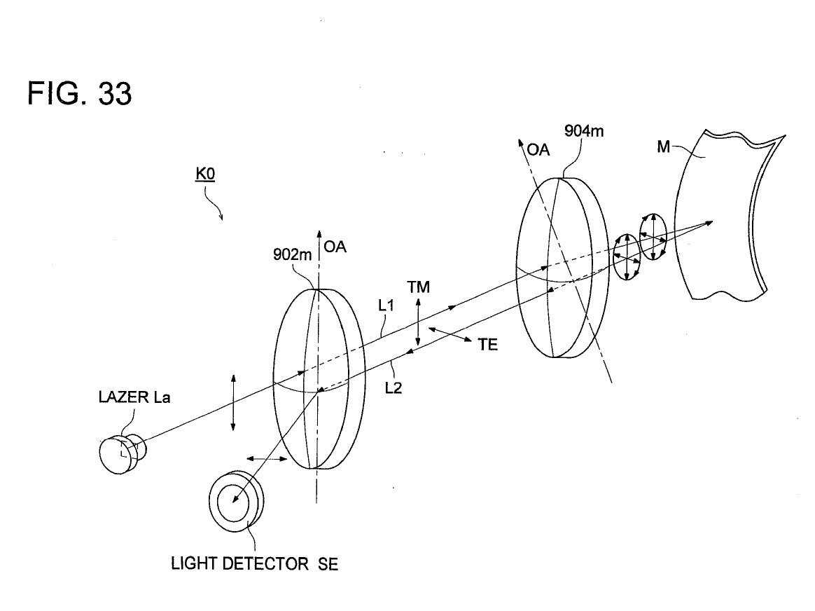

As shown in FIG. 33, in an optical system KO, a laser beam L1 from a laser La is made a specified parallel bundle of rays by the element 902m, is converged by the element 904m, and is applied to a magneto-optical recording medium M. The reflected laser beam L2 from the magneto-optical recording medium M enters the element 904m to become a parallel bundle of rays again, and is converged through the element 902m, to be incident on a light detector SE.

At this time, as regards the reflected laser beam L2, a phase difference between the TE wave and the TM wave is generated in the element 904m, and by the element 902m, the TE wave and the TM wave are split from each other, and become incident on the light detector SE.

As explained in the foregoing, by forming a polarized light splitting structure on the above-mentioned base material through drawing the pattern of a periodic structure composed of concave and convex portions each having a size of an order of sub-micron together with the pattern drawing on a curved surface portion by a three-dimensional pattern drawing method, also it is made possible to produce an optical lens or the like provided with a polarized light splitting structure on its one surface finally; hence, the optical lens may be applied to various kinds of apparatus instead of a conventional polarized light splitting element.

The reason is that elements having a polarized light splitting structure as final mold products by injection molding can be successively mass-produced, by making up a metal die on the basis of the above-mentioned base material.

Hence, in view of the labor and time in the processes for producing polarized light splitting elements one by one as in a conventional method, reduction of manufacturing cost by a large margin and an improvement of productivity can be achieved.

In the same way, by forming a birefringence phase structure on the above-mentioned base material, also it is made possible to form an optical lens or the like provided with a birefringence phase structure on its one surface finally; hence, the optical lens may be applied to various kinds of apparatus instead of a conventional wave plate.

The reason is that elements having a function of a wave plate as final mold products by injection molding can be successively mass-produced, by making up a metal die on the basis of the above-mentioned base material. Hence, in view of the labor and time in the processes for producing polarized light splitting elements one by one as in a conventional method, reduction of manufacturing cost by a large margin and an improvement of productivity can be achieved. As regards the concrete structure of a pattern drawing apparatus using an electron beam for forming a base material having a polarized light splitting structure or a base material having a birefringence phase structure as mentioned in the above, and the control for the pattern drawing, they are as described in the foregoing.

(Dose Distribution)

The control of a pattern drawing apparatus using an electron beam for carrying out pattern drawing with a desired dose distribution is the same as the abovementioned third to fifth examples of the embodiment.

The storing means stores, in forming a diffractive grating structure on the curved surface of a second base material, the characteristics of dose distribution defining beforehand a dose distribution for each scan position including the additional dose quantity for each blaze unit of the diffractive grating tilted in accordance with the position on the curved surface portion.

Further, in the case where the pattern drawing for a curved surface portion and a polarized light splitting structure is carried out on a first base material, the control means practices a control to vary the focus position in accordance with the pattern drawing position on the basis of the pattern drawing position measured by the measuring means, by adjusting the electric current value of the electron lens, and in the case where the pattern drawing for the curved surface portion and the diffractive grating structure is carried out on a second base material, the control means practices a control to vary the focus position in accordance with the pattern drawing position on the basis of the pattern drawing position measured by the measuring means, by adjusting the electric current value of the electron lens, and further such a control as to carry out the pattern drawing, in respect of the range within the depth of focus at the focus position, for the curved surface portion and the polarized light splitting structure portion, as calculating the pertinent dose quantity on the basis of the above-mentioned dose distribution characteristic stored in the storing means. Hence, it is possible that pattern drawing for each of the first and second base materials is independently carried out, and in a process after pattern drawing, a single base material, which is an integrated body of the above-mentioned first and second base materials is produced.

In addition, the process is done in the same way also in the case where a birefringence phase structure is formed on a first base material and a diffractive grating structure is formed on a second base material.

Further, the control means practices a control to carry out the pattern drawing for the above-mentioned curved surface portion and concave and convex portions as calculating the pertinent dose quantity on the basis of the dose distribution characteristic. In another way, it practices a control to carry out, in forming at least one blaze unit of the diffractive grating tilted on the curved surface portion, the pattern drawing for the above-mentioned curved surface portion and concave and convex portions as calculating the pertinent dose quantity on the basis of the dose distribution characteristic defining beforehand the dose quantity distribution for each scan position including the additional dose quantity of the pertinent portion.

Further, the control means practices a control to vary the above-mentioned focus position of the electron beam in accordance with the above-mentioned pattern drawing position by adjusting the electric current value of the electron lens, while it practices a control to carry out the pattern drawing for the above-mentioned base material, in respect of the range within the depth of focus at the above-mentioned focus position, as calculating the pertinent dose quantity on the basis of the dose distribution characteristic.

Furthermore, the control means practices a control to vary, on the basis of the pattern drawing position measured by the measuring means, the focus position of the electron beam applied by the electron beam applying means in accordance with the above-mentioned pattern drawing position, by moving up and down the carrying table by means of a drive means, while it practices a control, in respect of the range within the depth of focus at the above-mentioned focus position, to carry out the pattern drawing for the above-mentioned base material, as calculating the pertinent dose quantity on the basis of the above-mentioned dose distribution characteristic stored in the above-mentioned storing means.

(The Concrete Structure of the Control System)

Next, the control for carrying out various kinds of processes in the case where the above-mentioned circular pattern is approximated by a regular polygon and is drawn by straight-line scanning is the same as that described in the above.

(The Procedure of the Processing)

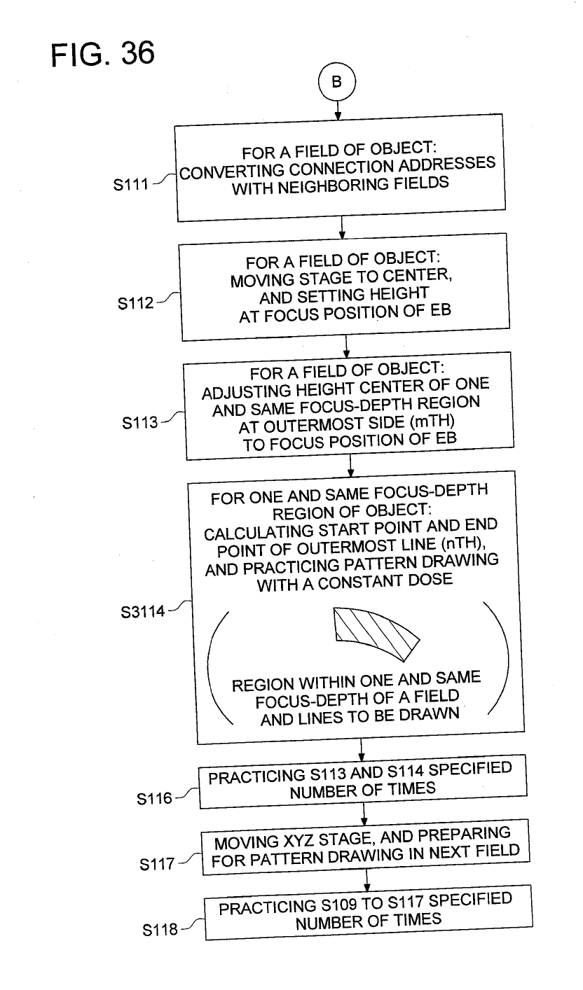

In the following, it will be explained with reference to FIG. 35 and FIG. 36, the procedure of the processing in producing a base material having a structure as described in the above by means of a pattern drawing apparatus using an electron beam capable of three-dimensional pattern drawing. Only the steps which are different from those in the above-mentioned examples of the embodiment will be explained below.

In this example of the embodiment, in the step S3114, in respect of the range within the same depth of focus taken as the object, the calculation of the dose quantity for the outermost (nth) line and the start point and end point of the polygon is carried out. Then, pattern drawing is done with a constant dose quantity (S3114). The area in the same focus-depth of the field and the line to be drawn are as shown in the step S3114. Further, the above-mentioned steps S3113 and S3114 are practiced a specified number of times (S3116).

In this way, by practicing the above-mentioned steps S109 to S117 a specified number of times (S118), it is possible to produce a base material having a polarized light splitting structure or a birefringence phase structure on the curved surface portion by means of an electron beam.

As explained in the foregoing, according to this example of the embodiment, by forming a polarized light splitting structure on the above-mentioned base material through drawing the pattern of a periodic structure composed of concave and convex portions each having a size of an order of sub-micron together with the pattern drawing for a curved surface portion by a three-dimensional pattern drawing method, also it is made possible to produce an optical lens or the like provided with a polarized light splitting structure on its one surface finally; hence, the optical lens may be applied to various kinds of apparatus instead of a conventional polarized light splitting element.

Further, by making up a metal die on the basis of the above-mentioned base material, elements having a polarized light splitting structure as final mold products by injection molding can be successively mass-produced. Hence, in view of the labor and time in the processes for producing polarized light splitting elements one by one as in a conventional method, reduction of manufacturing cost by a large margin and an improvement of productivity can be achieved.

Further, in the case where a birefringence phase structure is formed on the above-mentioned base material, also it becomes possible to form an optical lens or the like having the function of a wave plate as a birefringence phase structure on its one surface finally; hence, the optical lens may be applied to various kinds of apparatus instead of a conventional wave plate, and by making up a metal die on the basis of the above-mentioned base material, elements having a function of a wave plate as final mold products by injection molding can be successively mass-produced.

### Seventh Example of the Embodiment

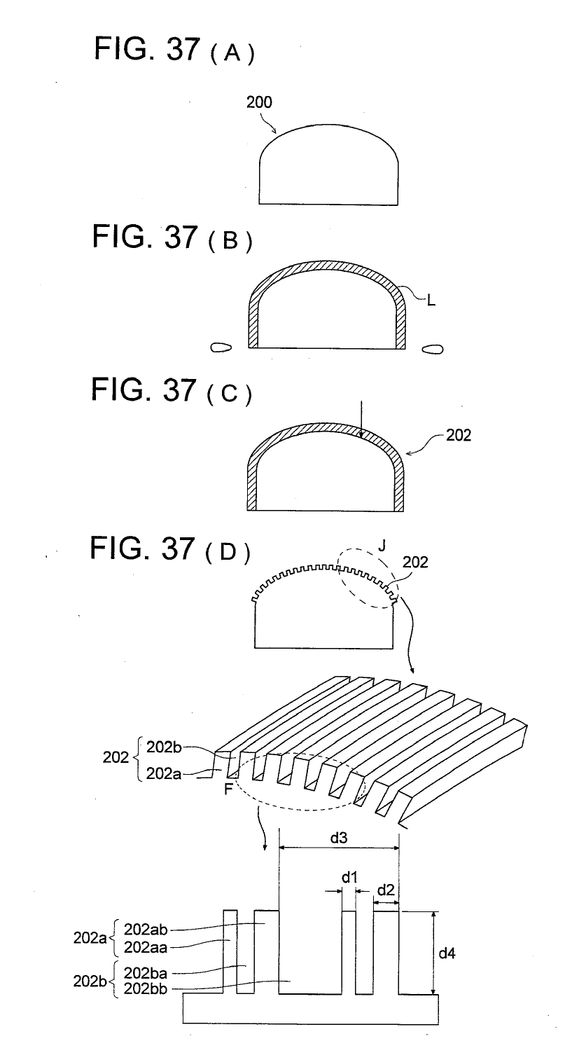

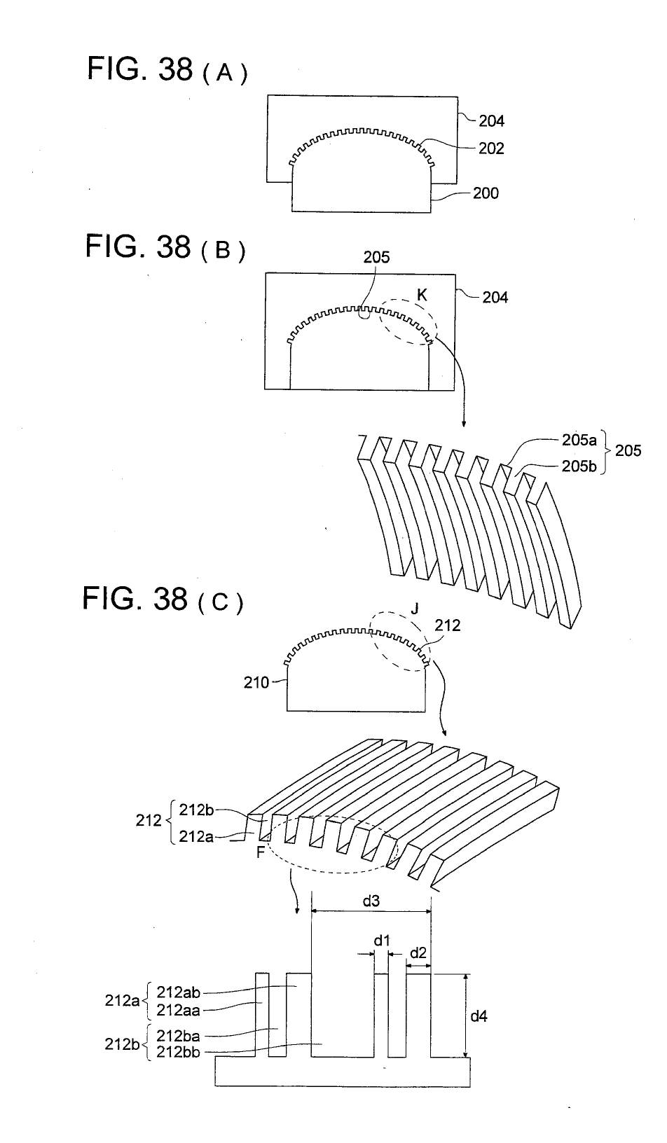

In the following, the seventh example of the embodiment of this invention will be explained with reference to FIG. 37 and FIG. 38. In addition, as regards the items having substantially the same structure as the above-mentioned sixth example of the embodiment, the explanation will be omitted, and only the different parts will be described.

In the above-mentioned sixth example of the embodiment, it has been disclosed the process to apply high-precision working such as forming a polarized light splitting structure to a base material by means of an electron beam; however in this example of the embodiment, it will be explained the overall process including the above-mentioned process, in particular, the process in which a metal die or the like for manufacturing an optical element such as an optical lens by injection molding is produced.

First, aspherical working of a metal die (made of non-electrolytic nickel, etc.) by machining is carried out (working process). Next, as shown in FIG. 37(A), resin molding of a base material 200 having the above-mentioned hemispherical surface is carried out by means of the metal die (resin molding process). Further, the base material 200 is washed and dried.

Subsequently, a surface treatment of the base material 200 is carried out (resin surface treatment process). To state it concretely, as shown in FIG. 37(B), the position adjustment of the base material 200 is made, and a spinner is rotated while resist L as a coating agent is being dropped, to carry out spin coating. Moreover, also pre-baking is carried out.

After spin coating, the thickness of said resist film is measured, and the evaluation of the resist film is made (resist film evaluation process). Then, as shown in FIG. 37(C), the position adjustment of the base material 200 is carried out, and as said base material 200 is being controlled with respect to the X-axis, Y-axis, and Z-axis, pattern drawing for the curved surface portion comprising a polarized light splitting structure 202 is carried out by an electron beam for three-dimensional pattern drawing as the above-mentioned fourth example of the embodiment (pattern drawing process).

Next, a surface smoothing treatment for the resist film L on the base material 200 is carried out (surface smoothing process). Further, as shown in FIG. 37(D), while the position adjustment of the base material 200 is being made, development processing is carried out (development process). Furthermore, a surface hardening treatment is carried out.

Subsequently, by SEM observation, film thickness measurement, etc., a process for evaluating the shape of the resist is carried out (resist shape evaluation process). Further, after that, an etching process is carried out by a dry etching method or the like.

At this time, as shown in an enlarged view of the part J of the polarized light splitting structure, convex portions 202a and concave portions 202b are provided; further, as shown in an enlarged view of the part F, each of the convex portions 202a comprises a first convex portion 202aa having a first width d1 and a second convex portion 202ab having a second width d2 which is different from said first width d1, and a plurality of the first convex portions 202aa and the second convex portions 202ab are formed at intervals. Further, between the first convex portion 202aa and the second convex portion 202ab, a first concave portion 202ba having a narrower width and a second concave portion 202bb having a broader width are formed, and these first and second concave portions 202ba and 202bb compose the concave portion 202b.

Next, in order to produce a metal die 204 for the base material 200 to which a surface treatment has been applied, as shown in FIG. 38(A), after a pre-treatment for electroforming processing of the metal die is carried out, an electroforming process etc, are practiced, and as shown in FIG. 38(B), a processing to separate the metal die 204 from the base material 200 is carried out.

To the metal die 204 which has been separated from the base material having been subjected to a surface treatment, a surface treatment is carried out (die surface treatment process). Then, the evaluation of the metal die 204 is performed.

Now, in the metal die 204, as shown in an enlarged view of the part K, a structure 205 composed of a concave portion 205a and a convex portion 205b is formed in such a way that they correspond to the convex portion and the concave portion of the above-mentioned base material 200 respectively.

In this way, after evaluation, by using the above-mentioned metal die 204, as shown in FIG. 38, mold products are produced by injection molding. After that, the evaluation of said mold products is performed.

Now, as shown in FIG. 38(C), in the injection molding product 210, a structure similar to that of the base material in the above-mentioned fourth example of the embodiment is completed, and a polarized light splitting structure 212 composed of a plurality of asymmetric concave and convex portions is formed on the curved surface portion. Further, as shown in an enlarged view of the part J, convex portions 212a and concave portions 212b are provided; further, as shown in an enlarged view of the part F, each of the convex portions 212a of the polarized light splitting structure 212 comprises a first convex portion 212aa having a first width d1 and a second convex portion 212ab having a second width d2 which different from said first width d1, and a plurality of the first and the second convex portions 212aa and 212ab are formed at intervals. Further, between the first convex portion 212aa and the second convex portion 212ab, a first concave portion 212ba having a narrower width and a second concave portion 212bb having a broader width are formed, and these first and second concave portions 212ba and 212bb compose the concave portion 212b.

As explained in the foregoing, according to this example of the embodiment, in the case where an optical element (for example, a lens) as the base material of the above-mentioned fourth example of the embodiment is produced, by drawing the pattern of the polarized light splitting structure composed of concave and convex portions having a size of an order of sub-wavelength together with the pattern drawing for the curved surface portion by means of a three-dimensional pattern drawing apparatus, to form a polarized light splitting structure as the shape of a metal die, said optical element can be manufactured by injection molding using a metal die; hence, it is possible to make the cost necessary for manufacturing reduced.

Further, by adding a structure having a polarized light splitting function to the metal die, the function can be added to lenses at the same time in injection molding, which makes it unnecessary to carry out an additional process. For this reason, although the manufacturing cost of the metal die itself is increased and the possible number of shots (about one million times) is [increased] decreased, it is possible to make the manufacturing cost and operation time reduced by a large margin as compared to the case where a process is applied to each base material such as a polarized beam splitter, which is a polarized light splitting element, as in a conventional method.

Further, because a polarized light splitting structure can be built in a plastic lens simultaneously in the process of injection molding of it, a process for producing a polarized light splitting element becomes unnecessary, which causes the cost of optical parts to be reduced.

In particular, this method can be applied also to a lens having no curved surface portion structure produced by injection molding, and by eliminating various kinds of steps, it is possible to achieve cost reduction by a large margin.

### The Eighth Example of the Embodiment

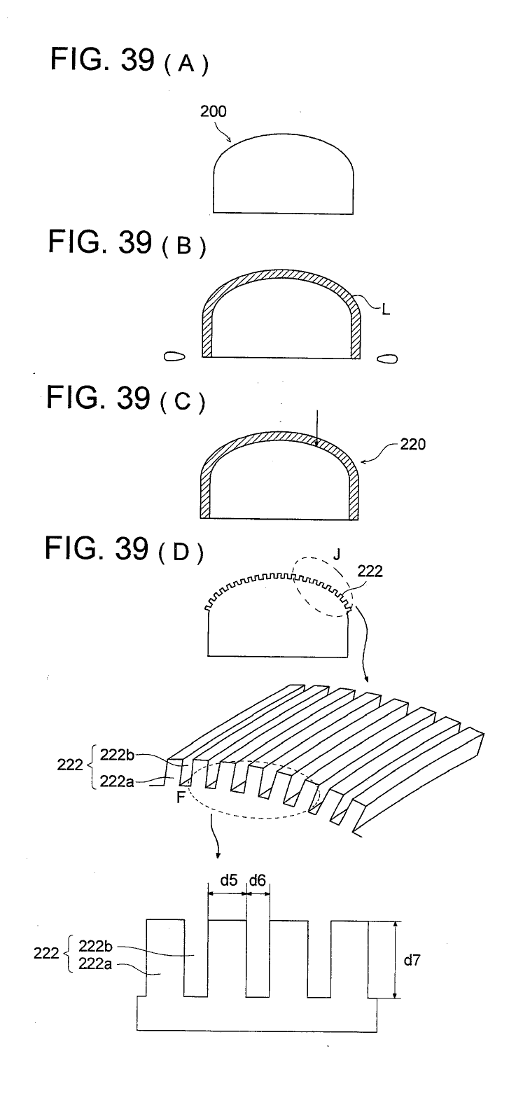

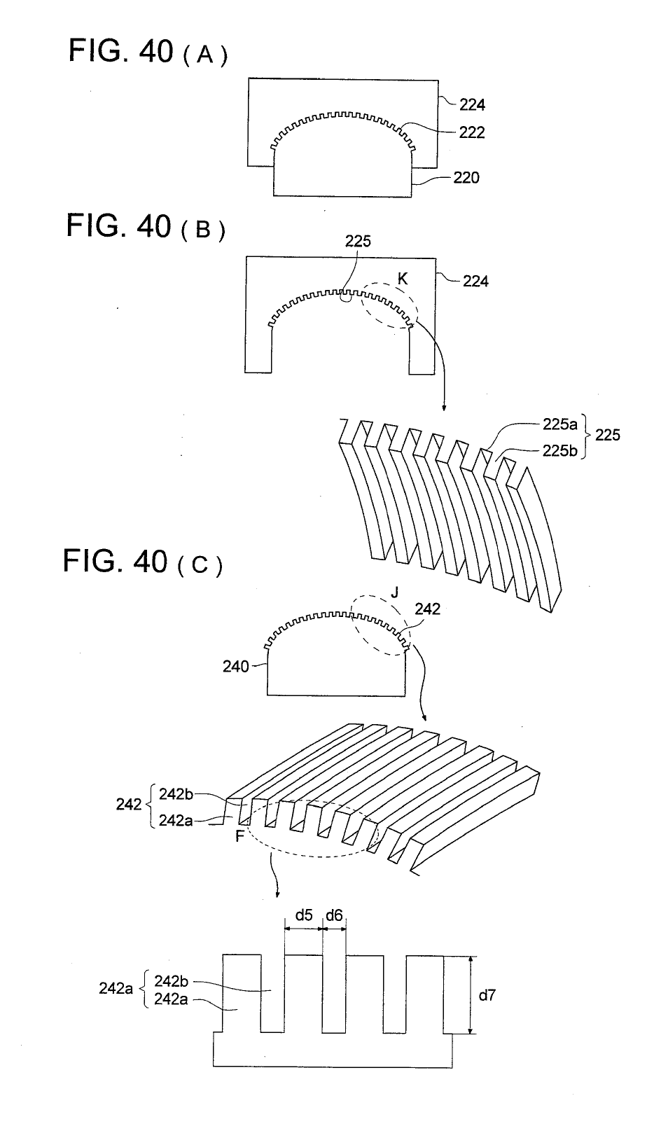

In the following, the eighth example of the embodiment of this invention will be explained with reference to FIG. 39 and FIG. 40. In the above-mentioned seventh example of the embodiment, the procedure of the overall process relating to a base material having a polarized light splitting structure has been explained; however in this example of the embodiment, it will be explained the overall process relating to a base material having a function of a wave plate as a birefringence phase structure, in particular, the process in which a metal die etc. for manufacturing an optical element such as an optical lens by injection molding is produced.

First, aspherical working of a metal die (made of non-electrolytic nickel, etc.) by machining is carried out (working process). Next, as shown in FIG. 39(A), resin molding of a base material 220 having the above-mentioned hemispherical surface is carried out by means of the metal die (resin molding process). Further, the base material 220 washed and dried.

Subsequently, a surface treatment of the base material 220 is carried out (resin surface treatment process). To state it concretely, as shown in FIG. 39(B), the position adjustment of the base material 220 is made, and a spinner is rotated while resist L as a coating material is being dropped, to carry out spin coating. Moreover, also pre-baking etc. are carried out.

After spin coating, the thickness of said resist film is measured, and the evaluation of the resist film is made (resist film evaluation process). Then, as shown in FIG. 39(C), the position adjustment of the base material 220 is carried out, and as said base material 220 is being controlled with respect to the X-axis, Y-axis, and Z-axis, pattern drawing for the curved surface portion comprising a birefringence phase structure 222 is carried out by an electron beam for three-dimensional pattern drawing as the above-mentioned fourth example of the embodiment (pattern drawing process).

Next, a surface smoothing treatment for the resist film L on the base material 220 is carried out (surface smoothing process). Further, as shown in FIG. 39(D), while the position adjustment of the base material 220 is being made, development processing is carried out (development process). Furthermore, a surface hardening treatment is carried out.

Subsequently, by SEM observation, film thickness measurement, etc., a process for evaluating the shape of the resist is carried out (resist shape evaluation process). Further, after that, an etching process is carried out by a dry etching method or the like.

At this time, as shown in an enlarged view of the part J of the birefringence phase structure 222, convex portions 222a and concave portions 222b are provided; further, as shown in an enlarged view of the part F, the birefringence phase structure 222 has a periodic structure formed of a plurality of the convex portions 222a each having a first width d5 and the concave portions 222b each having a second width d6, which is shorter than said first width d5, being alternately positioned. In addition, the convex portion 222a is formed to have a height of d7.

Next, in order to produce a metal die 224 for the base material 220 to which a surface treatment has been applied, as shown in FIG. 40(A), after a pre-treatment for electroforming processing of the metal die is carried out, an electroforming process etc. are practiced, and as shown in FIG. 40(B), a processing to separate the metal die 224 from the base material 220 is carried out.

To the metal die 224 which has been separated from the base material having been subjected to a surface treatment, a surface treatment is carried out (die surface treatment process). Then, the evaluation of the metal die 224 is performed.

Now, in the metal die 224, as shown in an enlarged view of the part K, a structure 225 composed of a concave portion 225a and a convex portion 225b is formed in such a way that they correspond to the convex portion and the concave portion of the above-mentioned base material 220 respectively.

In this way, after evaluation, by using the above-mentioned metal die 224, as shown in FIG. 40, mold products are produced by injection molding. After that, the evaluation of said mold products is performed.

Now, as shown in FIG. 40(C), in the injection molding product 240, a structure similar to that of the base material in the above-mentioned fourth example of the embodiment is completed, and a birefringence phase structure 242 composed of a plurality of concave and convex portions is formed on the curved surface portion. Further, as shown in an enlarged view of the part J, there is provided a periodic structure formed of convex portions 242a each having a first width d5 and concave portions 242b each having a second width d6, which is shorter than said first width d5, being alternately positioned. Further, the convex portion is formed to have a height of d7.

As explained in the foregoing, according to this example of the embodiment, in the case where an optical element (for example, a lens) is produced as the base material of the above-mentioned fourth example of the embodiment, by drawing the pattern of the birefringence phase structure composed of concave and convex portions each having a size of an order of sub-wavelength together with the pattern drawing for the curved surface portion by means of a three-dimensional pattern drawing apparatus, to form a birefringence phase structure as the shape of a metal die, said optical element can be manufactured by injection molding using a metal die; hence, it is possible to make the cost necessary for manufacturing reduced.

Further, by adding a structure having a function of a wave plate to the metal die, the function can be added to lenses at the same time in injection molding, which makes it unnecessary to carry out an additional process. For this reason, although the manufacturing cost of the metal die itself is increased and the possible number of shots (about one million times) is [increased] decreased, it is possible to make the manufacturing cost and operation time reduced by a large margin as compared to the case where a process is applied to each base material such as a wave plate as in a conventional way.

Further, because a structure having a function of a wave plate can be built in a plastic lens simultaneously in the process of injection molding of it, a process for producing a wave plate becomes unnecessary, which causes the cost of optical parts to be reduced.

In particular, this method can be applied also to a lens having no curved surface portion structure produced by injection molding, and by eliminating various kinds of steps, it is possible to achieve cost reduction by a large margin.

### Ninth Example of the Embodiment

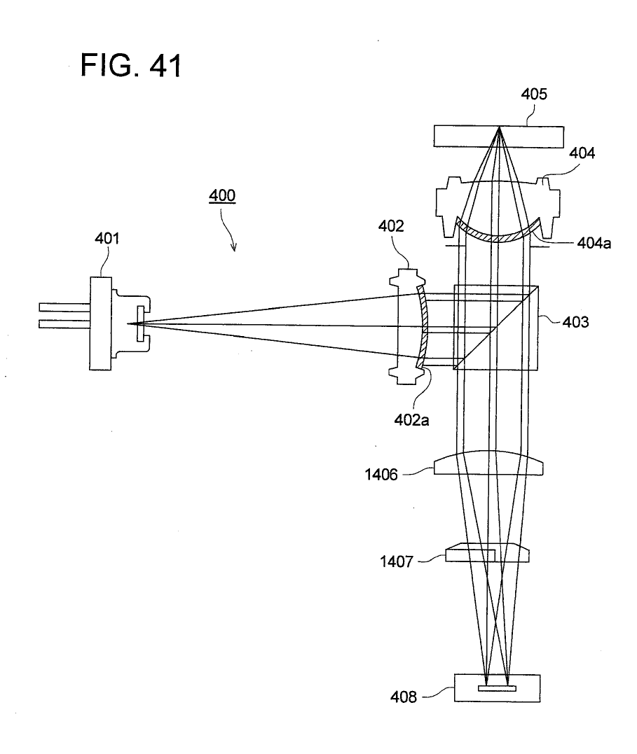

In the following, the ninth example of the embodiment of this invention will be explained on the basis of FIG. 41. FIG. 41 is a functional block diagram showing the ninth example of the embodiment of this invention.

In this example of the embodiment, it is disclosed an example of an optical pickup device as an example of electronic equipment using a base material as an object of pattern drawing (a base material) on which a pattern has been drawn by means of the above-mentioned pattern drawing apparatus using an electron beam (or an optical element which is a product formed of resin by injection molding).

In FIG. 41, an optical pickup device 400 comprises a semiconductor laser 401, a collimator lens 402 (a first optical element), a splitting prism 403, an objective lens 404 (a second optical element), a magneto-optical disk such as a DVD or a CD (a magneto-optical recording medium), a convergent lens 1406 (a third optical element), a cylindrical lens 1407, and a split light detector 408.

In this example of the embodiment, the optical elements in the above-mentioned examples of the embodiment is applied to some of the above-mentioned optical parts (irrespective of the presence or absence of a curved surface portion), for example, one including a polarized light splitting structure is applied to the collimator lens 402, and one including a birefringence phase structure (a structure having the function of a wave plate) is applied to the objective lens 404. That is, the collimator lens 402 has a polarized light splitting structure 402a, and the objective lens 404 has a birefringence phase structure 404a.

In the optical pickup device 400 having a structure as described in the above, a laser beam from the semiconductor laser 401 is made parallel by the collimator lens 402. At this time, it is split into two bundles of rays which are composed of P polarized light and S polarized light and have optical paths close to each other respectively. The parallel beam including these two bundles of rays is reflected by the splitting prism 403 towards the objective lens 404, is converged by the objective lens 404 to the diffraction limit, and is applied to the magneto-optical disk 405 (magneto-optical recording medium).

The reflected laser beam from the magneto-optical disk 405 enters the objective lens 404, is again made a parallel beam. At this time, a phase difference is generated between the above-mentioned P polarized light and S polarized light by the birefringence phase structure 404a; after their orientations of polarization are rotated by a specified angle, they are transmitted through the splitting prism 403, and the two bundles of rays, which are composed of P polarized light and S polarized light and have optical paths close to each other respectively, are converged by the convergent lens 1406 and the cylindrical lens 1407, to form their respective spots in the split light receiving areas (light receiving elements) of the split light detector 408.

As described in the above, in this example of the embodiment, by using an optical lens provided with a polarized light splitting structure on its one surface (integrally formed), and an optical lens provided with a birefringence phase structure on its one surface, it becomes unnecessary to use a dedicated polarized beam splitter and a wave plate as in a conventional device, the number of component members and the number of attached parts are reduced, which makes it possible to achieve the cost reduction by a large margin.

Further, because it becomes unnecessary to arrange a polarized light splitting element and a wave plate, the space occupied by the component members mounted is reduced, which makes it possible to achieve making the size of an optical pickup device smaller; further, the adjustment required for the optical system of an optical pickup device becomes unnecessary.

Further, in respect of an optical pickup device, to make it small-sized and integrated becomes easy, and the tracking mechanism can be simplified.

Besides, in the above-mentioned example of the embodiment, it is shown as an example the case where a polarized light splitting structure is formed on the collimator lens and a birefringence phase structure is formed on the objective lens, but this invention should not be limited to this; it is of course possible a case where various kinds of polarized light splitting structures or birefringence phase structures are formed on the convergent lens, cylindrical lens, etc.

### The Tenth Example of the Embodiment

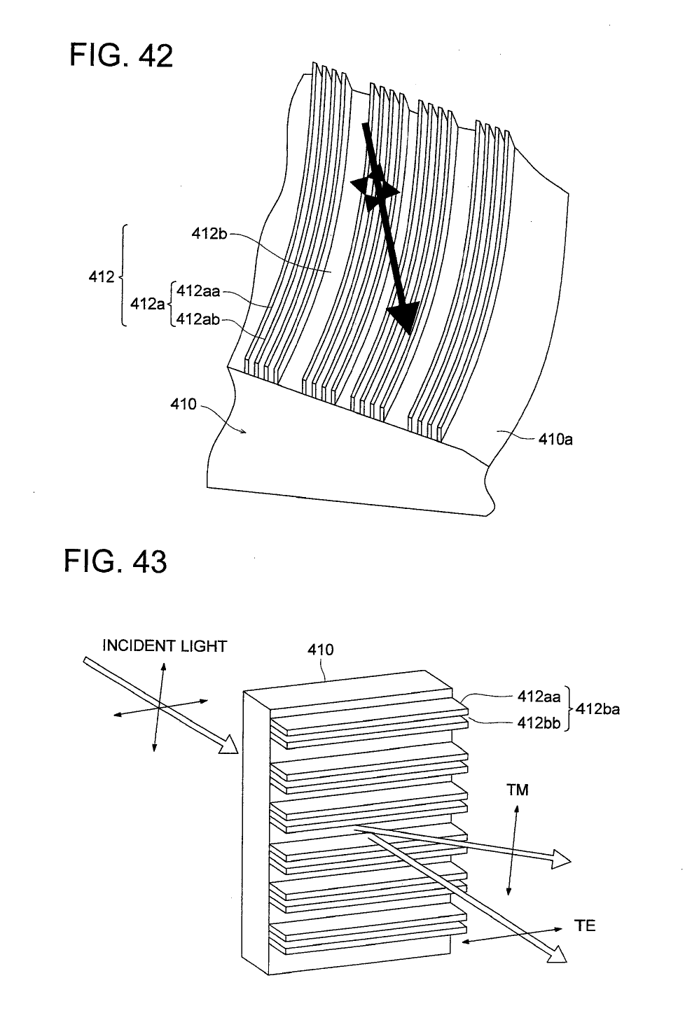

In the following, the sixth example of the embodiment of this invention will be explained on the basis of FIG. 42 and FIG. 43.

With respect to a polarized light splitting structure to be formed on the curved surface portion of a base material, it is not limited to the structure described in the above-mentioned sixth example of the embodiment, but a structure as shown in FIG. 42 may be employed.

As shown in the drawing, a polarized light splitting structure 412 to be formed on a curved surface portion 410a of a base material 410 has a periodic structure formed of a first concave and convex portions 412a each composed of a plurality (for example, four) of a first convex portions 412aa having a first width and a first concave portions 412ab having a second width, which is different from said first width, being alternately positioned, and a second concave portions 412b each formed to have a third width, which is different from said first and second width, being alternately positioned.

Further, in FIG. 43, it is disclosed a structure in which the number of the first convex portions 412aa in the first concave and convex portion 412a is two. Any way, it is possible to split an incident light wave into a TE wave and a TM wave in the emerging light wave.

### Eleventh Example of the Embodiment

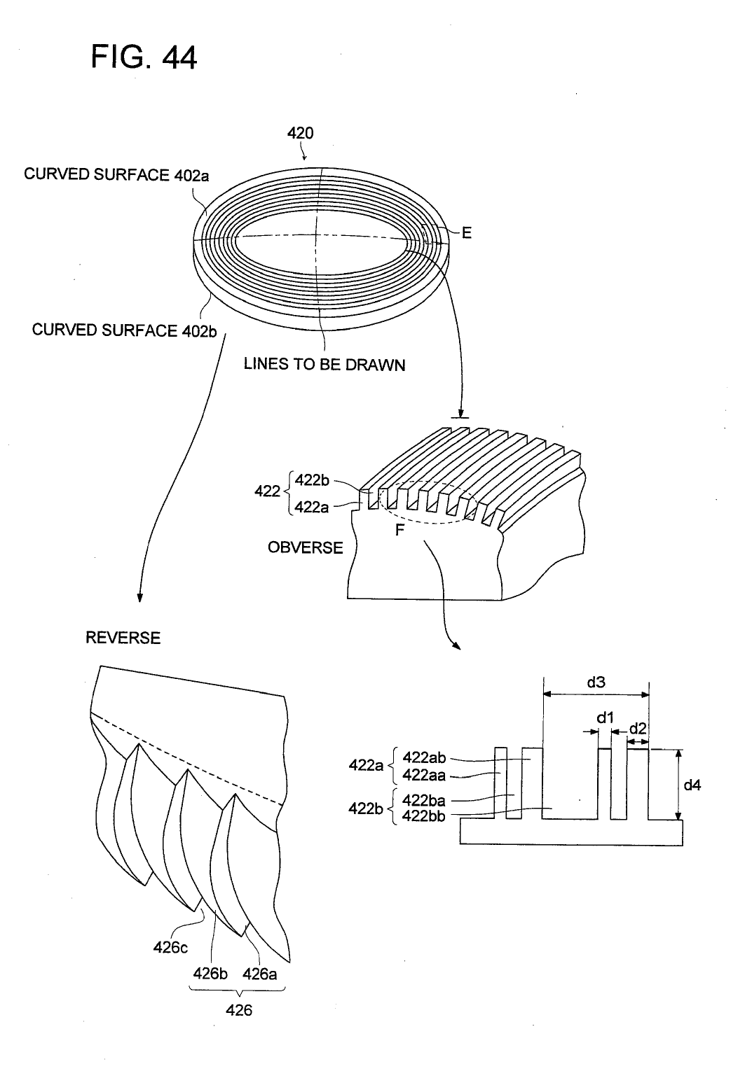

In the following, the tenth example of the embodiment of this invention will be explained on the basis of FIG. 44. In the above-mentioned tenth example of the embodiment, it has been explained a case where a polarized light splitting structure is formed on one surface of a base material; however, in this example of the embodiment, it is disclosed a case where a polarized light splitting structure is formed on one surface of a base material and a blaze-shaped diffractive grating structure is formed on the other surface of the base material.

To state it concretely, as shown in FIG. 44, on the curved surface portion 420a on one side of the base material 420, a circular pattern is disclosed as an example of a pattern to be drawn; as shown in an enlarged view of the part E which is a part of the pattern to be drawn, the base material 420 has a polarized light splitting structure 422 composed of a plurality of concave and convex portions formed on it. Besides, it is desirable that the base material 422 is made up of an optical element, for example, a pickup lens or the like.

The polarized light splitting structure 422 has a function to split a light beam entering or outgoing from said curved surface portion 420a into at least two polarized light components, namely, a TE wave and a TM wave, and has convex portions 422a and concave portions 422b.

To state it in more detail, as shown in an enlarged view of the part F shown in FIG. 44, each of the convex portions 422a of the polarized light splitting structure 422 comprises a first convex portion 422aa having a first width of d1 and a second convex portion 422ab having a second width of d2 which is different from said first width d1, and a plurality of the first and second convex portions are formed at intervals. Further, between the first convex portion 422aa and the second convex portion 422ab, a first concave portion 422ba having a narrower width and a second concave portion 422bb having a broader width are formed, and these first and second concave portions 422ba and 422bb make up a concave portion 422b. Besides, these first and second convex portions 422aa and 422ab are formed to have a height d4, and it is formed a periodic structure made up of a plurality of units, each of which has a length d3 and is composed of the first and second convex portions 422aa and 422ab and the first and second concave portions 422ba and 422bb. In addition, by making the structure in one unit asymmetric, polarized light splitting can be performed even for a light beam entering perpendicularly.

In the base material 420 of this example of the embodiment, by making up such a periodic structure on the curved surface portion 420a, it is possible to split a light wave passing through said structure into a TE wave (a wave having no magnetic field component and only an electric field component in the plane perpendicular to the progressing direction) and a TM wave (a wave having no electric field component and only a magnetic field component in the plane perpendicular to the progressing direction).

Now, as the concrete numerical values of d1, d2, d3, and d4 in FIG. 44, it is desirable, for example, with the refractive index of the base material 902 denoted by n=1.92, and the wavelength denoted by λ, that d1=0.25λ, d2=0.39λ, d3=2λ, and d4=1.22λ.

The structure described up to now is similar to that in the sixth example of the embodiment. In this example of the embodiment, further, a diffractive grating structure composed of a plurality of blazes 426 is formed on the curved surface portion 420b on the other side of the base material 420.

To state it concretely, as shown in an enlarged view of a part of the curved surface portion 420b on the other side of the base material 420, a diffractive grating structure composed of a plurality of blazes 426 is formed on the base material 420.

Each of the blazes 426 are formed of a slope portion 426b and a side wall portion 426a, and a plurality of said side wall portions 426a are formed along the circumferential direction in a cylindrical shape.

To state it in more detail, the base material 420 has a curved surface portion 420b formed on the other side (rear side) of the base material 420, and has a diffractive grating with each blaze formed with an inclination positioned at every unit width of the pitch L1; in one pitch L1 of this diffractive grating, the side wall portion 426a rising upward from said curved surface portion 420a at one end position of said unit length, a slope portion 426b formed between two neighboring side walls 426a and 426a, and a groove portion 426c formed in the border space between the side wall portion 426a and the slope portion 426b are included. Further, it is desirable that the shape of the blazes has such a structure that the inclination becomes larger with the position coming nearer to the periphery of the curved surface portion 420b. In addition, it is desirable that this diffraction pattern structure is formed by the pattern drawing applied to a coating layer (a resist) coated on the curved surface portion 420a. Besides, also it is appropriate to form a reflection reducing structure for reducing the reflection of light entering said slope portion 426b on said slope portion 426b.

As explained in the above, in this example of the embodiment, by forming a polarized light splitting structure on the surface of one side of a base material and a plurality of blazes as a diffractive grating structure on the surface on the other side of the base material, correction of aberration in the case of interchangeable use of a CD and a DVD becomes possible; hence, a CD and a DVD can be used interchangeably in an optical pickup device. Further, by employing a structure in which the blaze is made to have a steeper inclination with the position coming nearer to the periphery of the curved surface portion, the lowering of the pickup function caused by the increase of angle of incidence owing to the grating density becoming higher can be eliminated.

In addition, in this example of the embodiment, it has been shown as an example a case where a polarized light splitting structure is formed on the surface on one side of a base material and a diffractive grating structure is formed on the surface on the other side of the base material; however as a matter of course, also it is appropriate a case where a birefringence phase structure is formed on the surface on one side of a base material and a diffractive grating structure is formed on the surface on the other side of the base material.

### The Twelfth Example of the Embodiment

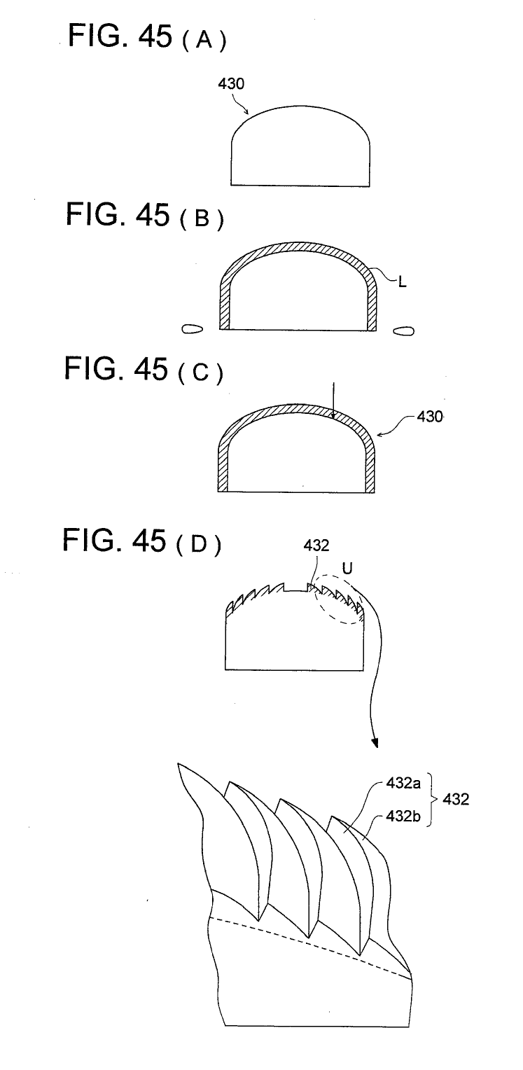

In the following, the twelfth example of the embodiment will be explained on the basis of FIG. 45 to FIG. 47.

In the above-mentioned eleventh example of the embodiment, it has been disclosed an example in which a polarized light splitting structure is formed on the curved surface portion on one side of a base material and a diffractive grating structure is formed on the surface on the other side of the base material; however in this example of the embodiment, it will be explained the overall process for manufacturing the above-mentioned structure, in particular, a process in which a metal die or the like for manufacturing an optical element such as an optical lens by injection molding.

Besides, as regards the process in the case where a polarized light splitting structure or a birefringence phase structure is formed on the curved surface portion on one side of a base material, the explanation will be omitted because it is similar to that in the above-mentioned sixth example and seventh example of the embodiment; hence, an explanation centered on a manufacturing process for forming a diffractive grating structure on the curved surface portion on the other side of the base material will be given.

First, aspherical working of a metal die (made of non-electrolytic nickel, etc.) by machining is carried out (working process). Next, as shown in FIG. 45(A), resin molding of a base material 430 having the above-mentioned hemispherical surface is carried out by means of the metal die (resin molding process). Further, the base material 430 is washed and dried.

Subsequently, a surface treatment of the base material 430 is carried out (resin surface treatment process). To state it concretely, as shown in FIG. 45(B), the position adjustment of the base material 430 is made, and a spinner is rotated while resist L as a coating material is being dropped, to carry out spin coating. Moreover, also pre-baking is carried out.

After spin coating, the thickness of said resist film is measured, and the evaluation of the resist film is made (resist film evaluation process). Then, as shown in FIG. 45(C), the position adjustment of the base material 430 is carried out, and as said base material 430 is being controlled with respect to the X-axis, Y-axis, and Z-axis, as the above-mentioned sixth example of the embodiment pattern drawing for the curved surface portion comprising a diffractive grating structure is carried out by an electron beam for three-dimensional pattern drawing (pattern drawing process).

At this time, in forming blazes as a diffractive grating structure, it is desirable that the step S3114 of FIG. 36 in the sixth example of the embodiment is modified to be such one as described below and the following step S115 is carried out.

To state it concretely, in respect of a range within the same depth of focus taken as the object, the calculation of the dose quantity for the outermost line (nth) and the start point and end point is carried out. In addition, the start point and end point are made the connection points with the neighboring fields respectively (S3114). In this case, the number of the start points and end points is made an integer, and the dose quantity is expressed by the product of a coefficient, which is determined by the maximum dose quantity defined for the radial position (angle of incidence) and the position of the diffractive grating, multiplied by said maximum dose quantity.

Subsequently, pattern drawing is carried out on the basis of the dose distribution DS(x, y) determined by the dose quantity given in the step S3114 (S115). At this time, it is desirable that the dose distribution DS is made broad for shallow positions (near the apex) of the slope (tilted portion) and sharp for deep positions (groove portion) of it.

In this way, by giving said dose distribution, the pattern drawing for the diffractive grating can be performed by a single scan. Then, the steps S113 to S115 are practiced a specified number of times (S116), and the movement of the XYZ stage and the preparation for practicing the pattern drawing of the next field are carried out (S117); by practicing the above-mentioned steps S109 to S117 a specified number of times (S118), it is possible to produce a base material having a diffraction pattern on the curved surface by means of an electron beam.

To return the explanation to FIG. 45, next, a surface smoothing treatment for the resist film L on the base material 430 is carried out (surface smoothing process). Further, as shown in FIG. 45(D), while the position adjustment of the base material 430 is being made, development processing is carried out (development process). Furthermore, a surface hardening treatment is carried out.

Subsequently, by SEM observation, film thickness measurement, etc., a process for evaluating the shape of the resist is carried out (resist shape evaluation process). Further, after that, an etching process is carried out by using a dry etching method or the like.

Now, as shown in an enlarged view of the part U of the diffractive grating structure 432, a diffractive grating structure is formed of a plurality of blazes composed of a slope portion 432b and a side wall portion 432a each. As regards these blazes, it is desirable that the angle of the diffractive grating surface becomes steeper with its position coming closer to the periphery.

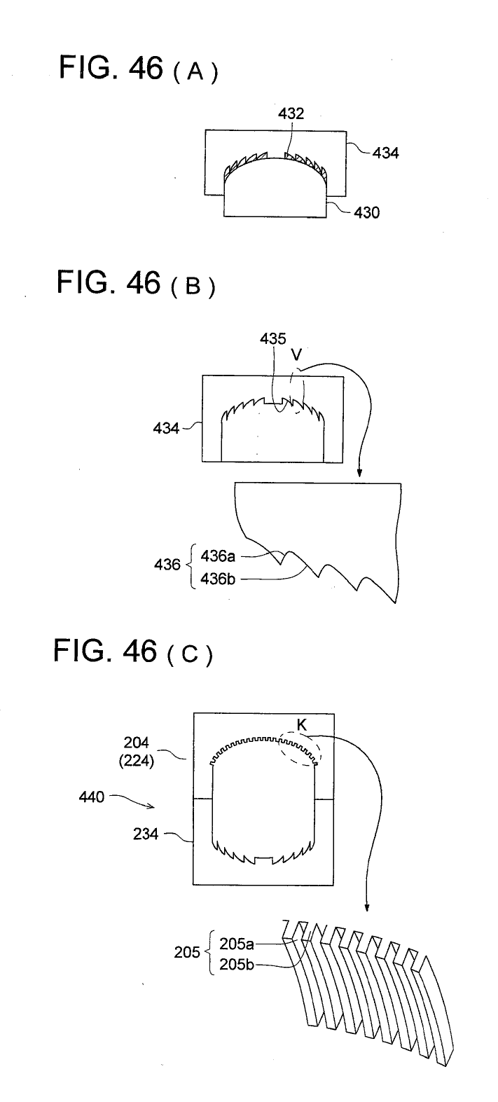

Next, in order to produce a metal die 434 for the base material 430 to which a surface treatment has been applied, as shown in FIG. 46(A), after a pretreatment for electroforming processing of the metal die is carried out, an electroforming process etc. are practiced, and as shown in FIG. 46(B), a processing to separate the metal die 434 from the base material 430 is carried out.

To the metal die 434 which has been separated from the base material having been subjected to a surface treatment, a surface treatment is carried out (die surface treatment process). Then, the evaluation of the metal die 434 is performed.

Now, in the metal die 434, as shown in an enlarged view of the part V, concave portions 435 are formed in such a way as to correspond to the blazes of the above-mentioned base material 430, and in each of these concave portions 435, a plurality of minute convex portions 436 are formed in such a way as to correspond to the shape of the hole portions of the slope portion 432b of the above-mentioned base material 430.

Now, in the case where a polarized light splitting structure is provided on the curved surface portion on one side of the base material and a diffractive grating structure is provided on the curved surface portion on the other side of the base material, after the above-mentioned evaluation, as shown in FIG. 46(C), the pertinent metal die 434 and the metal die 204 in the above-mentioned seventh example of the embodiment are placed in an arrangement of both facing each other, and mold products are produced by injection molding. After that, the evaluation of said mold products is performed.

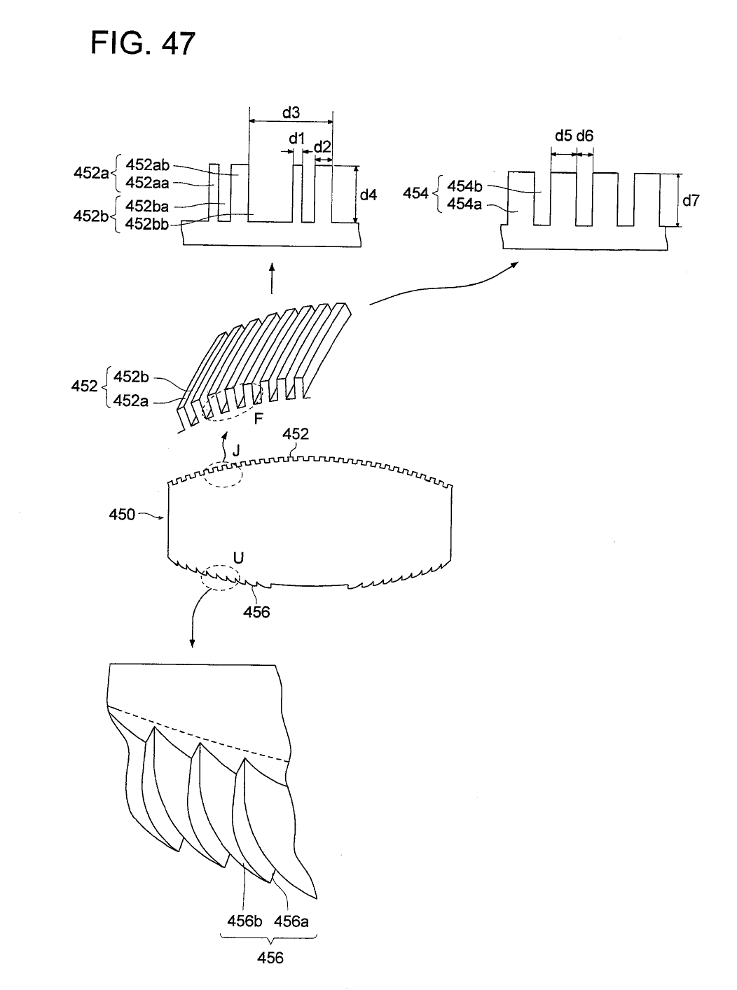

At this time, as shown in FIG. 46(C), in the injection molding product 440, a structure similar to that of the base material in the above-mentioned eleventh example of the embodiment is completed. To state it concretely, as shown in FIG. 47, on the curved surface portion of one side of the base material 450, a polarized light splitting structure is formed, and on the curved surface portion on the other side of the base material 450, a diffractive grating structure 456 is formed. Further, as shown in an enlarged view of the part J, concave portions 452b and convex portions 452a composing the polarized light splitting structure 452 are formed.

Further, as shown in an enlarged view of the part F, the convex portion 452a of the polarized light splitting structure 452 comprises a first convex portion 452aa having a first width d1 and a second convex portion 452ab having a second width d2, which is different from said first width d1, and a plurality of the first and second convex portions 452aa and 452ab are formed at intervals Further, between the first convex portion 452aa and the second convex portion 452ab, a first concave portion 452ha having a narrower width and a second concave portion 452bb having a broader width are formed, and these first and second concave portions 452ba and 452bb make up the concave portion 452b.

Further, on the curved surface on the other side, blazes 456 as a diffractive grating structure are formed, and as shown in an enlarged view of the part U, the blaze 456 consisting of a side wall portion 456a and a slope portion 456b is formed.

On the other hand, in the case where a birefringence phase structure is provided on the curved surface portion on one side of a base material and a diffractive grating structure is provided on the curved surface portion on the other side of the base material, after the above-mentioned evaluation, the pertinent metal die 434 and the metal die 224 in the above-mentioned eighth example of the embodiment are arranged facing each other, and mold products are produced by injection molding. After that, the evaluation of said mold products is performed.

At this time, as shown in FIG. 46(C), in an injection molding product 440, on the curved surface portion of one side of the base material, a birefringence phase structure is formed, and on the curved surface portion on the other side of the base material, a diffractive grating structure is formed; as shown in an enlarged view of the part K, concave portions and convex portions making up a birefringence phase structure are formed. To state it concretely, as shown in FIG. 47, on the curved surface portion on one side of the base material 450, a birefringence phase structure is formed, and on the curved surface portion on the other side of the base material 450, a diffractive grating structure 456 is formed. Further, as shown in an enlarged view of the part J, concave portions and convex portions making up the birefringence phase structure are formed.

Further, as shown in an enlarged view of the part F, the birefringence phase structure 454 has a periodic structure formed of the convex portions 454a each having a first width d5 and the concave portions 454b each having a second width d6, which is shorter than said first width d5, being alternately positioned. In addition, the convex portion 454a is formed to have a height of d7.

Further, on the curved surface on the other side, blazes 456 as a diffractive grating structure are formed, and as shown in an enlarged view of the part U, the blaze 456 consisting of a side wall portion 456a and a slope portion 456b is formed.

As explained in the above, according to this example of the embodiment, the pattern of a polarized light splitting structure or a birefringence phase structure is drawn for the curved surface of a first base material by means of a three-dimensional pattern drawing apparatus, and a first metal die is produced on the basis of this first base material; on the other hand, the pattern of a blaze shape as a diffractive grating structure is drawn for the curved surface portion of a second base material, and a second metal die is produced on the basis of this second base material. By carrying out injection molding with these first and second metal dies arranged facing each other, it is possible to make up a base material such that a polarized light splitting structure or a birefringence phase structure is formed on the curved surface of its one side and a blaze shape as a diffractive grating structure is formed on the curved surface portion of the other side of it.

In addition, in the above-mentioned example of the embodiment, it is assumed that the surface on which a diffractive grating structure is formed is a curved surface; however, also it is appropriate to suppose that a diffractive grating structure is formed on a flat surface portion. Besides, also it is possible a case where a birefringence phase structure or a polarized light splitting structure is formed on a flat surface portion.

In this way, because optical elements can be manufactured by injection molding using a metal die, it is possible to make the cost necessary for manufacturing reduced. Further, by adding a structure having a function of a polarized light splitting element, a wave plate, and a diffractive grating to the metal die, the functions can be added to lenses at the same time in injection molding, which makes it unnecessary to carry out an additional process. For this reason, although the manufacturing cost of the metal die itself is increased and the possible number of shots (about one million times) is increased, it is possible to make the manufacturing cost and operation time reduced by a large margin as compared to the case where an evaporation coating process is applied to each optical lens as in a conventional method.

Further, because a polarized light splitting element, a wave plate, and a diffractive grating structure can be built in a plastic lens simultaneously in the process of injection molding of it, it causes the cost of optical parts to be reduced.

### Thirteenth Example of the Embodiment

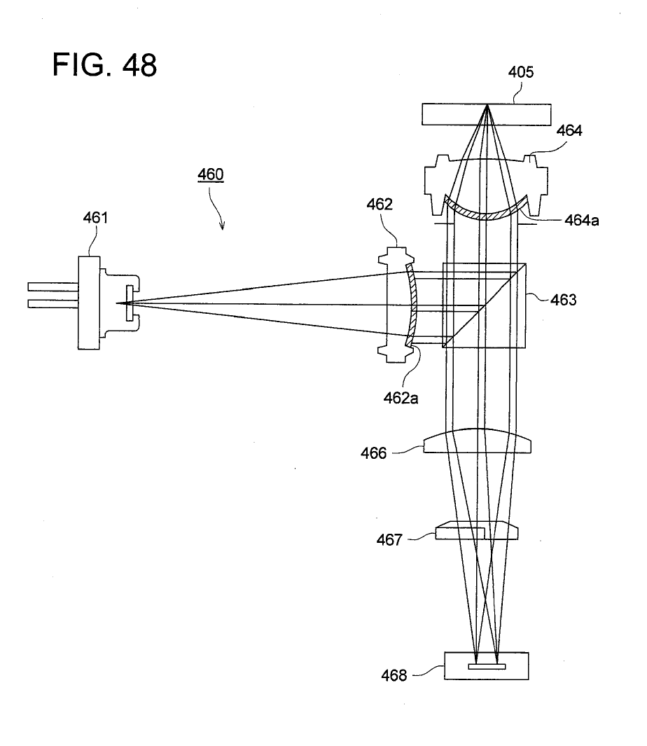

In the following, the thirteenth example of the embodiment of this invention will be explained on the basis of FIG. 48. FIG. 48 is a functional block diagram showing the thirteenth example of the embodiment of this invention.

In this example of the embodiment, it is disclosed an example of an optical pickup device as an example of an electronic device using a base material (or an optical element which is a mold product of resin by injection molding) disclosed in the twelfth example of the embodiment.

In FIG. 48, an optical pickup device 460 comprises a semiconductor laser 461, a collimator lens 462, a splitting prism 463, an objective lens 464, a magneto-optical disk 465 such as a DVD or a CD (a magneto-optical recording medium), a convergent lens 466, a cylindrical lens 467, and a split light detector 468.

Among the above-mentioned optical parts, in this example of the embodiment, (irrespective of the presence or absence of a curved surface portion), for example, the collimator lens 462 employs an optical element including a polarized light splitting structure of the above-mentioned tenth example of the embodiment, and for example, the objective lens 464 employs an optical element of the above-mentioned eleventh or twelfth example of the embodiment including a birefringence phase structure (a structure having a function of a wave plate) on one surface and a diffractive grating structure on the other surface. That is, the collimator lens 462 has a polarized light splitting structure 462a, and the objective lens 464 has a birefringence phase structure 464a and a diffractive grating structure 464b.

In the optical pickup device 460 having a structure as described in the above, a laser beam from the semiconductor laser 461 is made parallel by the collimator lens 462. At this time, it is split into two bundles of rays, which have optical paths close to each other and are composed of P polarized light and S polarized light respectively, by the polarized light splitting structure 462a. The parallel beam including these two bundles of rays is reflected by the splitting prism 463 towards the objective lens 464, is converged by the objective lens 464 to the diffraction limit, and is applied to the magneto-optical disk 465 (magneto-optical recording medium).

The reflected laser beam from the magneto-optical disk 465 enters the objective lens 464, and is again made a parallel beam. At this time, a phase difference is generated between the above-mentioned bundles of rays respectively composed of P polarized light and S polarized light by the birefringence phase structure 464a; after their orientations of polarization are rotated by a specified angle, they are transmitted through the splitting prism 463, and the two bundles of rays, which are composed of P polarized light and S polarized light and have optical paths close to each other respectively, are converged by the convergent lens 466 and the cylindrical lens 477, to form their respective spots in the split light receiving areas (light receiving elements) of the split light detector 468.

Further, because a diffractive grating structure 464b is formed on the objective lens 464, it is possible to make correction of aberration to be produced in using a CD and a DVD in an interchangeable way. Besides, by employing a structure in which the blaze as a diffractive grating structure unit is made steeper with the location coming closer to the periphery of the curved surface portion, it is possible to eliminate the lowering of the pickup function caused by the increase of angle of incidence owing to the grating density being made higher.

As described in the above, in this example of the embodiment, by using an optical lens provided with a polarized light splitting structure on its one surface (integrally formed), and an optical lens provided with a birefringence phase structure on its one surface, it becomes unnecessary to use a dedicated polarized beam splitter and a wave plate as in a conventional device, the number of component members and the number of attached parts are reduced, which makes it possible to achieve the cost reduction by a large margin.

Further, because it becomes unnecessary to provide a polarized light splitting element and a wave plate, the space occupied by the component members mounted is reduced, which makes it possible to achieve making the size of an optical pickup device smaller; further, the adjustment required for the optical system of an optical pickup device becomes unnecessary.

Further, in respect of an optical pickup device, to make it small-sized and integrated becomes easy, and the tracking mechanism can be simplified.

Besides, in the above-mentioned example of the embodiment, it is shown as an example the case where a birefringence phase structure and a diffractive grating structure are formed on the objective lens, but this invention should not be limited to this; it is of course possible a case where various kinds of polarized light splitting structures or birefringence phase structures are formed on the convergent lens, cylindrical lens, etc.

In addition, an apparatus and a method of this invention has been explained on the basis of some specified examples of the embodiment; however, a skilled person in the art can make various kinds of modifications for the examples of the embodiment described in the specification of this invention without departing from the spirit and scope of this invention.

Further, in the case where at least one unit portion of a diffractive grating is formed with a tilt on a base material having at least a curved surface portion (or in the case where groove portions are formed with a fine pitch), a structure having at least a groove portion on the base material may be appropriate. Further, as regards the base material, also it is appropriate such one that has at least a slope formed, even though it has no curved surface portion. Further, also it is possible a case where the base material has a flat surface or a slope, and an electron beam is applied to it with a specified angle of incidence in a tilted state.

Further, it has been shown as an example a case where, in forming a polarized light splitting structure or a birefringence phase structure on the surface on one side of a base material, and a diffractive grating structure on the surface on the other side of the base material, the first and second base materials, and the first and second metal dies are used; however, also it is appropriate a case where pattern drawing is done for the surface on one side of a base material, and then pattern drawing is done for the surface on the other side of it, to produce a metal die for one base material for mass production.

As explained in the foregoing, according to this invention, by forming a polarized light splitting structure on a base material on which a pattern is to be drawn together with the pattern drawing for a curved surface portion by a three-dimensional pattern drawing method, also it is made possible to produce an optical lens or the like provided with a polarized light splitting structure on its one surface finally; hence, the optical lens may be applied to various kinds of apparatus instead of a conventional polarized light splitting element.

In this way, by making up a metal die on the basis of a base material having a pattern drawn, elements having a polarized light splitting structure as final mold products by injection molding can be successively mass-produced. Hence, in view of the labor and time in the processes for producing polarized light splitting elements one by one as in a conventional method, reduction of manufacturing cost by a large margin and an improvement of productivity can be achieved.

Further, by forming a birefringence phase structure on a base material on which a pattern is to be drawn, also it is made possible to produce an optical lens or the like provided with a structure having a function of a wave plate as a birefringence phase structure on its one surface finally; hence, the optical lens may be applied to various kinds of apparatus instead of a conventional wave plate.

In this way, by making up a metal die on the basis of the above-mentioned base material, elements having a function of a wave plate as final mold products by injection molding can be successively mass-produced. Hence, in view of the labor and time in the processes for producing polarized light splitting elements one by one as in a conventional method, reduction of manufacturing cost by a large margin and an improvement of productivity can be achieved.

Further, because optical elements can be manufactured by injection molding using a metal die, it is possible to make the cost necessary for manufacturing reduced. It is possible to add the function of polarized light splitting and the function of a wave plate simultaneously at the time when this base material is produced by injection molding, which makes it unnecessary to carry out an additional process. For this reason, it is possible to make the manufacturing cost and operation time reduced by a large margin as compared to the case where polarized light splitting elements and wave plates are manufactured one by one as in a conventional method, which causes the cost of optical parts to be reduced.

Further, by using a base material having a pattern drawn to have a diffractive grating structure formed on the surface on the other side of it, correction of aberration in a pickup device for interchangeable use of a CD and a DVD can be satisfactorily practiced.

Further, in an optical pickup device, by using an optical element provided with a polarized light splitting structure on one surface (integrally built) and an optical element provided with a birefringence phase structure on one surface, it becomes unnecessary to use a dedicated polarized light splitter and a wave plate as in a conventional device, and the number of component members and the number of attached parts are reduced, which makes it possible to achieve cost reduction by a large margin.

Further, because it is unnecessary to arrange a polarized splitting element and a wave plate, the space occupied by the component members arranged is reduced, which makes it possible to make the optical pickup device small-sized, and further, makes it unnecessary to adjust the optical system of the pickup device. Furthermore, as regards an optical pickup device, to make it small-sized and integrated becomes easy, and the tracking mechanism car be simplified.

In the above-mentioned examples of the embodiment 1 to 13, it has been explained a case where a pattern is drawn directly on a base material of an optical element such as an optical lens; however, it is also appropriate to use the above-mentioned principle, steps of procedure, and method of processing, in the case where a mold (metal die) for forming an optical lens made of resin or the like by injection molding is worked.

Further, for a base material, it has been disclosed an example of a pickup lens to be used for a DVD, a CD, etc.; however, this invention can be applied to an objective lens having no diffractive grating, a lens for interchangeable use of a DVD and a CD provided with a diffractive grating having a pitch of 20 μm, an objective lens provided with a high-density diffractive grating having a pitch of 3 μm for interchangeable use of recording media for a blue laser, etc.

Further, in the case where an optical element is used for the base material, the electronic device using said base material is not limited to the above-mentioned reading device of a DVD, a CD, etc, but various kinds of optical device may be appropriate.

Further, it is also appropriate to employ a structure such that the steps of measuring a plurality of reference points on a base material, calculating a standard coordinate system on the basis of these reference points, and measuring the thickness distribution of the base material on the basis of this coordinate system are carried out during the application of an electron beam. Further, also it is appropriate to employ a structure such that the step of calculating an optimum focus position on the basis of the thickness distribution and the step of adjusting said focus position to a pattern drawing position are carried out during the application of an electron beam. In this case, it is desirable to employ a structure such that, during the application of an electron beam which is in process of pattern drawing for one pattern drawing position, an operation process such as calculation of the above-mentioned focus position for another pattern drawing position is being practiced to get ready for the subsequent application of an electron beam. Further, as regards the object of calculation that can be carried out in the calculation step during the application of an electron beam, in addition to the thickness distribution, calculation processing such as correction of the thickness distribution etc. can be included in it.

Further, it is also possible to employ a structure such that a processing program to be processed in a pattern drawing apparatus using an electron beam in the above-mentioned examples of the embodiment, processing explained, and the whole or various parts of data (such as various kinds of tables) in the memory are recorded in an information recording medium. For this information recording medium, for example, a semiconductor memory such as a ROM, a RAM, and a flash memory, an integrated circuit, etc. may be used, and further, it is also appropriate to use the pertinent information recorded in some other medium, for example, a had disk, etc.

What is claimed is:

1. An optical element producing method of producing an optical element with a microscopic predetermined pattern thereon, the method comprising:
irradiating a beam onto a layer of a first base material to draw a first pattern thereon;
irradiating a beam onto a layer of a second base material to draw a second pattern thereon;
forming a first molding die and a second molding die respectively based on the first and second base materials;
assembling a mold by arranging the first and second molding dies to be opposite to each other; and
conducting an injection molding process with the mold so as to form the optical element such that the predetermined pattern corresponds to the first and second patterns drawn on the first and second base materials.

2. An optical element producing method of claim 1, wherein one of the first pattern and the second pattern comprises a polarized light splitting structure and the other of the first pattern and the second pattern comprises a diffractive grating structure.

3. An optical element producing method of claim 1, wherein one of the first pattern and the second pattern comprises a birefringence phase structure and the other of the first pattern and the second pattern comprises a diffractive grating structure.

4. An optical element producing method of claim 1, wherein the beam is an electron beam.
